(19) United States
(12) Patent Application Publication
(10) Pub. No.: US 2007/0250492 A1
(43) Pub. Date: Oct. 25, 2007

(54) VISUAL SEARCH EXPERIENCE EDITOR

(76) Inventors: Mark Angel, Napa, CA (US); Max Copperman, Santa Cruz, CA (US); Raya Fratkina, Nashua, NH (US); Scott B. Huffman, Redwood City, CA (US); Brian Ulicny, Winchester, MA (US)

Correspondence Address: SCHWEGMAN, LUNDBERG & WOESSNER, P.A., P.O. BOX 2938, MINNEAPOLIS, MN, 55402, US

(21) Appl. No.: 11/462,557

(22) Filed: Aug. 4, 2006

Related U.S. Application Data
(63) Continuation of application No. 11/379,795, filed on Apr. 23, 2006.

(51) Int. Cl. G06F 17/30

(52) U.S. Cl. 707/4

(57) ABSTRACT

This document describes, among other things, a visual search experience editor for providing a tailored search experience to one or more end-users. In certain examples, the editor provides a What-You-See-Is-What-You-Get (WYSIWIG)-type interface, so that an administrative user can see what the tailored search experience will look like to the end-user. This may include the ability to review live search results or other specialized transaction interface results responsive to the tailored search. This document also describes various techniques of triggering tailored search experiences, as well as techniques for mapping queries to tailored search experiences, such as to generalize a particular tailored search for a particular query to apply to other similar queries.

This application is a continuation of U.S. Application No. 11/379,795, filed Apr. 23, 2006, which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2005, Knova Software, Inc. All Rights Reserved.

### TECHNICAL FIELD

This patent document pertains generally to search experience editors and search tuning tools and interfaces, and more particularly, but not by way of limitation, to visual search experience editors.

### BACKGROUND

Computer-assisted searches of resources can provide a range of results. Sometimes, irrelevant or non-helpful documents are provided in a search result. In some instances, to find a desired resource, a user may be required to sift through a list of mostly non-helpful documents before the desired resource is located. Sometimes, navigation aids (links) are provided as a component of or in addition to search results. In some instances, the navigation aids do not help the user navigate to the desired resource. Sometimes, specialized transaction interfaces (e.g., telephone number or stock quote lookup, or ticket-buying interfaces) are presented to the user. In some instances, the specialized transaction interfaces are inappropriate or irrelevant to helping the user find to the desired resource, and in some instances relevant or appropriate specialized transaction interfaces are not presented.

Search engines are used in a number of different contexts. For example, some web sites or other resources provide a search engine that assists the user in locating explanatory documents (e.g. “help” resources) that describe how to solve a particular problem. Search engines are also used in shopping operations—for example to find a particular product or a particular kind of product.

### SUMMARY

In an example, this document describes a method of crafting an end-user search experience. A plurality of items are displayed in an administrative interface. The plurality of items includes at least one query item and one or more additional items associated with the query item. The one or more additional items includes at least one responsive item to the query item. The one or more additional items are displayed in a configuration representative of an appearance of an end-user search interface. Administrative input is received through the administrative interface. The administrative input relates to a modification of one or more of the items or the configuration. At least one parameter relating to the modification is saved in a record. The administrative interface displays, in a configuration representative of an appearance of an end-user search interface, the configuration of the one or more of the additional items as modified in accordance with the at least one parameter saved in the record.

In certain variations of this or other examples, the record includes triggers, each trigger associated with at least one of the saved parameters, and comprising receiving a first query through an end-user search interface, identifying whether the first query maps to at least one trigger, and if the first query does map to at least one trigger, then using the at least one parameter associated with the at least one trigger to control the displaying of at least one responsive item in the end-user interface.

In another variation of this or other examples, the method includes determining a first query class associated with the first query. Identifying whether the first query maps to at least one trigger comprises identifying whether the first query class maps to at least one trigger.

In another variation of this or other examples, displaying at least one query item includes displaying at least one text string or specifiable parameter.

In another variation of this or other examples, displaying at least one additional item includes displaying a result item, a results area, a featured result, a featured result area, a navigation item, a navigation area, a direct answer, an advertisement, or a specialized transaction interface.

In another variation of this or other examples, the saving in a record comprises saving in an underlying knowledge representation, wherein search results are presented in an end-user search interface using the modified knowledge representation.

In another variation of this or other examples, the saving in a record comprises saving in a record that is associated with at least one trigger for comparison against an end-user query to determine whether to use the saved at least one parameter in response to the end-user query.

In another variation of this or other examples, receiving administrative input includes receiving an instruction to add an item to the administrative interface, remove an item from the administrative interface, move an items to a different organizational unit or a different location in the administrative interface, reorder an items or items, edit an item, rename an item, merge two or more items, preview an end user interface, or edit a property of an item.

In another variation of this or other examples, receiving administrative input comprises receiving input specifying one or more contexts in which the modification is to be applied.

In another variation of this or other examples, the method includes receiving an end-user query in an end-user interface, and applying the modification in the end-user interface if the specified one or more contexts are present.

In another variation of this or other examples, applying the modification includes applying the modification if the end-user query corresponds to a specified query class, a specified product or product group, a specified document type, a specified author, or a specified user or customer group.

In another variation of this or other examples, the method includes displaying some or all of the additional items in an end-user interface using the at least one parameter saved in the record to add an item to the administrative interface, remove an item from the administrative interface, move an item to a different organizational unit or a different location in the administrative interface, reorder an items or items, edit an item, rename an item, merge two or more items, or edit a property of an item.

In another variation of this or other examples, the one or more additional items includes search results responsive to the query item.

In another variation of this or other examples, the method includes refreshing the administrative interface in accordance with the modification provided by the administrative input.

In another variation of this or other examples, the method includes receiving administrative input includes receiving an input changing the at least one query item and refreshing the administrative interface includes updating the one or more additional items in response to changing the at least one query item.

In another variation of this or other examples, the method includes displaying in the administrative user interface one or more other queries associated with the record the displaying in the administrative interface the plurality of items includes displaying two or more items in an order as would be presented in the end-user search interface in response to the at least one query-item, and the receiving administrative input includes receiving an instruction to change the displayed order of the two or more items.

In another variation of this or other examples, the method includes displaying in the administrative interface a first pane and a second pane, and wherein the receiving administrative input includes receiving an instruction to move or copy an item from the first pane to the second pane.

In another variation of this or other examples, the method includes displaying in the administrative interface the plurality of items includes displaying items in a what-you-see-is-what-you-get (WYSIWYG) interface that displays the items substantially as the items would be displayed to an end-user, and the method further includes displaying one or more controls in the WYSIWYG interface through which at least some of the administrative input relating to a modification of the end user presentation scheme is receivable.

In another variation of this or other examples, the method includes displaying in the administrative interface the plurality of items includes displaying one or more selectable navigation items, and the receiving administrative input includes at least one of adding a navigation item, removing a navigation item, merging navigation items, creating a new navigation item, and renaming a navigation item.

In another variation of this or other examples, the method includes receiving an input selecting a navigation item, refreshing the display and presenting items associated with the navigation item in a configuration representative of an appearance of an end-user search interface, receiving administrative input, through the administrative interface, relating to a modification of one or more of the plurality of items or the configuration of the one or more items, and saving in the record at least one parameter relating to the modification of one or more of the plurality of items or the configuration of the one or more items.

In another variation of this or other examples, the method includes displaying in the administrative interface a WYSIWYG query response region including a general results area listing a plurality of ordered results, a targeted results area listing one or more targeted results, and a navigation area listing one or more navigation links.

In another variation of this or other examples, the method includes displaying a query match region listing one or more queries associated with the at least one trigger and displaying one or more administrative controls relating to the queries associated with the at least one trigger.

In another variation of this or other examples, displaying a WYSIWYG query response region includes presenting search results for a first query in the general results area, and the displaying a query match region listing one or more queries associated with the trigger includes normalizing the first query, determining a first query class using the normalized first query, and populating the query match region with one or more other, different query classes that contain the first query class.

In another variation of this or other examples, the method includes logging previous queries, normalizing the previous queries, and storing normalized versions of the previous queries in a query index, and populating the query match region with one or more other, different query classes that contain the first query class includes searching the query index using the first query class and populating the query match region with normalized versions of the previous queries.

In another example, this document describes a method of crafting an end-user search experience. The method includes displaying in an administrative interface a plurality of items including at least one query item and one or more additional items associated with the query item, the one or more additional items displayed in a configuration representative of an appearance of an end-user search interface, receiving administrative input, through the administrative interface, relating to a modification of one or more of the plurality of items or the configuration of the one or more items, saving in a record at least one parameter relating to the modification of one or more of the plurality of items or the configuration of the one or more items, receiving a first query through an end-user search interface, determining whether the first query qualifies as a trigger for the record, and if the first query qualifies as a trigger for the record, displaying at least one responsive item in the end-user search interface using the at least one parameter relating to the modification of one or more of the plurality of items or the configuration of the one or more items.

In a variation of this or other examples, the method includes determining whether the first query qualifies as a trigger for the record includes identifying a first query class associated with the first query, and determining whether the first query class qualifies as a trigger for the record.

In another variation of this or other examples, the method includes identifying a first query class includes determining a normalized version of the first query.

In another variation of this or other examples, the method includes searching a set of resources using the first query and displaying a result of the searching modified by the record.

In another variation of this or other examples, the method includes refreshing the administrative interface and reflecting in the administrative interface the modification of one or more of the plurality of items or the configuration of the one or more items.

In another variation of this or other examples, the method includes displaying in an administrative interface a plurality of items includes displaying a plurality of queries having a specified relationship with the record.

In another variation of this or other examples, the method includes displaying a plurality of queries having a specified relationship with the record includes displaying a plurality of queries that are triggers for the record.

In another variation of this or other examples, the receiving administrative input includes receiving at least one input specifying at least one query to be associated with or dissociated from the record, wherein associated queries qualify as a trigger for the record.

In another variation of this or other examples, the method includes recording in the record the at least one query to be associated with or dissociated from the record.

In another variation of this or other examples, the record includes a sponsored result and displaying a plurality of queries having a specified relationship with the record includes displaying queries that are triggers for the sponsored result.

In another variation of this or other examples, the method includes receiving a first query includes receiving a first query string, and determining whether the first query qualifies as a trigger for the record includes determining a query class from the first query string and determining whether the query class qualifies as a trigger.

In another variation of this or other examples, the method includes displaying a plurality of queries includes displaying queries having a specified relationship with the query class.

In another variation of this or other examples, the displaying queries having a specified relationship with the record includes displaying queries associated with the record, displaying queries dissociated from the record, or displaying queries containing the query class.

In another variation of this or other examples, receiving a first query includes receiving a first query string and a second query string, and determining whether the first query qualifies as a trigger for the record includes determining a query class using the first query string and second query string and determining whether the query class qualifies as a trigger.

In another variation of this or other examples, the method includes providing at least one second query to a search interface or other specialized transaction interface in the end-user search interface to obtain the at least one responsive item.

In another variation of this or other examples, the at least one second query is associated with the trigger for which the first query received through the end-user interface qualifies, and in which the at least one second query is different from the first query.

In another variation of this or other examples, the at least one second query uses the first query in combination with a different query, wherein the different query is associated with the trigger for which the first query received through the end-user interface qualifies.

In another variation of this or other examples, the at least one second query uses a portion of the first query that does not qualify the first query as the trigger in combination with a third query that is different from the first query.

In another variation of this or other examples, the providing at least one second query comprises generating the at least one second query from a disjunctive combination of multiple queries.

In another variation of this or other examples, multiple end-user queries qualify as the trigger.

In another example, this document describes a method that includes receiving a query input, identifying a search modification record with which the query input has a specified relationship, the search modification record including at least one modification relating to the presentation of one or more items responsive to the query input or a configuration of the one or more items, and displaying results responsive to the query using the search modification record.

In a variation of this or other examples, identifying a search modification record with which the query input has a specified relationship includes identifying a search modification record associated with a query class that the query contains.

In another variation of this or other examples, displaying results responsive to the query using the search modification record includes displaying results using an instruction specified by the search modification record to add an item to the administrative interface, remove an item from the administrative interface, move an item to a different organizational unit or a different location in the administrative interface, reorder an items or items, edit an item, rename an item, merge two or more items, or edit a property of an item.

In another example, this document describes a computer-assisted method that comprises selecting, using administrative user input, a search interface or other specialized transaction interface for use in an administrative interface that displays items, including the selected search interface or other specialized transaction interface, in a configuration representative of an end-user interface. Administrative input is received to configure, for at least one query, an input argument to the selected search interface or other specialized transaction interface. The method includes creating and storing a record, the record including a tailored search experience trigger for the at least one query, the trigger using information from the administrative user input. The argument configured for the at least one query is passed to the selected search interface or other specialized transaction interface. The method includes displaying, in the administrative interface in response to the argument configured for the at least one query, a result returned by the search interface or other specialized transaction interface, the result displayed in a manner that is representative of how the result will be displayed in the end-user interface.

In a variation of this or other examples, the method includes positioning, using information from the administrative user input, the search interface or other specialized transaction interface at a desired location in the administrative interface, wherein the location in the administrative interface is representative of a corresponding location in the end-user interface at which the selected search interface or other specialized transaction interface will be displayed.

In another variation of this or other examples, the method includes creating and storing the record includes creating and storing a record that includes the trigger, a specified location of the search interface or other specialized transaction interface in the end-user interface, and a relationship between the argument and the at least one query.

In another variation of this or other examples, the receiving administrative user input comprises receiving an abstraction to generalize a specific query into a broader class of queries, and wherein the configuring the argument is performed for the class of queries.

In another variation of this or other examples, the method includes providing to the administrative user at least one query, and receiving the abstraction from the administrative user, wherein the abstraction is of at least a portion of the at least one query.

In another variation of this or other examples, the method includes receiving an end-user query in the end-user interface. If the end-user query corresponds to at least one trigger, then the method includes providing a corresponding tailored search experience to the end-user, the provided tailored search experience including displaying in the end-user interface at least one search interface or other specialized transaction interface that corresponds to the at least one trigger that corresponds to the end-user query.

In another variation of this or other examples, the method includes presenting to the administrative user a plurality of argument abstractions from which to select.

In another variation of this or other examples, the presented plurality of argument abstractions is extensible by the administrative user, and comprising receiving administrative user input to define or extend the abstractions.

In another variation of this or other examples, the method includes receiving administrative user input to define a scope of queries to which a particular abstraction applies.

In another variation of this or other examples, the method includes using the abstraction by consulting a list defining queries to which a particular abstraction applies.

In another variation of this or other examples, the method includes using the abstraction by performing a function call to determine at least one characteristic of any queries to which the abstraction applies.

In another variation of this or other examples, the method includes presenting to the administrative user a plurality of search interfaces, a plurality of other specialized transaction interfaces, or at least one search interface and at least one other specialized transaction interface from which to select.

In another variation of this or other examples, receiving administrative user input to configure the argument includes receiving administrative user input that is based on an end-user query.

In another variation of this or other examples, the receiving administrative user input to configure the argument includes receiving administrative user input that is separate from an end-user query.

In another variation of this or other examples, the method includes modifying, in the administrative interface, the result returned by the search interface or other specialized transaction interface, and saving the modification in a search experience modification record, in correspondence with the tailored search experience trigger, such that an end-user query that invokes the tailored search experience trigger causes the modification to be displayed in the end-user interface.

In an example, this document also describes a method that includes receiving, in an end-user interface, a query from an end-user, determining whether the query invokes a predetermined trigger for a tailored search experience, and, if the query invokes a trigger, modifying the end-user interface according to a search modification record associated with the invoked trigger, the modifying including presenting to the end-user at least one search interface or other specialized transaction interface according to the search modification record associated with the invoked trigger.

In a variation of this or other examples, the method includes using a subscription engine for performing the determining whether the query invokes a predetermined trigger for a tailored search experience.

In another variation of this or other examples, the method includes presenting to the end-user at least one search result item according to the search modification record associated with the invoked trigger.

In another variation of this or other examples, the method comprises performing, in response to the end-user query, at least one search having an argument that is modified from the end-user query, the modification according to the search modification record associated with the invoked trigger.

In another variation of this or other examples, the method includes performing, in response to the end-user query, at least one search, and modifying results of the at least one search according to the search experience modification record associated with the invoked trigger.

### BRIEF DESCRIPTION OF THE DRAWINGS

FIG. 1A is a flow chart that schematically illustrates an example of a method that includes receive administrative input, through an administrative interface, relating to a modification of one or more of a plurality of items or the configuration of the one or more items.

FIG. 1B is a flow chart that schematically illustrates another example of a method that includes determining whether at a first query class contains at least one trigger query class associated with the record.

FIG. 1C is a flow chart that schematically illustrates another example of a method that is capable of permitting an administrative user to modify displayed items and to review modifications.

FIG. 1D is a flow chart that schematically illustrates another example of a method that includes receiving and displaying input relating to modification of items in a navigation area.

FIG. 1E is a flow chart that schematically illustrates another example of a method that includes refreshing and displaying navigation items.

FIG. 2 is a schematic illustration of an example of a network environment in which a search experience editor may be used.

FIG. 3 is a schematic illustration of an example of a computer on which a search experience editor may be used.

FIGS. 4 and 5 are schematic illustrations of applying example records to a search experience.

FIG. 6 is a flow chart of an example of a method that includes determining whether a first query qualifies as a trigger for a record.

FIG. 7 is a flow chart of an example of a method that includes receiving through an administrative interface and recording at least one input specifying at least one query to be associated with or dissociated from the record.

FIG. 8 is a flow chart of an example of a method that includes receiving a query input, identifying a search experience modification record with which the query input has a specified relationship, and displaying results responsive to the query using the search experience modification record.

FIGS. 9A, 9B, and 9C are schematic illustrations of examples of methods that typically include displaying a WYSIWYG query response region.

FIG. 10 is a schematic illustration of an example method that includes logging queries and populating a query pane using results of searching a query index.

FIG. 11 is a screen shot of an example visual search experience editor tool, such as at an entry point into the tool.

FIG. 12 is a screen shot of an example editing interface of a visual search experience editor tool.

FIG. 13 is a screen shot of an example interface that supports adding navigation areas to a current tailored search.

FIG. 14A is a screen shot of an example interface for establishing a new tailored search.

FIG. 14B is a screen shot of an example interface that can be used in creating a new tailored search.

FIG. 14C is a screen shot of an example interface for selecting one or more session context elements.

FIG. 15 is a screen shot of an example interface showing information about terms in a query.

FIG. 16A is a screen shot of an example interface for adding items, such as for adding best bets.

FIG. 16B is a screen shot of an example interface for creating items, such as for creating a best bet.

FIG. 16C is a screen shot of an example interface for deleting items, such as for deleting a best bet.

FIG. 16D is a screen shot of an example interface for editing items, such as for editing a best bet.

FIG. 17 is a screen shot of an example interface for viewing removed or deleted items.

FIG. 18A is a screen shot of an example interface for deleting a navigation area.

FIG. 18B is a screen shot of an example interface for adding a navigation aid.

FIG. 18C is a screen shot of an example interface for moving a navigation aid, such as from one navigation area to another.

FIG. 18D is a screen shot of an example interface for deleting a navigation aid.

FIG. 19 is a schematic illustration representing an example showing effects of operating a visual search experience editor.

FIG. 20 is a schematic illustration, similar to FIG. 19, including a search experience editor.

FIG. 21A is a schematic illustration that shows an example of the effects of saving a tailored search experience.

FIG. 21B is a schematic illustration, similar to FIG. 21A, including a search experience editor.

FIG. 22 is a schematic illustration that shows an example of typical usage of a search experience editor.

FIG. 23A is a schematic illustration that shows an example of using tailored searches in an end-user interface.

FIG. 23B is a schematic illustration that shows an example of using tailored searches in an end-user interface.

FIG. 24 is a schematic illustration that shows an example of an editing interface for designing a search template.

FIG. 25 is a schematic illustration that shows an example of an initial interaction of a user with an editing interface for designing a search template.

FIG. 26 is a schematic illustration that shows an example of a next act of search template construction.

FIG. 27 is a schematic illustration that shows an example of the step of specifying arguments to the widget.

FIG. 28 is a schematic illustration that shows an example of the results returned in response to the arguments to the widget that were specified in FIG. 27.

FIG. 30 is a schematic illustration that shows an example of completing the placement and argument specification for this example of a search template.

FIG. 31 is a schematic illustration that shows an example of a first step in a process of abstracting a search template.

FIG. 32 is a schematic illustration that shows an example of abstracting a portion of a query.

FIG. 33 is a schematic illustration that shows an example of further a further aspect of abstracting a portion of the query.

FIG. 34 is a schematic illustration that shows an example of a completed abstraction.

FIG. 35 is a schematic illustration that shows an example of an end-user interface.

FIG. 36 is a schematic illustration that shows another example of an end-user interface.

FIG. 37 is a schematic illustration that shows an example of a search experience that can be used by the general public or by one or more communities of interest.

FIG. 38 is a schematic illustration that shows an example of a nurse designing a search template.

FIG. 39 is a schematic illustration that shows an example of an arbitrary end-user using an end-user interface employing the search template shown being designed in FIG. 38.

FIG. 40 is a schematic illustration of an example that shows detail beyond that shown in FIGS. 24-39.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

### Overview

This document describes a mechanism to improve the user experience for users of search technologies. These technologies are exemplified in today's marketplace by Google and Yahoo, but include many other search providers, such as are used in on-line retail offerings (Mercado, MondoSoft), in Service Resolution Management offerings for customer service and support (Knova, ATG, Inquira), in enterprise search, and other search applications. The mechanism could function as a separate technology layer, e.g., sitting between the users and the search technology, or could be built into the search technology.

Among other things, is the mechanism provides an administrative interface (called a search experience editor) that supports a WYSIWYG (What You See Is What You Get) or like type of interaction with a search system, that is, the administrative user can search and see the search results much as they would in an end-user interface to the same search system. The interface provides a set of controls that allow the administrative user to manipulate the results or the presentation of the results. For example, the administrative user can add and delete results, edit results, and modify the organization and presentation of results.

In certain examples, the actions taken by the administrative user are recorded in a manner that allows the system to use the record of them to modify the search results and presentation of such results in the end-user interface for the search system. This permits an administrative user to perform a search in this administrative search experience editor, and to tailor the results to their liking. The tailoring is saved such that other users (e.g., end-users) that do that same search or related searches in the normal end-user search interface will see the tailored results. This saved record of the tailoring may also be used to affect the results and presentation of results in the search experience editor, such as to allow further tailoring, or re-tailoring by the same or a different administrative user.

The administrative user of the search experience editor can affect the user experience of an end-user of the search system, hence the term “search experience editor”. A “tailored search” can be used to describe a search in combination with one or more manipulations that tailor the search results or the presentation of such results.

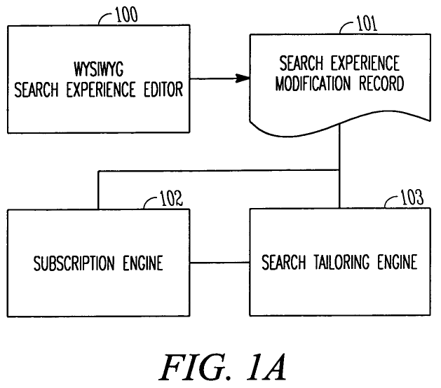

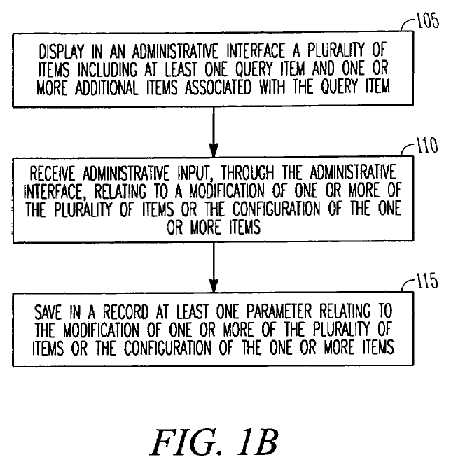

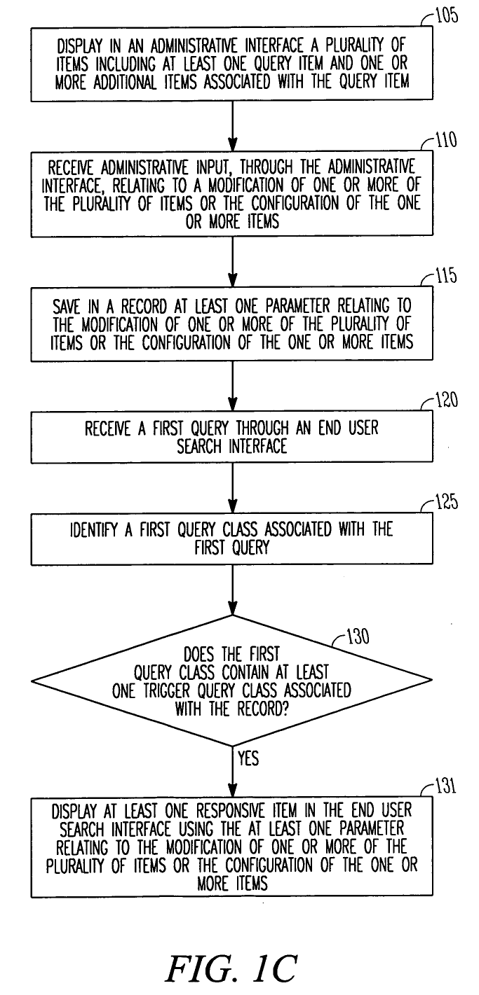

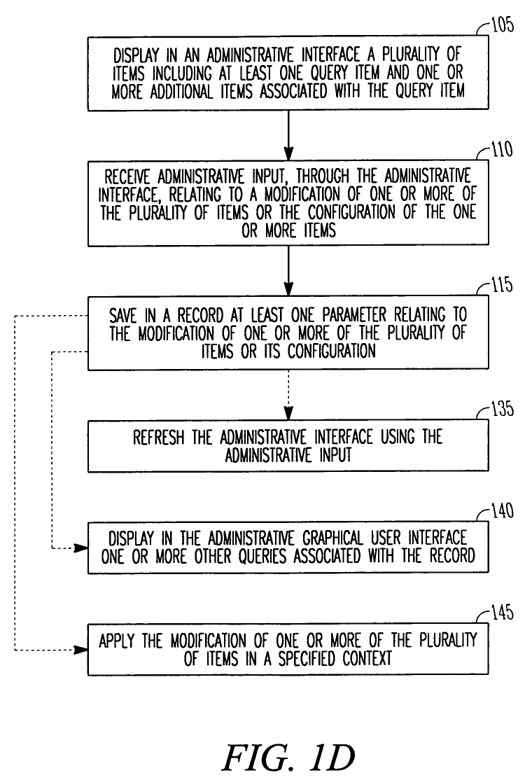

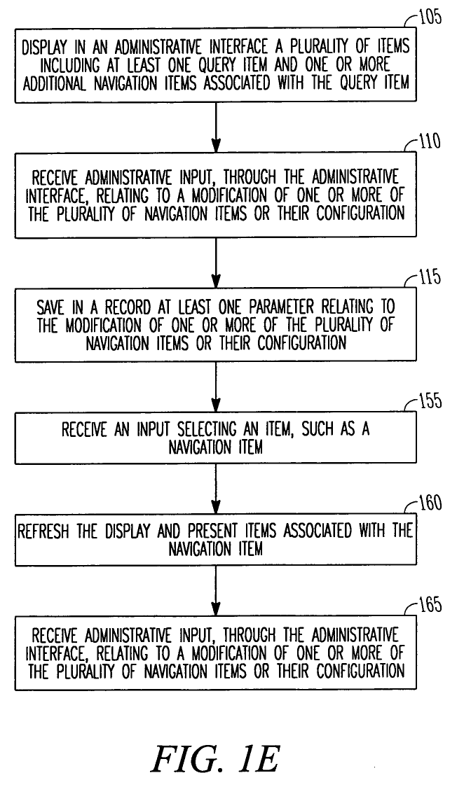

FIG. 1A is a block diagram illustrating generally one conceptualization of such a mechanism to improve the user experience. The example of FIG. 1A depicts four major components. An intuitive WYSIWIG-like search experience editor 100 permits an administrative or like user to perform searches and to implement one or more modifications to such searches to affect the search experience or subsequent users—particularly end-users. A search experience modification record 101 records information about the search being performed and the edits to such search being made by the administrative user using the search experience editor 100. A subscription engine 102 determines which particular tailored search, if any, should be applied to a particular end-user query, which can be called a trigger matcher. A search tailoring engine 103 applies the tailoring to the pre-tailoring results of running the query.

These component are used in concert with a search system, which could be a search engine like Google or Yahoo or FAST.

FIG. 19 shows the effects of operating the search experience editor, without explicitly showing the search experience editor itself The search experience editor user 1905 interacts with the search experience editor's editing interface 1910. The search experience editor user 1905 enters a query 1915, which is passed to the search system 1920 and is also recorded 1916 in the search experience modification record 1917. The search system 1920 runs the query 1915, producing results 1925, which are displayed in the search experience editor's editing interface 1930. Note that 1930 is the same interface as 1910, but at a later moment in time. The search experience editor user 1935 (the same user as 1905, but at a later moment in time) uses a control in the search experience editor's editing interface 1930, for example to delete one of the search results 1926. This results in the modified list of search results 1927 being displayed in the search experience editor's editing interface 1940, and at the same time results in the editing command 1955 (in this example, to delete result C) being written to the search experience modification record 1950 (the same search experience modification record as 1917, but at a later moment in time) for the search.

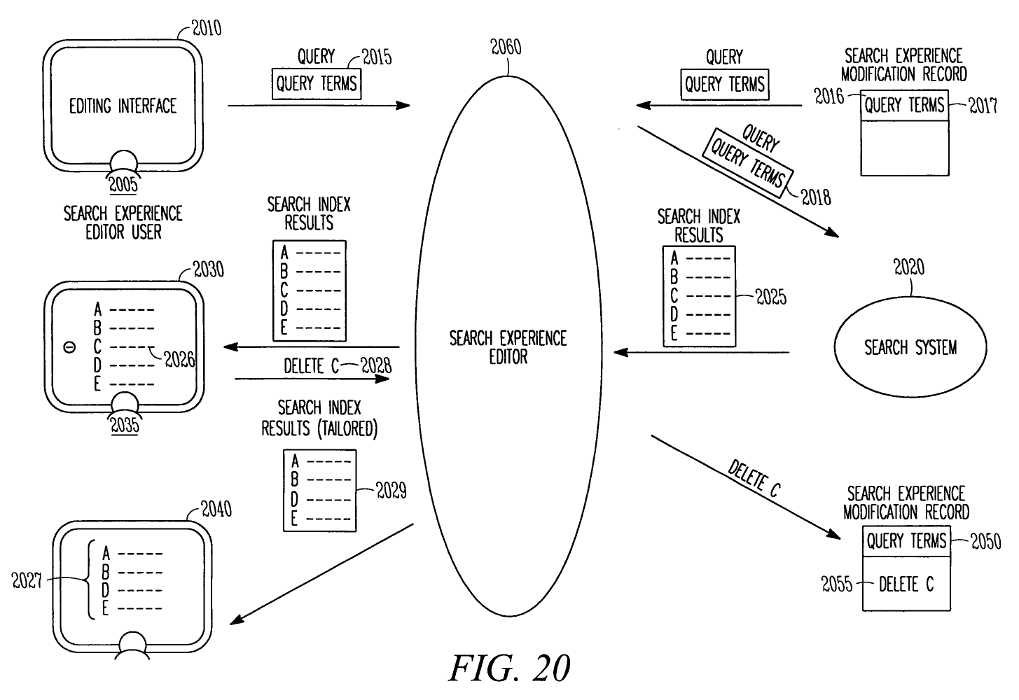

FIG. 20 shows the same operations as FIG. 19, but with the search experience editor shown explicitly. The search experience editor user 2005 enters a query 2015 into the search experience editor's editing interface 2010. The search experience editor 2060 receives the query 2015 and passes it 2018 to the search system 2020, and also records it 2016 in the search experience modification record 2017. The search system 2020 runs the query 2018, producing results 2025, which are returned to the search experience editor 2060 and displayed in the search experience editor's editing interface 2030. The search experience editor user 2035 uses a control in the search experience editor's editing interface 2030, for example to delete one of the search results 2026. The search experience editor 2060 receives the editing command 2028 and performs two actions in response: it modifies the list of search results 2029 and displays the modified list 2027 in the search experience editor's editing interface 2040, and it writes the editing command (in this example, the command 2055 to delete result C) to the search experience modification record 2050 for the search.

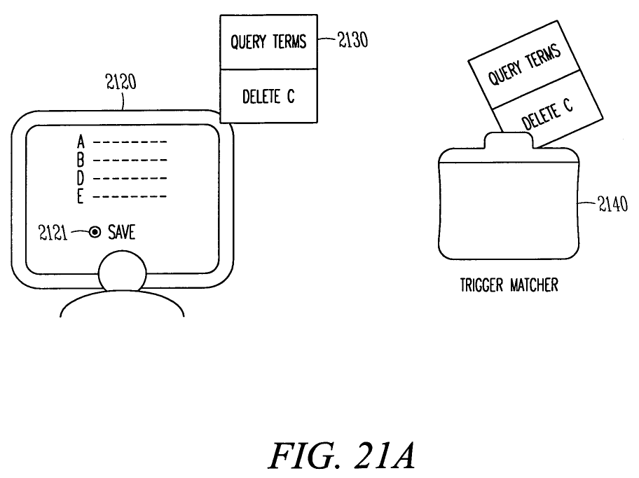

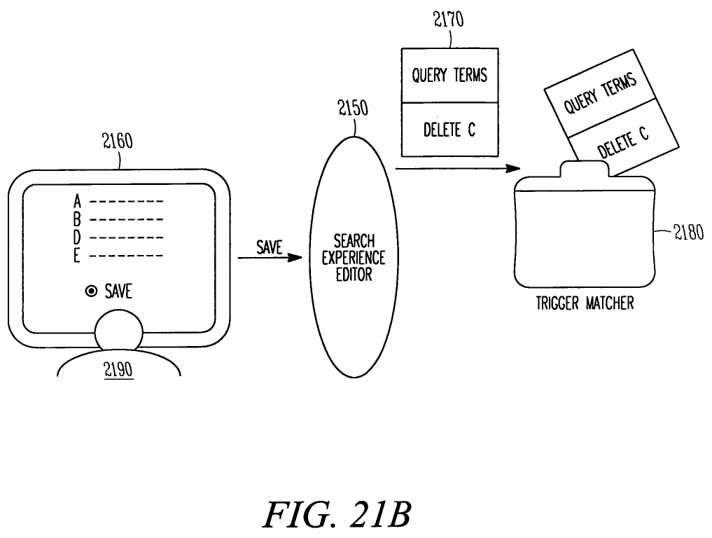

FIG. 21A shows the effects of saving a tailored search experience. When the search experience editor user 2110 selects the SAVE control 2121 in the search experience editor's editing interface 2120, the search experience modification record 2130 is passed to the trigger matcher 2140, where it is stored in persistent storage. FIG. 21B shows the same operation, with the search experience editor's role made explicit. When the search experience editor user 2190 selects the SAVE control 2161 in the search experience editor's editing interface 2160, the search experience editor 2150 passes the search experience modification record 2170 to the trigger matcher 2180, where it is stored in persistent storage.

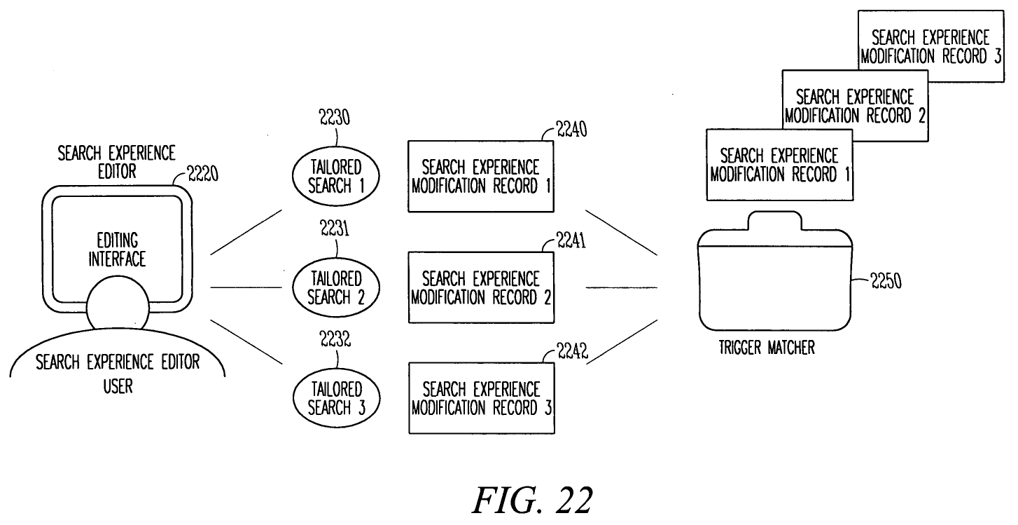

FIG. 22 shows the typical usage of the search experience editor. The search experience editor user 2210 edits numerous searches, one at a time, using the search experience editor's editing interface 2220 and going through sequences of actions like those shown in FIG. 19 (though not limited to a single editing operation), followed by a SAVE action as shown in FIG. 21, for each. This results in numerous tailored searches (shown in the figure as 2230, 2231, & 2232, but with no restrictions on the number) being created, each with a search experience modification record ((shown in the figure as 2240, 2242, & 2242). The search experience modification records are all sent to the trigger matcher 2250 and stored.

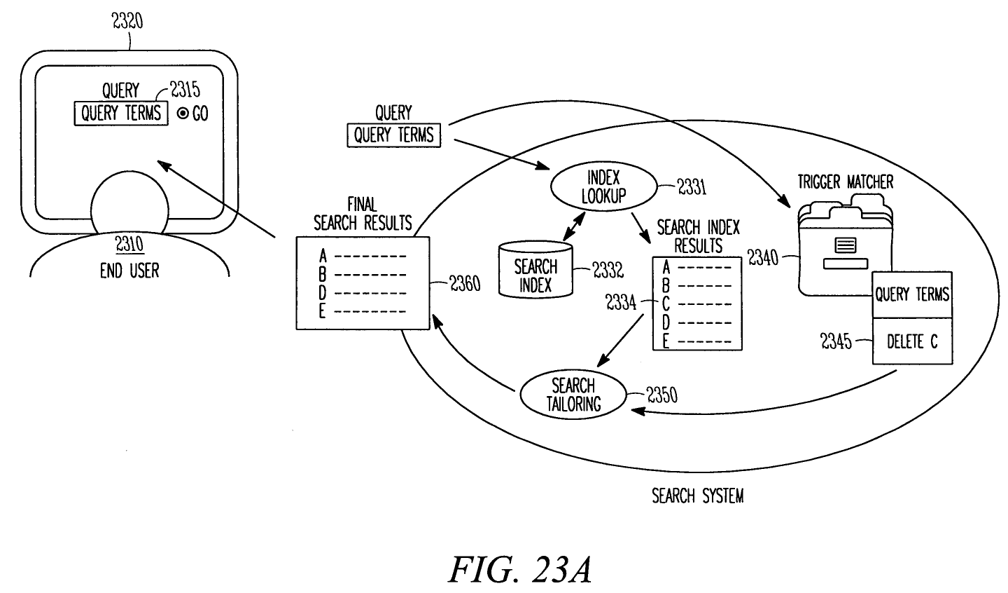

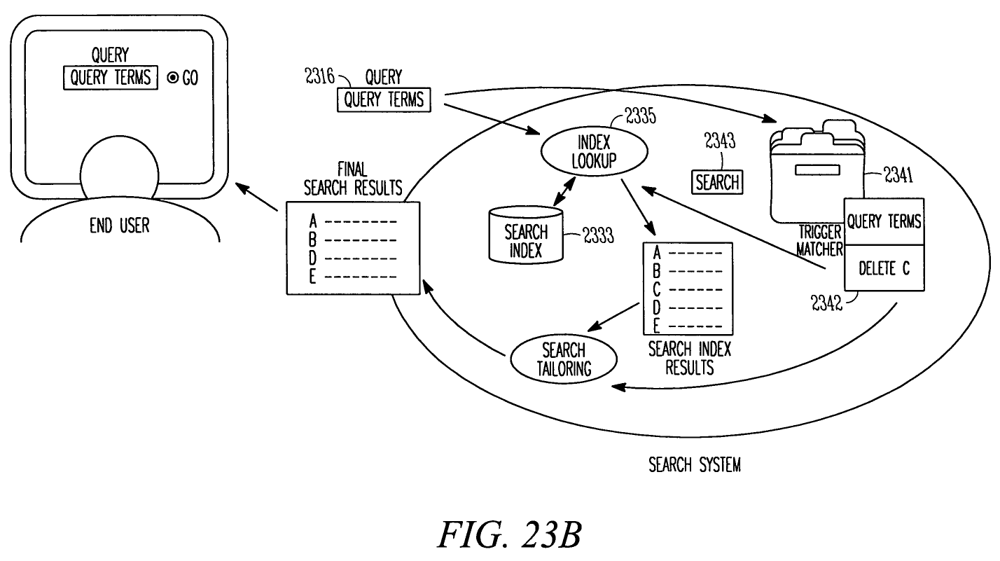

FIG. 23A shows the use of tailored searches in the end-user interface 2320. The end-user 2310 enters a query 2315 into the end-user interface 2320. The query 2315 is sent to the search system 2330. The search system's index lookup component 2331 performs a lookup of the query on its search index 2332 (consistent with standard operation of search engines) producing a set of search results 2333. For expository purposes this figure continues the example shown in FIG. 19; the search results are the same as those in 1925. Note result 2334 is the same result as 1926; it is the result deleted by the search experience editor user in FIG. 19; the result referred to by the command 1955 recorded in the search experience modification record 1950. The end-user query 2315 is also sent to the trigger matcher 2340. This query is matched against all of the queries for all of the tailored searches that the trigger matcher has in its storage, and is found to match the query stored in the search experience modification record 2345—which (to continue the example) is the search experience modification record shown as 1950 in FIG. 19. The search results 2333 and the search experience modification record 2345 are sent to the Search Tailoring component 2350. The Search Tailoring component 2350 performs the commands recorded in the experience modification record 2345 (here, to delete result C) on the search results 2333, thereby removing result 2334 from the search results. The output of performing the recorded commands on the search results is a set of final search results 2360 which are sent to the end-user interface and displayed to the user. These results 2360 are the same as those shown in the search experience editor's editing interface 1940; this is part of the WYSIWYG aspect of the search experience editor.

In different circumstances, the search experience editor may be used by different populations. In some circumstances—for example, an online vendor—only a website administrator will typically have access to the search experience editor, so that the tailoring of searches is well controlled. In a call center search application, experienced call center agents may have access to the search experience editor, so that they can improve the search experience for their peers and for less experienced agents, but inexperienced agents may not have access. In a search application for a community of interest (say, summer camp enthusiasts), in certain examples, all community members would have access to the search experience editor. In other examples, there would be some mechanism to identify and discriminate between deemed experts or other such members that would have access to the search experience editor, and other members that would not. For an internet search engine, all ranges of control are conceivable, from no-one having access to the search experience editor to everyone having access to the search experience editor. In certain examples, a search engine could supply two alternative end-user search interfaces, one returning tailored results and one returning “raw” results.

Note that “a search” need not refer to a single particular search string, but can refer to a set of aggregated individual queries. For example, “Dog” and “dog” can be two instances of the same search, as can “dog” and “dogs”, as can “dog” and “mutt”. Similarly, “how do I disable logging”, “how can I disable logging”, “disable logging”, and “disable tracing” all may be instances of the same search. In certain examples, a particular tailored search applies to a set of individual queries that are conflated by the search system. Examples of techniques used to conflate the queries above are capitalization normalization, stemming, and synonym usage, and stopword recognition. In fact, a tailored search can apply to any set of queries that can be conflated using any technique. It can be valuable, in certain examples, to conflate queries that are a bit further afield, such as “disable logging” and “disable logging on Windows”, enlarging the set of queries for a particular tailored search so as to allow more end-users to reap the benefits of the tailoring.

“Search index results” typically refers to a set of items, usually documents, found by a search engine in its index. Search index results can be regarded as distinct from advertisements that are often placed on the screen that to fund the free (to the end-user) Internet search provided by Google or Yahoo. In the present context, such advertisements would not be considered part of the search index results, nor would the spelling suggestions offered by certain search engines, nor would the Related Names links offered by Ask.com, nor the stock quotes lookup widget provided by some search engines when a company or stock symbol is recognized in the query, nor the mortgage calculator provided when deemed relevant to the query, nor would other search results that fall outside search index results.

### General Description

A search experience editor is useful to provide an interface to an administrative user and to receive input relating to one or more modifications of an end-user search experience. In an example, the administrative user can manage an end-user's search experience through an administrative search experience editor that provides the administrative user with graphic visual information about the information that will be presented to an end-user in response to an end-user-query. The end-user query can include, for example, textual or like information entered by the end-user. In certain examples, the end-user query can also include session context or metadata. In an example, the search experience editor provides an administrative interface that presents one or more items that are graphically load out in a configuration that is representative of a layout and other graphical appearance of an end-user interface. Such substantial similarity, in the present context, provides a what-you-see-is-what-you-get (WYSIWIG) search-experience interface that presents to an administrative user information such as search results laid out very similarly to how they would actually appear in an end-user interface.

In FIG. 1B, at 105, a plurality of items are displayed in an administrative user interface. In this example, the plurality of items includes at least one query item and one or more additional items associated with the query item. In an example, the one or more additional items include search results responsive to the query item. The query item may include a text string in a query field. In an example, the query item alternatively or additionally includes one or more categorized specifiable parameters, such as metadata or context-based parameters. The query item may include one or more specifiable parameters that are selectable through a menu-driven interface, such as a pull-down menu allowing selection of a product group, user group, or author. In an example, displaying at least one additional item includes displaying a result item, a results area, a featured result, a featured result area, a navigation item, a navigation area, a direct answer, an advertisement, or a specialized transaction interface. In an example, a result item includes a link to a document or other resource. In an example, a featured result includes a “best bet” item, such as an item that has been determined to likely be responsive to the query. In another example, a featured result is includes a sponsored result. An advertisement is sponsored content, such as a promotion of a product or service. In various examples, an advertisement for a shoe brand is presented in response to the query “shoes.” In various examples, the advertisement includes a graphic, an animation, a sound, or a video. In an example, a navigation item is a link to a web page. In an example, a navigation item includes a link that spawns a search, with a resulting display in the administrative interface with the same items returned by the spawned search. In an example, a specialized transaction interface is an interface into which some or all of the query item may be passed, possibly with additional items specified in the administrative interface, and which performs some particular transaction or operation using such input parameters. In an example, the transaction performed by a specialized transaction interface is looking up an item in a specialized lookup function, such as looking up a stock quote, given a stock symbol, looking up a phone number, or looking up a summer camp in a summer camp registry. In an illustrative example, the transaction performed by a specialized transaction interface is purchasing tickets, such as for a concert, theatre performance, sporting event, or other event. In an example, the transaction performed by a specialized transaction interface is purchasing a retail or wholesale item. The specialized transaction interface may includes a graphic, an animation, a sound, or a video.

At 110, administrative user input is received, such as relating to a modification or tailoring of one or more of the plurality of items or how they are configured or displayed. In an example, a title or synopsis of an item is modified. In another example, an item is added to or removed from the tailored display of the administrative interface. For example, a non-applicable or redundant item may be removed from the tailored display of the search results so that an end-user does not have to consider the non-applicable or redundant item. In another example, a non-applicable or redundant specialized interaction interface entry point may be removed from the tailored display of the administrative interface. In another example, a relevant specialized interaction interface entry point may be added to the tailored display of the administrative interface. In another example, an item is moved to a different organizational unit or a different location in the tailored display of the administrative interface. For example, an item may be moved or copied from one pane to another, such as from a search index results pane to a best bet pane of the tailored display. In another example, the items are reordered in the tailored display. For example, a highly pertinent item may be moved toward the top of a results list. In another example, an item is edited or renamed. In another example, a property of an item is edited. In another example, two or more items are merged. In another example, a preview of a tailored display of the end-user search interface is presented.

Tailoring a search experience by modifying an item configuration may include, for example, changing an order in which the items are displayed, changing a division of items into display regions such as panes, or highlighting or otherwise emphasizing of one or more featured items. In certain examples, an advertisement can be moved, enlarged, added, or removed (i.e. dissociated) from the tailored display using the administrative interface. In another example, an administrative-user of the search experience editor can also directly access an authoring system, such as to modify a text document or other item. In another example, the administrative user of the search experience editor does not have permission to edit documents, but instead can access a recommend edit control, which initiates an interface that receives a request for modification of a document by an owner of edit privileges to the document.

In an example, a parameter is specified to be passed to a specialized transaction interface. In another example, the query item, part of the query item, or one or more of the additional items associated the query item is specified to be passed to a specialized transaction interface.

At 115, at least one parameter relating to the modification of one or more of the plurality of items or the configuration of the one or more items is saved in a tailoring record. In an example, the record is saved on a network storage unit, for example, such as a hard drive coupled to a server.

The items are optionally displayed in a WYSIWYG-like search experience editor administrative interface that displays items to the administrative user substantially as the items would be displayed in an end-user search interface. In an example, one or more controls that are not available in the end-user search interface are displayed in the WYSIWYG administrative user interface. The administrative user input for tailoring the end-user's search experience is receivable through the controls. Examples of the controls include, without limitation, an icon, a link, a drag-and-drop capability, a text box, a pulldown, or a slider.

FIG. 1C schematically illustrates certain optional aspects of the method of FIG. 1B, including, at 120, receiving a first query through an end-user search interface and, at 125, identifying a first query class associated with the first query. In certain examples, the query may include both user input and context. In various examples, the context includes a user profile, one or more user preferences, a user status, such as a platinum support membership. In another example, context includes information extracted from a website through which a user is interfacing, such a German language site, which passes German language tag that is considered as search context.

At 130, it is determined whether the first query class contains at least one trigger query class associated with the record. As an illustrative example, the query class “used bicycle parts” could include the trigger query class “bicycle parts.” In an example, a trigger query class is selected based upon the closeness, e.g. the similarity in scope or language, of the trigger query class to the first query class. For example, the trigger query class “bicycle parts” is closer to “used bicycle parts” than the trigger query class “bicycle.” In FIG. 1C, at 131, at least one responsive item in the end-user search interface is displayed using the at least one parameter relating to the modification of one or more of the plurality of the items or the configuration of the one or more items. In an example, a responsive item is an item returned by a search engine or other software or an item specified by a search experience modification record.

FIG. 1D provides a flowchart that illustrates another example of a method. As previously described, an administrative interface such as a search experience editor is displayed at 105, an administrative user input is received at 100, and at least one parameter is saved in a record at 115. One or more optional operations are then performed. At 135, the administrative interface is refreshed using the administrative input. In an example, receiving administrative user input includes receiving an input changing the at least one query item, and refreshing the administrative interface includes updating the one or more additional items in response to changing the at least one query item.

At 140, one or more other queries associated with the record are displayed in the administrative user interface. In an example, the one or more queries are presented in a query match pane.

At 145, the modification specified by the administrative user input is applied in a specified context. In an example, the modification is applied only when an end-user specified query contains at least one trigger query class associated with the modification. In another example, the specified context is determined using a history of one or more previous searches. In another example, the modification is applied when the query includes a specified product or product group, a specified document type, a specified author, a specified user group, or a specified customer group. In another example, the modification is applied more broadly. In an example, the modification is applied to an underlying knowledge representation. For example, a modification to an item may be applied to all instances in which the item is displayed as a search result.

In the example of FIG. 1E, the displaying at 105 includes displaying one or more selectable navigation items and the receiving administrative user input at 110 includes receiving a modification relating to the one or more navigation items. At 155, an input is received selecting the navigation item. If the navigation item is selected, at 160 the display is refreshed, and items associated with the navigation item are presented. At 165, a modification of one or more of the items associated with the navigation items, or the configuration thereof, is received as administrative input and stored in a record.

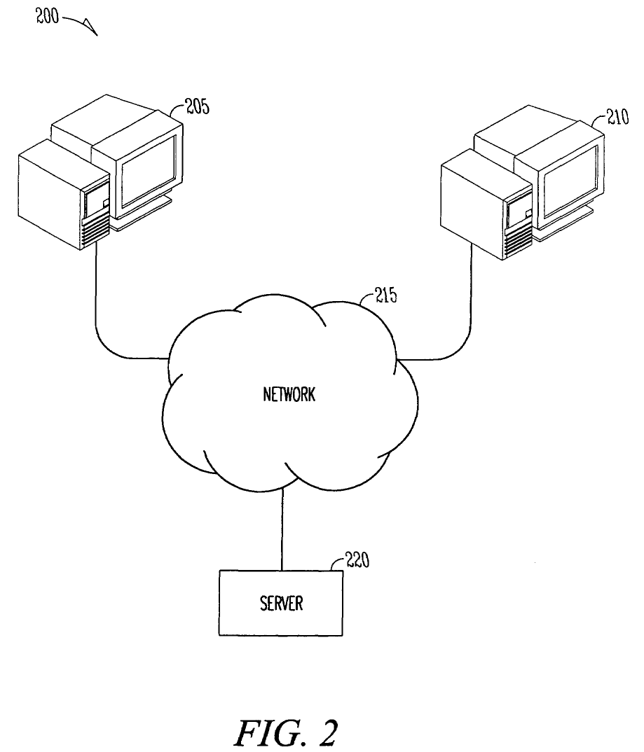

The search experience editor is typically implemented in a network environment. FIG. 2 illustrates an example network 200 in which a search experience editor can be implemented. One or more computing devices 205, 210 are connected to a network 215. In an example, the network includes a public network, such as the internet. A server 220 is also connected to the network. In an example, one or more of the computing devices 205, 210 access information on the server 220 and display the information in a user interface. In an example, a user inputs a query through computing device 205. The query is routed to the server, which executes the query and provides responsive information that is displayed in the user interface. In an example, a search experience editor administrative user having proper login credentials accesses the server through a network and provides instructions through an administrative interface that allows the search experience editor administrative user to manage information that is displayed to end-users.

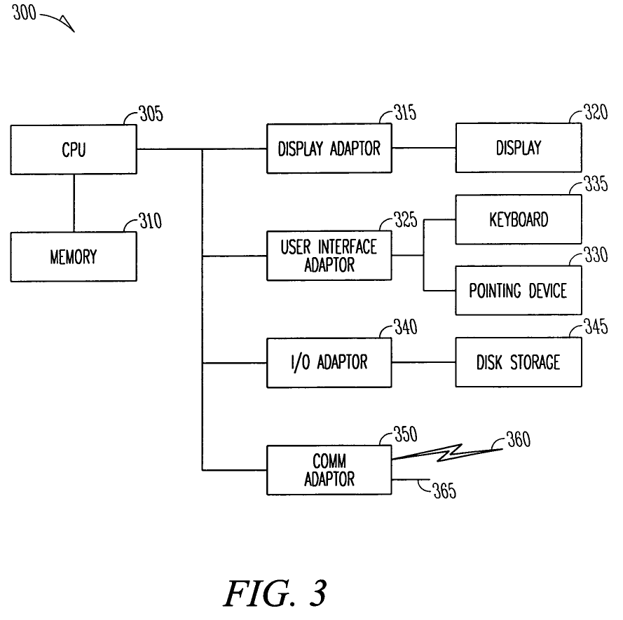

FIG. 3 is a schematic illustration of an example computing device 300. The computing device includes a central processor unit (CPU) or other processor 305, a memory circuit 310, a display adapter 315, a display 320, a user interface (UI) adapter 325, a pointing device 330, a keyboard 335, an input/output (IO) adapter 340, a disk storage unit 345, and a communications adapter 350. In an example, computing device 355 is connected to public network via network interface cable 360 or a wireless data link 365. In an example, an administrative user interface or end-user interface is run on the computing device 300.

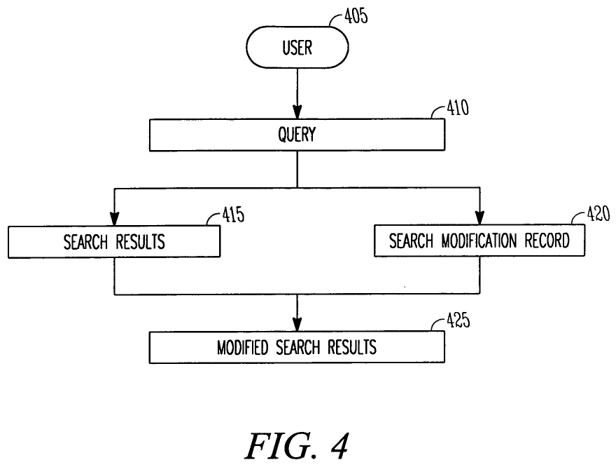

FIG. 4 schematically illustrates application of a search experience modification record to search results. In this example, a user 405 provides query 410 through an interface, such as an end-user interface or an administrative interface. The query includes, for example, a text string, a selectable parameter (e.g. from a menu), or contextual information, such as information about a site or page that is displayed in the end-user interface. The query 410 is used to develop search results 415. In an example, the search results include items that are responsive to the query, such as “help” resources for the end-user. A search experience modification record 420 is also identified using the query 410. In an example, the search experience modification record includes items to be displayed, items not to be displayed (i.e., suppressed items), information about how to display the items, such as an item order, item location on the screen, graphical aspects of the items such as size or highlighting, or other information. The search experience modification record is typically created using an administrative interface that shows, for example, items in a configuration representative of how the items will be actually presented in an end-user interface. Modified search results 425 are determined using the search results 415 and the search experience modification record 420. For example, the modified search results may be presented in a different order than the search results 415, or they may include more, fewer, or different items than the search results 415, as specified by the search experience modification record. The modified search results are presented in an administrative interface or end-user interface.

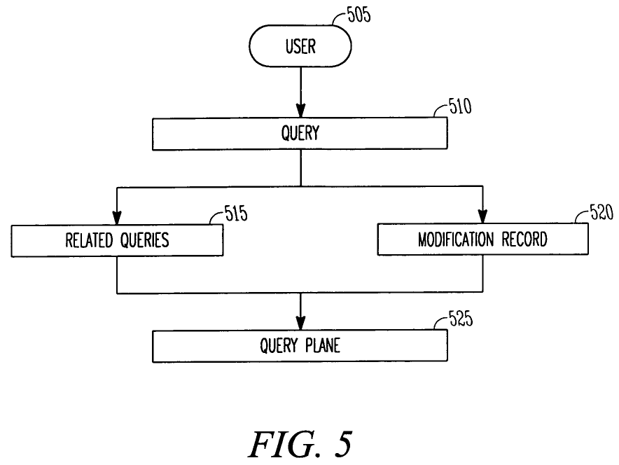

FIG. 5 schematically illustrates an example of application of a search experience modification record to search results. In this example, a user 505 provides a query 510 through an interface, such as an end-user interface or an administrative interface. Alternatively, the query 510 is retrieved from a query log (which typically includes many actual user-queries) or otherwise identified. The query 510 typically includes, for example, a text string, a selectable parameter (e.g. from a menu), or contextual information, such as information about a site or page that is displayed in the end-user interface. The query 510 is used to identify a group of related queries 515. In an example, the related queries include other queries in a query class defined by or determined from the query 510. The query is also used to identify at least one modification record 520. The group of related queries 515 and the modification record 520 are used to populate a query pane. In an example, the modification record 520 includes queries that are added to the query pane or suppressed from the query pane. In an example, the modification record 520 includes queries that are added to or suppressed from the query class of the query 510. The query pane is presented in an interface, such as an administrative interface. In an example, the query pane allows for assessment and modification of queries responsive to a query string. In an example, modification of the group of queries and application of such modification through a search experience record allows for administrative construction of a specified end-user search experience or management of sponsored results.

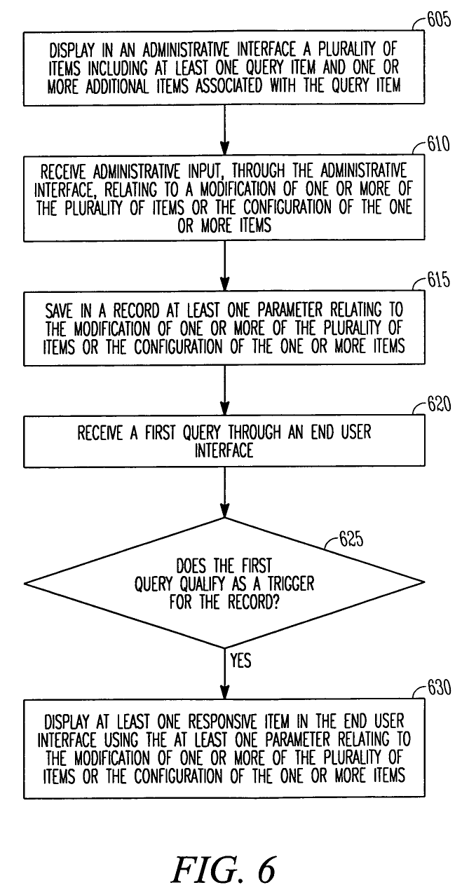

FIG. 6 is a schematic illustration of an example method that associates the work performed in the administrative interface with the modifications performed on the search results, such as on the search index results or on the other returned content. At 605, a plurality of items including at least one query item and one or more additional items associated with the query item are displayed in an administrative interface. At 610, administrative user's input-relating to a modification of one or more of the plurality of items or their configuration, is received through the administrative interface. At 615, at least one parameter relating to the modification of one or more of the plurality of items or their configuration is saved in a record. In an example, the administrative interface display is refreshed to reflect the modification of one or more of the plurality of items or their configuration.

At 620, a first query is received through an end-user interface. At 625, it is determined whether the first query qualifies as a trigger for the record. In an example, a query qualifies as a trigger if the query is in a list of queries or query classes associated with the record, or if the query contains a specified query class or is in a specified query class. In an example, determining whether the first query qualifies as a trigger for the record includes identifying a first query class associated with the first query, and determining whether the first query class qualifies as a trigger for the record. In an example, identifying a first query class includes determining a normalized version of the first query. In an example, receiving a first query includes receiving first and second query strings, and determining whether the first query qualifies as a trigger includes determining a query class using the first query string, the second query string, or both, and determining whether the query class qualifies as a trigger.

If the first query qualifies as a trigger, at 630, at least one responsive item in the end-user interface is displayed using the at least one parameter relating to the modification of one or more of the plurality of items or the configuration of the one or more items. In an example, a set of resources are searched, and a result of the searching is displayed. In an example, the resources may include text documents, web pages, animations, video, audio, or other content. The result of the searching is modified using the record. For example, an item in the result may be moved upward in the displayed search result or presented as a best bet item instead of merely an item in a results list. As another example, a specialized transaction interface listed in the record is displayed in response to the first query qualifying as a trigger.

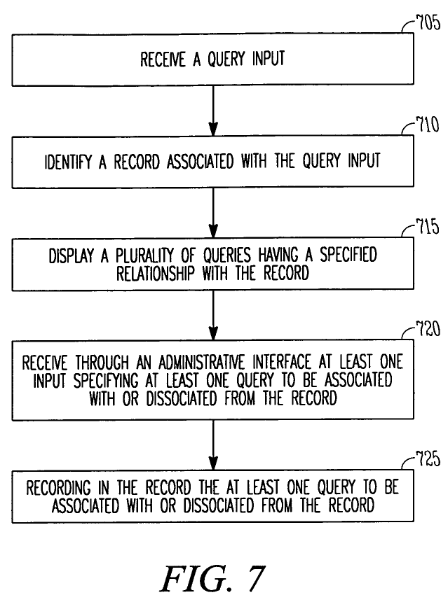

FIG. 7 is a schematic illustration of an example of a method that includes receiving through an administrative interface at least one administrative user input specifying at least one query to be associated with or dissociated from the triggers of record, and recording in a record the at least one query to be associated with or dissociated from the triggers of record. At 705, a query input is received. At 710, a record associated with the query input is identified. At 715, a plurality of queries having a specified relationship with the record is displayed. In an example, displaying a plurality of queries having a specified relationship with the record includes displaying a plurality of queries that are triggers for the record. In an example, displaying a plurality of queries having a specified relationship with the record includes displaying a plurality of queries found in any query logs (e.g., entered by previous users) that are in the same query class as the query input 705. In an example, displaying a plurality of queries having a specified relationship with the record includes displaying a plurality of queries found in the query logs (that is, entered by previous users) each of whose query classes contain the query class of the query input 705. In an example, displaying a plurality of queries having a specified relationship with the record includes displaying a plurality of queries found in any query logs (e.g., entered by previous users) each of whose query classes is contained by the query class of the query input 705. For example, the record may include a sponsored result, and displaying a plurality of queries having a specified relationship with the record may include displaying queries that are triggers for the sponsored result. This advantageously permits the query pane to show an advertisement buyer which queries the buyer will get or pay for with a sponsored advertisement or link, providing a “try-before-you-buy” option for the buyer. At 720, which is optional, at least one input is optionally received to specify at least one query to be associated with or disassociated from the record. In an example, a query associated with the record qualifies as a trigger for the record. In an example, a query disassociated from the record does not qualify as a trigger for the record, although it otherwise might have qualified (e.g., by being in the same query class as the query input 705). Optionally, at 725, at least one query to be associated or disassociated from the record is recorded in the record. Certain examples permit display of a first list of queries that are triggers and a second list of queries that are not triggers. An administrative interface allows queries to be dragged and dropped between the first and second lists.

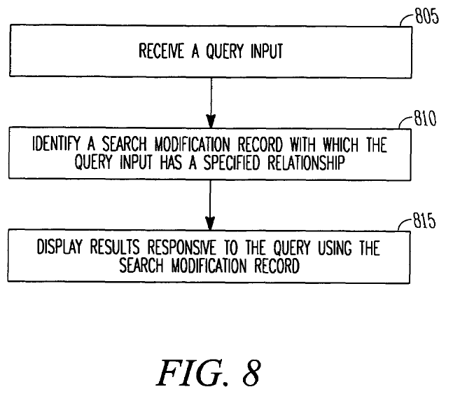

FIG. 8 is a schematic illustration of an example of a method that includes receiving a query input, identifying a search experience modification record with which the query input has a specified relationship, and displaying one or more results responsive to the query using the search experience modification record. At 805, a query input is received. At 810, a search experience modification record with which the query input has a specified relationship is identified. In an example, identifying a search experience modification record with which the query input has a specified relationship includes identifying a search experience modification record associated with the query class associated with the query received at 805. In certain examples, identifying a search experience modification record with which the query input has a specified relationship includes identifying a search experience modification record associated with a query class that the query received at 805 contains. In certain examples, identifying a search experience modification record with which the query input has a specified relationship includes identifying a search experience modification record associated with a query class contained by the class of the query received at 805 contains. In certain examples, identifying a search experience modification record with which the query input has a specified relationship is carried out by a subscription engine, such as of the sort that might be capable of use by an online newspaper to determine whether any of the day's news articles match a particular user's interests. In this illustrative example, the set of search experience modification records can be conceptualized as corresponding to the set of news articles and the query input can be conceptualized as corresponding to a user's interests. The subscription engine compares the query input to the trigger terms in each search experience modification record. Subscription engines are typically architected for rapid comparisons in the presence of large numbers of news articles and large numbers of user interests. For example, the subscription engine typically orders criteria such that rare criteria are examined first, for matching purposes, or such that computationally cheap matching tests are performed before computationally expensive matching tests, or both.

This is particularly suitable in the present context, in which there may be large numbers of search experience modification records and large numbers of query inputs. At 815, the display provides results responsive to the query using the search experience modification record. This may include displaying results using an instruction specified by the search experience modification record, such as to add an item to the administrative interface display, to remove an item from the administrative interface display, to move an item to a different organizational unit or a different location in the administrative interface display, to reorder an items or items on the display, to edit a displayed item, to rename a displayed item, to merge two or more items, or to edit a property of an item.

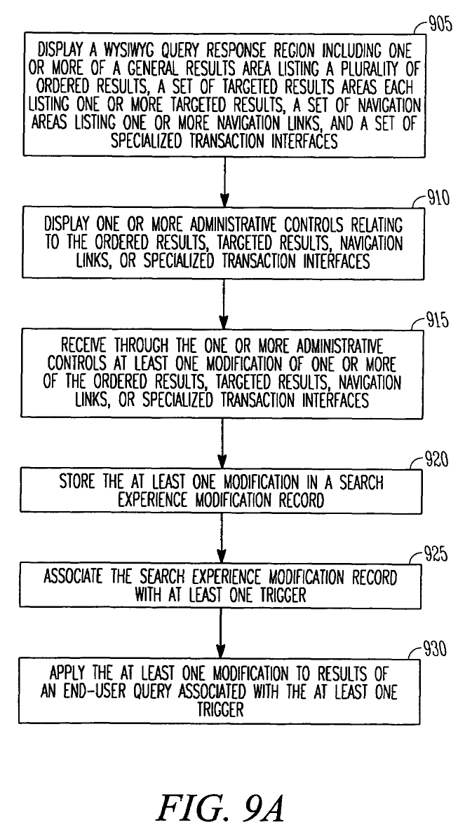

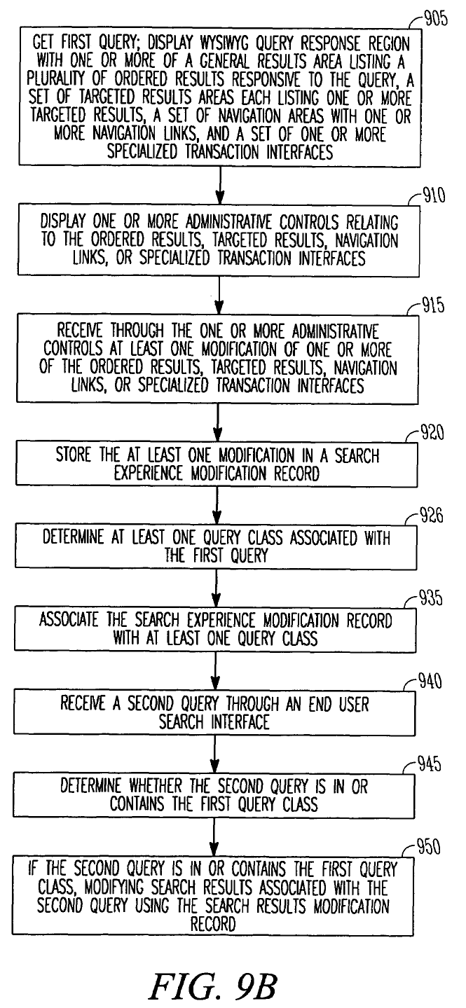

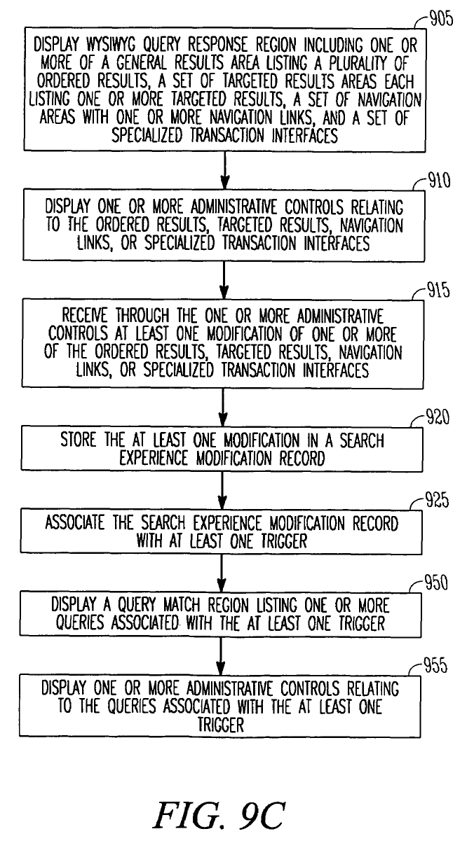

FIGS. 9A-9C are schematic illustrations of an example method that includes displaying a WYSIWYG query response region. At 905, a WYSIWYG query response region is displayed. The WYSIWYG response region includes one or more of a general results area listing a plurality of ordered results, a set of targeted results areas each listing one or more targeted results, a set of navigation areas each listing one or more navigation links, and a set of specialized transaction interfaces. At 910, a display provides one or more administrative controls relating to the ordered results, targeted results, navigation areas, navigation links, or specialized interfaces. In an example, such displaying of one or more administrative controls includes displaying at least one such control in the WYSIWYG query response region. At 915, at least one modification of one or more of the ordered results, targeted results, navigation areas, navigation links, or specialized interfaces is received from the administrative user through the administrative interface. In an example, the modification includes adding, removing, renaming, merging, or reordering one or more of the ordered results, targeted results, navigation areas, navigation links, or specialized interfaces. In another example, the modification includes controlling the graphical presentation of one or more of the ordered results, targeted results, navigation areas, navigation links, or specialized interfaces, such as by adding one or more graphical elements or animations, specifying such things as one or more of font size, type, and color, highlighting one ore more elements, or specifying the location of one or more the elements on the page being displayed. At 920, the at least one more modification is stored in a search experience modification record.

In certain examples of FIG. 9A, at 925, the search experience modification record is associated with at least one trigger. At 930, the at least one modification is available to be applied to results of an end-user query associated with the at least one trigger.

In certain examples of FIG. 9B, at 926, a first query is received and at least one associated first query class is determined. For example, the first query can be retrieved from a query log. At 935, the at least one first query class is stored with or otherwise associated with the search experience modification record. At 940, a second query is received through an end-user-search interface. At 945, it is determined whether the second query is in or contains the first query class. At 950, if the second query received through the end-user search interface is in or contains the first query class, search results associated with the second query are modified using the search result modification record.

In the example of FIG. 9C, at 950, a query match region is displayed. The query match region lists one or more queries associated with at least one trigger. At 955, one or more administrative controls for the queries associated with the at least one trigger are displayed. In an example, displaying a WYSIWYG query response region includes presenting search results for a first query in the general results area, and the displaying a query match region at 950 includes normalizing the first query and determining a first query class, and populating the query match region with one or more other, different queries or query classes that contain the first query class.

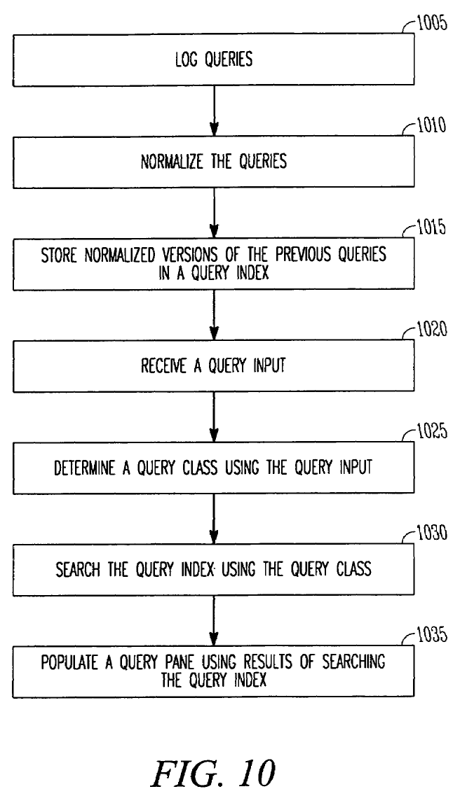

FIG. 10 is a schematic illustration of an example of a method that includes logging queries and populating a query pane using results of searching a query index. At 1005, queries, such as those received through an administrative interface or an end-user search interface are logged. At 1010, the logged queries are normalized. In an illustrative example, “bicycles” or “bicycling” would be normalized to “bicycle” and “bicycling club” would be normalized to “bicycle club”. At 1015, normalized versions of the logged queries are stored in a query index. At 1020, a query input is received. At 1025, a query class is determined for the query input. In an example, the query input is “Minnesota bicycling club” and the resulting query class is “bicycle club.” At 1030, the query index is searched using the query class. In an example, the query index is searched for query classes that are in or contain the query input. In an example, the query classes “bicycle” and “bicycle club” are identified for use in the searching of the query index. At 1035, a query pane is populated using the results of the searching the query index using the appropriate query classes.

### An Example Search Experience Editor

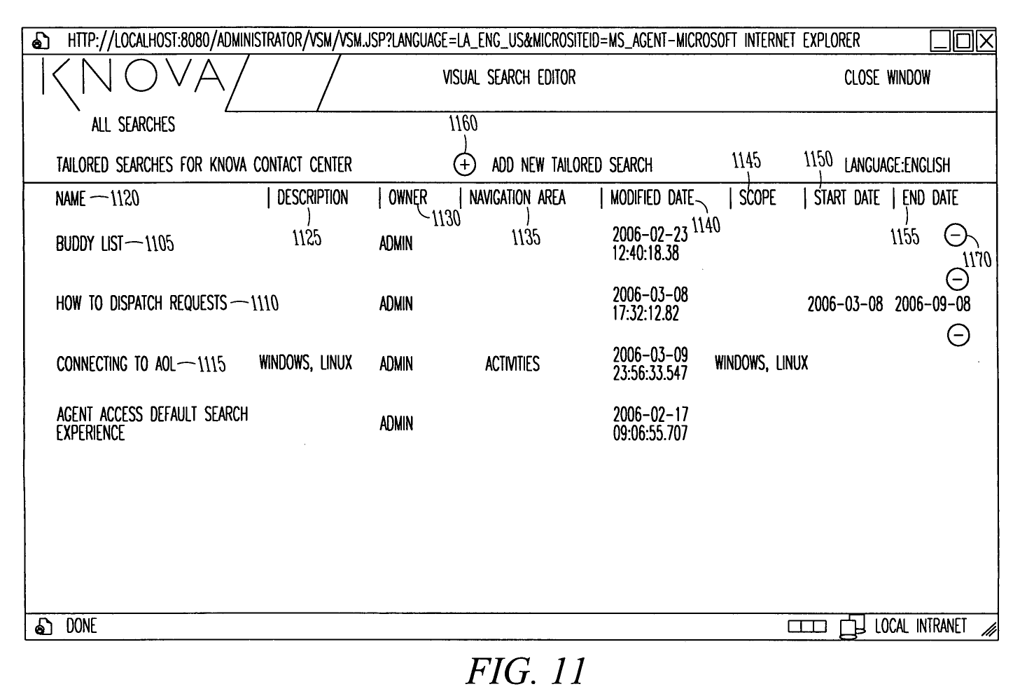

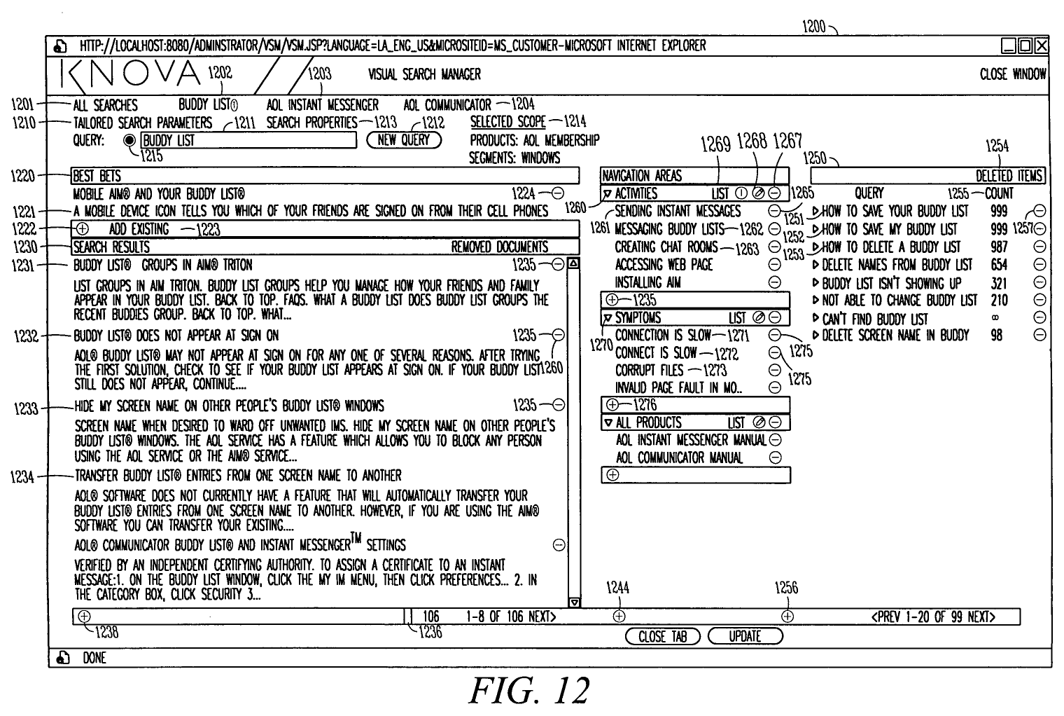

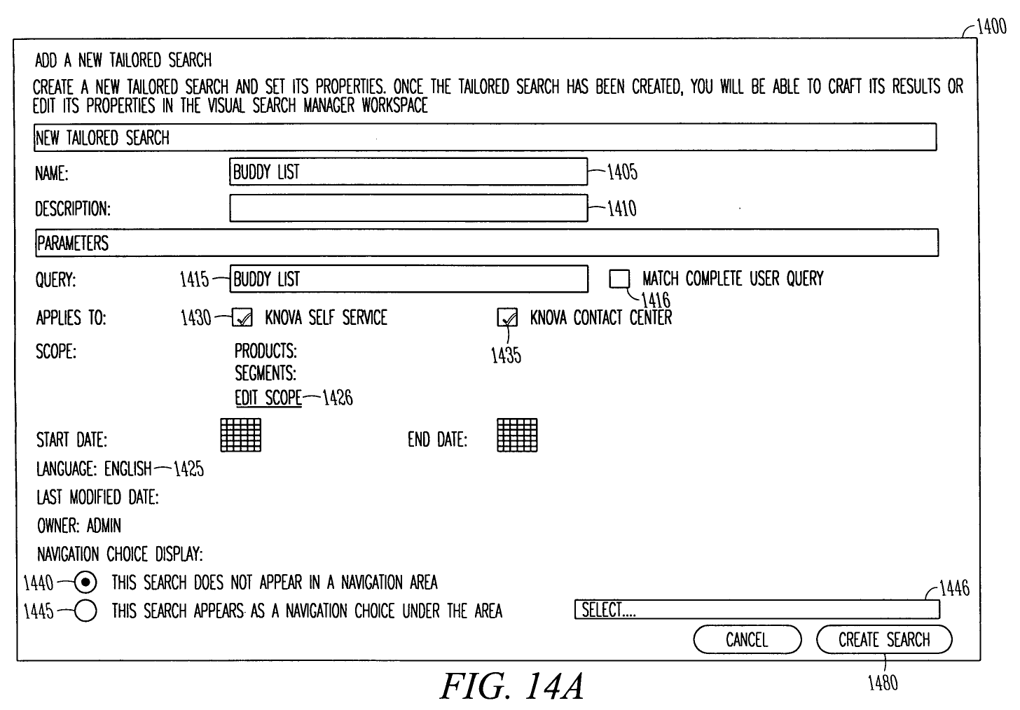

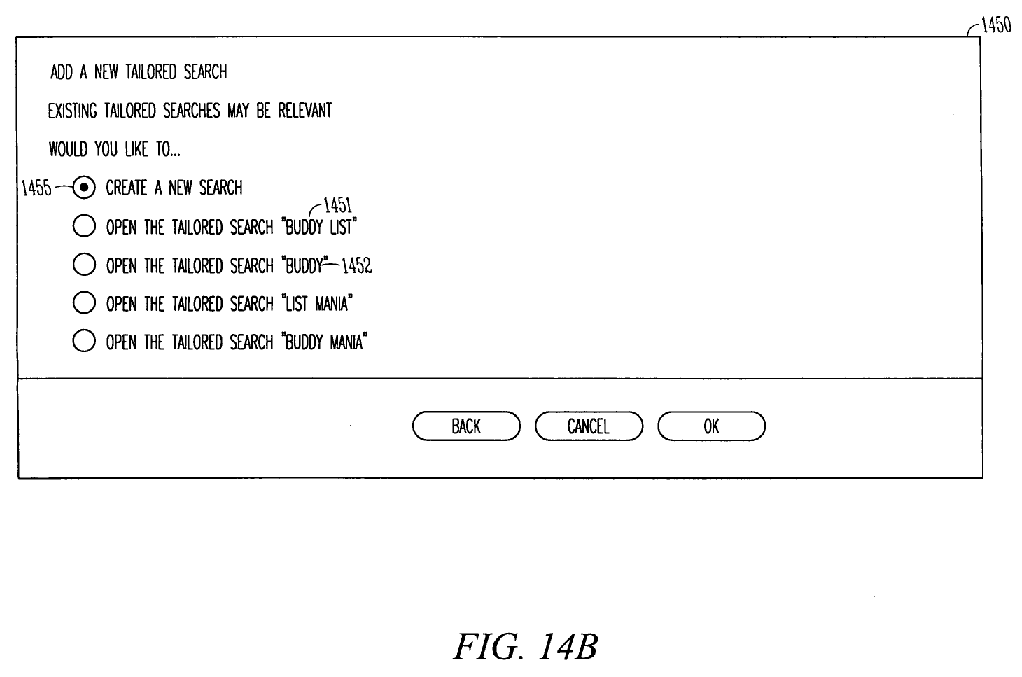

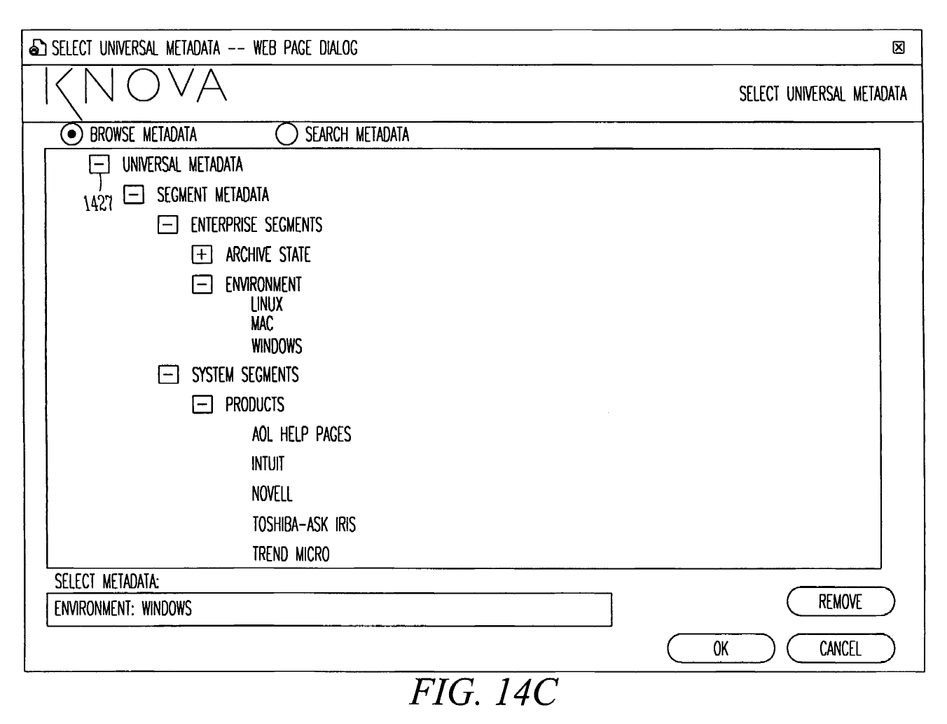

An example administrative interface, sometimes called a search experience editor, is illustrated in FIGS. 11-23B, which show a variety of screen shots or other illustrations of an example visual search experience editor tool. FIG. 11 is an example of an entry point into the visual search experience editor tool. FIG. 11 shows an index of named tailored searches, including “Buddy List” 1105, “How To Dispatch Requests” 1110, “Connecting to AOL” 1115. Such names of tailored searches can be assigned by the administrative user who created the tailored searches using the visual search experience editor tool. In certain examples, the administrative interface is typically made available to users who meet certain access qualifications, such as an administrator, and is typically not available to all users. Search experience parameters can be specified for each tailored search. In this example, assigned names of the tailored searches are listed in a Name column 1120. An administrator-specified description of the tailored search is provided in the description column 1125. The Owner column 1130 lists the creator or owner of the tailored search. Navigation areas in which the tailored search may be displayed as a navigation aid are listed in the Navigation Areas column 1135. For example, the Connecting to AOL tailored search may be displayed in the Activities navigation area or the Features and Functions navigation area. The Date Modified column 1140 lists the date the search was last modified. The Scope column 1145 lists one or more environments in which the tailored search is applied. For example, the Buddy List tailored search may provide access to a Support Site, which may be accessed by end-user customers. In another example, an Install Messenger tailored search provides access to a Search Center, which may be a call center where support representatives can access the Install Messenger tailored search while providing phone support to end-user customers. A product column may also be included, such as to list one or more products to which the tailored search relates. This helps permit different tailored searches to be defined for different products. Similarly, a Group column may also be included, such as to list a user group (e.g., a North American user group) to which the tailored search particularly relates. Likewise, a Segment column could also be included, such as to list a market segment to which the tailored search particularly relates. A new tailored search can be added by selecting an Add New Tailored Search control 1160 In an example, selecting this or a similar control 1160 brings up a window in which information can be provided to populate one or more of the fields in columns 1120, 1125, 1130, 1135, 1140, 1145, 1150, and 1155, as well as other properties, for establishing a new tailored search. Such a window is exemplified by FIG. 14A, and selecting the “Add Search” button in FIG. 14A takes the administrative user to an interface such as the one exemplified by FIG. 12, in which the new tailored search can be defined or edited. A delete control 1170 is provided for each listed tailored search. When the delete control is selected, the associated tailored search is removed from the system. In an example, selecting one of the existing tailored searches 1105, 1110, 1115 takes the administrative user to an interface such as the one exemplified by FIG. 12, in which the existing tailored search can be further defined or edited. Selecting the “Search Properties” link 1213 in FIG. 12 takes the administrative user to an interface such as the one exemplified by FIG. 14A, in which the properties of an existing tailored search can be reviewed or set or modified.

Each tailored search has an associated search experience modification record. Information provided to populate columns 1120, 1125, 1130, 1135, 1140, 1145, 1150, and 1155, as well as other properties, are stored in the search experience modification record, and the search experience modification record provides this information to the search experience editor so that it can display a tailored search index such as is shown in FIG. 11. FIG. 14A provides a sample interface for adding a new tailored search.

As mentioned above, if a tailored search listed in FIG. 11 is selected, such as by selecting the name of the tailored search (e.g. Buddy List) with a pointing device such as a mouse, a search experience editor's editing interface is presented. An example editing interface 1200 is shown in the example of FIG. 12. The information shown in FIG. 12 relates to the “Buddy List” tailored search of FIG. 11. The editing interface 1200 is an administrative interface that enables its administrative user to tailor the experience of an end-user who searches on a particular query. In some instances, for example, one or more of the results provided by a search engine is not relevant or responsive to a specified query. Such non-responsive items can be deleted by the administrative user in the administrative interface, which causes them also to be deleted from the result set seen by an end-user who enters that query.

### Search Experience Editor Panes

In an example, the editing interface 1200, also called the administrative interface 1200 includes a number of panes, such as the Query pane 1210, the Best Bet pane 1220, the Search Index Results pane 1230, the Navigation Areas pane 1240, and the Query Matches pane 1250. The visual search editor optionally includes one or more additional panes, such as a Sponsored Results pane, another Featured Results pane, or a set of Specialized Transaction Interface panes.

In an example, there visual search editor provides a Query pane 1210 that displays and supports editing of one or more elements or properties that specify the search, including the query string 1211, the New Query button 1212, the Search Properties link 1213, and the scope 1214 of the search. In certain examples, the contents of various other panes (e.g., Search Index Results pane, Best Bets pane, etc.) relate to the search specified in the Query pane 1210.

In an example, is the visual search editor provides a Featured Results pane 1220 for displaying content that the administrative user determines the sponsoring enterprise would wish end-users to see in response to the particular search query specified in the Query pane (whether that content is returned in the search index results for that query's search, or not).

In an example, the visual search editor provides a Search Index Results pane 1230 for displaying content in the search index that relates to the particular search query specified in the Query pane 1210.

In an example, the visual search editor provides one or more Navigation panes in which one or more navigation aids corresponding to the search query are shown. In another example, there is a Navigation Area pane 1240 with distinct, optionally labeled areas in which Navigation panes such as 1260, 1270 can be organized. In another example, Navigation panes such as 1260, 1270 in which navigation aids such as 1271 are shown may be freely placed in any location in the visual search editor's user interface display. In another example, navigation aids such as 1271 may be freely placed in any location in the visual search editor's user interface display.

In an example, the visual search editor provides a Specialized Transaction Interface pane in which one or more Specialized Transaction Interfaces are shown. In another example, there is a Specialized Transaction Interface Area pane with distinct, optionally labeled areas in which Specialized Transaction Interfaces panes can be organized. In another example, Specialized Transaction Interfaces may be freely placed in any location in the visual search editor's user interface display.

In an example, there is a Query Matches pane in which queries that match the specified search (if any) are shown.

### What-You-See-Is-What-You-Get

One aspect of the visual search editor is that the administrative user's manipulations, to modify the end-user's search experience, are done in a WYSIWYG fashion. This permits the administrative user to edit the search experience in a visual search editor interface that is substantially similar to and strongly representative of the actual search interface seen by the end-user. This advantageously allows the administrative user to concentrate on the desired outcome for the end-user, rather than on the manner of expressing that outcome—the expression is simply to make the search interface display look right for the end-user.

The subject matter of the panes shown in FIG. 12 is illustrative of an example of the structure of the WYSIWIG visual search editor interface. In an example, the visual search editor presents items in a configuration that is highly visually representative of the way such items will be presented to an end-user. For example, the best bet item 1221 is presented in the Best Bet pane, and search index result items 1231, 1232, 1233 in the search index results pane are presented in the order in which they will be presented in an end-user search interface.

Items in the Search Index Results pane 1230 can also be reorganized by the administrative user by dragging and dropping, as can items such as 1271, 1272 in any Navigation Area, as well as Navigation Areas such as 1260, 1270 themselves. In an example, the panes themselves can also be rearranged, e.g., the placement of the Search Index Results pane 1230 and Navigation Area pane 1240 could be swapped. In an example, the panes can be dragged and dropped. A control in the administrative visual search experience editor allows the administrative user to drag and drop the panes in the screen, or to otherwise specify the location of a pane for an end-user (such as via a description of the location; upon submitting the description, the panes are moved to the specified location in the administrative visual search experience editor screen). The location of each pane specified by the administrative user is recorded in the search experience modification record. When the screen is rendered in the end-user interface, the rendering engine consults the search experience modification record and renders the panes in the locations specified by the administrative user.

### Search Experience Editor Controls

The panes typically include various graphical user interface (GUI) or other controls that enable the administrative user of the visual search experience editor to edit the organization of the items in the administrative and end-user interfaces as well as the inclusion or exclusion of items from the administrative or end-user interface. For example, several of the panes include a “remove” control, such as represented by a minus sign in a circle (1224, 1235, 1275), and an “add” control, such as represented by a plus sign in a circle (1222, 1238, 1244, 1266, 1276). The remove control removes the item to which it visually corresponds. The add control allows an administrative user of the search experience editor to specify an item to add. Other graphical or textual icons could be used and associated with the same or similar operations. Other controls are present as well. Each control performs two actions, one on the display of the administrative interface, which is immediately visible to the administrative user, and one on the search experience modification record, which records enough information to reproduce the action in the end-user interface. For example, when an Add control is used to add an item, information about the item, the fact that it has been added, and where it is added in the display are all typically recorded in the search experience modification record. When the query 1211 from the query pane 1210, or a sufficiently similar query, is entered in the end-user interface, such recorded instructions are used to reproduce in the end-user interface the actions specified by the administrative user in the administrative interface, thereby making the end-user display substantially similar to the administrative interface display. The query 1211 from the query pane 1210 can be referred to as the “trigger query”. When a query entered in the end-user interface is recognized as being sufficiently similar to the trigger query, the tailored search is said to be “triggered”—we also say that the tailored search “fires”—which means that the instructions recorded for that search's experience are consulted to modify the end-user interface. For example, when an end-user runs a search that triggers a tailored search, the added items listed in the search experience modification record are added to the end-user's search results.

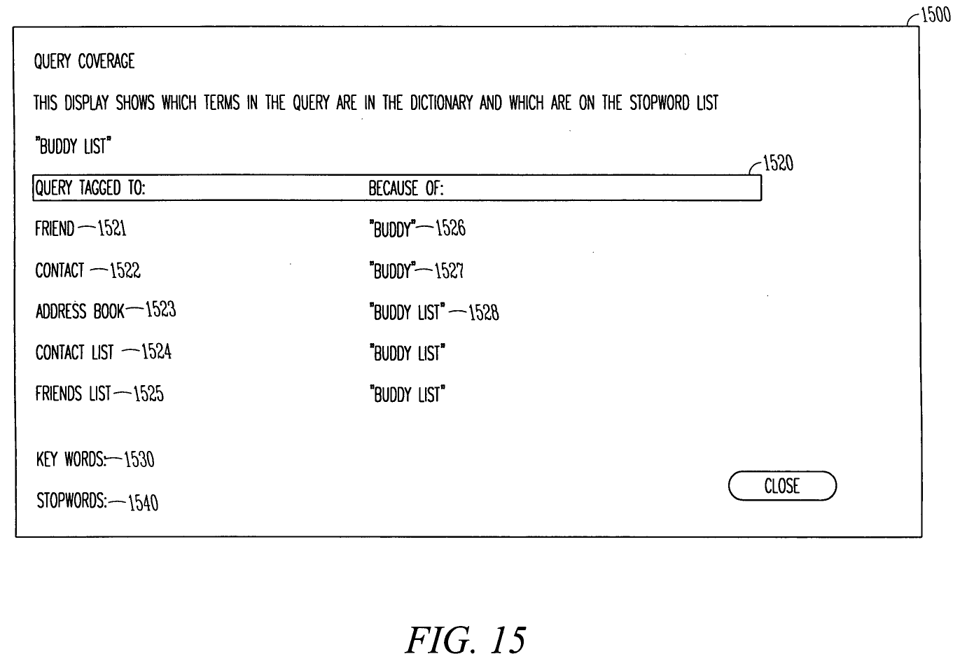

The Query pane 1210 has a Query field 1211 that lists the query for the tailored search, here “Buddy List.” The name of the tailored search can (but need not) be but is not necessarily the same as the query for that search. In an example, the Query pane 1210 has a New Query button 1212; selecting the New Query button 1212 refreshes the contents of the panes using the current search criteria, which may be modified by the search experience editor user. In an example, the Query pane 1210 has a Search Properties link 1213 that takes the user to an interface (exemplified by FIG. 14A) in which the user can set or modify the search properties. In an example, the Query pane 1210 has a Scope display 1214 that tells the user about additional conditions (besides matching the trigger query) for triggering the tailored search. In an example, the Query field 1211 in the query pane 1210 has a control 1216 that causes information about the query to be displayed. Selecting control 1216 brings up an interface such as that shown in FIG. 15. Interface 1500 in FIG. 15 displays the query “buddy list” 1510 about which information is provided. A Dictionary Matches area 1520 shows dictionary entry “Friend” 1521 and shows that it matches “buddy” 1526, dictionary entry “Contact” 1522 matching “buddy” 1527, dictionary entry “Address book” 1523 matching “buddy list” 1528, and so on. A Keywords area 1530 and a Stopwords area 1540 are shown. Stopwords are very general words that are ignored when searching, such as “of” and “and”. There are no stopwords in query 1510. Keywords are query words that neither match any dictionary entries nor are stopwords. There are no keywords in query 1510. In an example, a dictionary of synonyms is maintained and referenced to interpret a query from an end-user. For example, the query “contact list” is equivalent to “buddy list” and “contact list” will trigger the “buddy list” tailored search.

The Best Bet pane, or Featured Results pane, 1220, titled “Best Bets” and may contain zero or more items 1221 that have been determined by a person such as the administrative user to be likely to be responsive to the particular query. In an example, the item 1221 is a search result selected from the search index results pane 1230 by a search experience editor's administrative user and dragged or otherwise promoted into the featured result pane 1220. In another example, the item 1221 is selected by a search engine and optionally automatically populated into the Best Bets pane. The Best Bets pane 1220, for example, includes an add control 1222 that allows the search experience editor's administrative user to select items (e.g., other than items found by the search engine and placed in the search results) and add them to the Best Bets area. In an example, the featured results pane includes an add-existing control 1223 that pops up a list of candidate featured results from which the search experience editor's administrative user can choose, while the add control 1222 pops up a search interface in which the search experience editor user can search for a featured result to add. In an example, the featured results pane 1220 includes a create control that allows the search experience editor's administrative user to create a new item and add it to the Best Bets area. In another example, a single control supports both adding existing items and creating new items.

However an item is selected or created by the administrative user, it is then immediately displayed in as an item (e.g. 1221) in the Best Bets pane 1220. The selected item is added to a list of featured results or best bets in the search experience modification record. When the tailored search is triggered by an end-user's query, the list of featured results in the modification record is examined, and the items found therein are displayed in the Best Bets or like featured results pane in the end-user interface. The featured results seen by the search experience editor's administrative-user (after any manipulation) are the same as the featured results for that search seen by the end-user; this is consistent with the WYSIWYG aspect of the visual search editor.

In an example, the Best Bets or other featured results pane 1220 includes two or more featured results that are presented in a visual configuration that is representative of how such results are presented in an end-user search interface display. Such results are modifiable or movable by a search experience editor's administrative user, for example, by dragging and dropping the items to place them in a desired order. A change to the order of the items in the search experience editor causes a corresponding change to the order of the items in the list of featured results in the search experience modification record. The items are then displayed in the end-user interface in the order specified in the search experience modification record. In this way, the order of the items shown in the search experience editor (after modification by the administrative user) corresponds to the order in which they are shown in an end-user search interface.

The featured results pane 1220 typically includes a delete control 1224 displayed next to each item 1221. If the delete control 1224 is selected by the administrative user, the corresponding item is removed from the particular Best Bets or other featured results pane 1220 and is also removed or otherwise suppressed from the search experience modification record's list of featured results to be displayed. Not being in the list, the item will not be displayed in the Best Bets or other featured results pane in the end-user interface when the tailored search is triggered.

The featured results pane 1220 alternatively includes featured results other than best bets, such as sponsored results (e.g., advertisements), for example. In an example, a visual search experience editor includes two or more featured results panes, which are displayed in an arrangement that is representative of how the results are displayed in an end-user interface, and which are capable of being arranged by a search experience editor's administrative user, such as through drag-and-drop or other techniques. In this example, each featured results pane has a corresponding featured results list, or similar tracking information, in the search experience modification record.

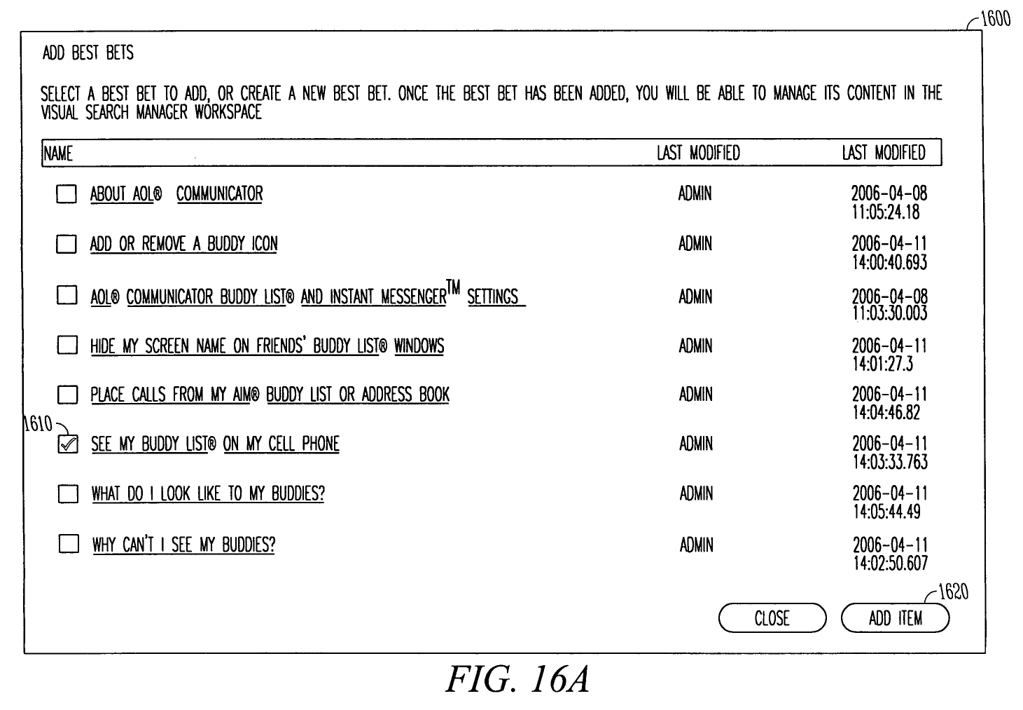

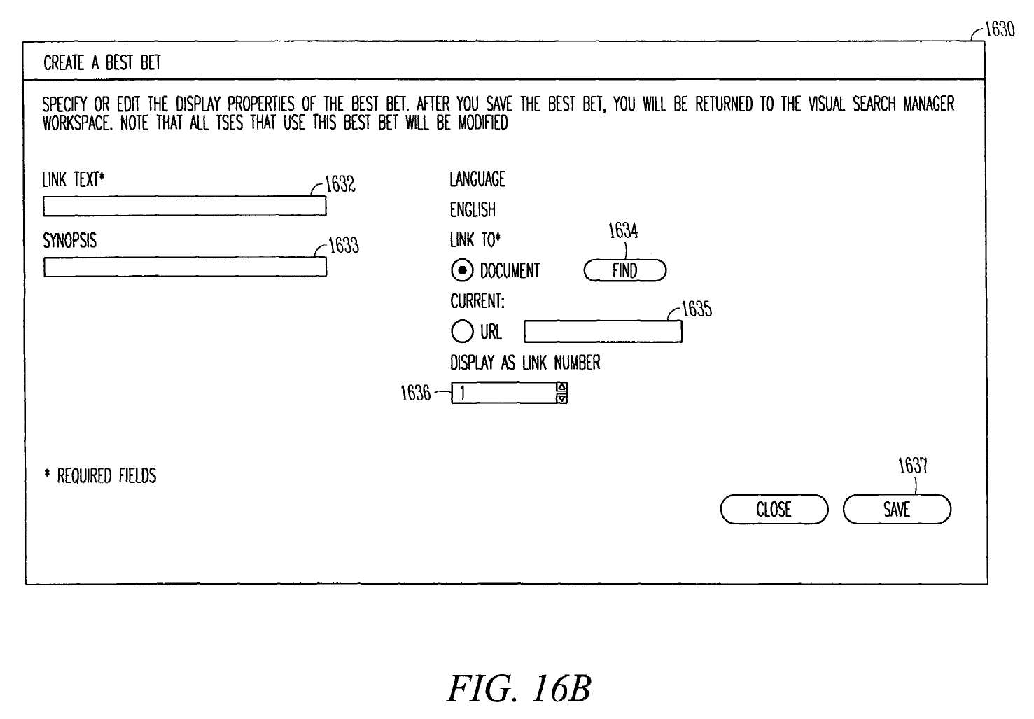

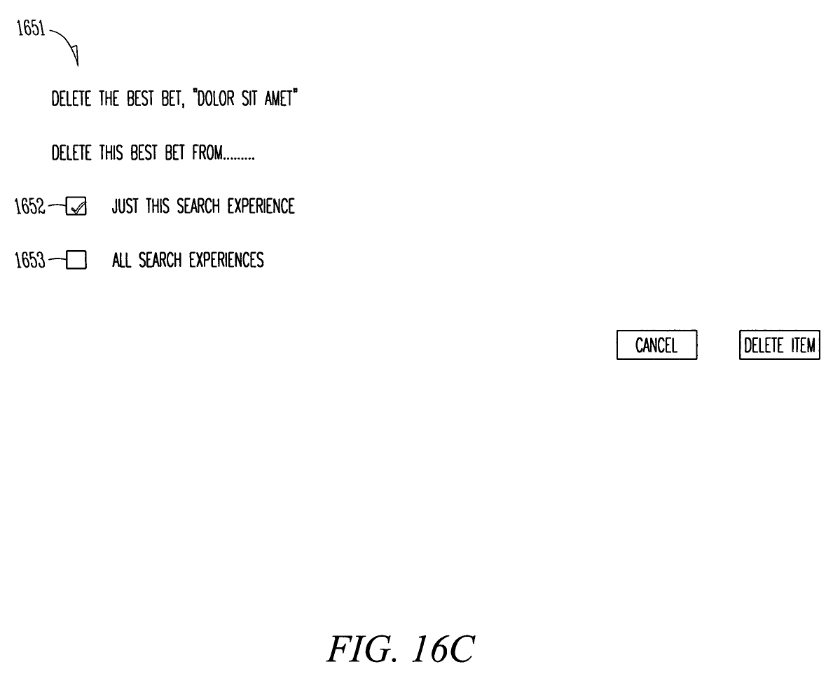

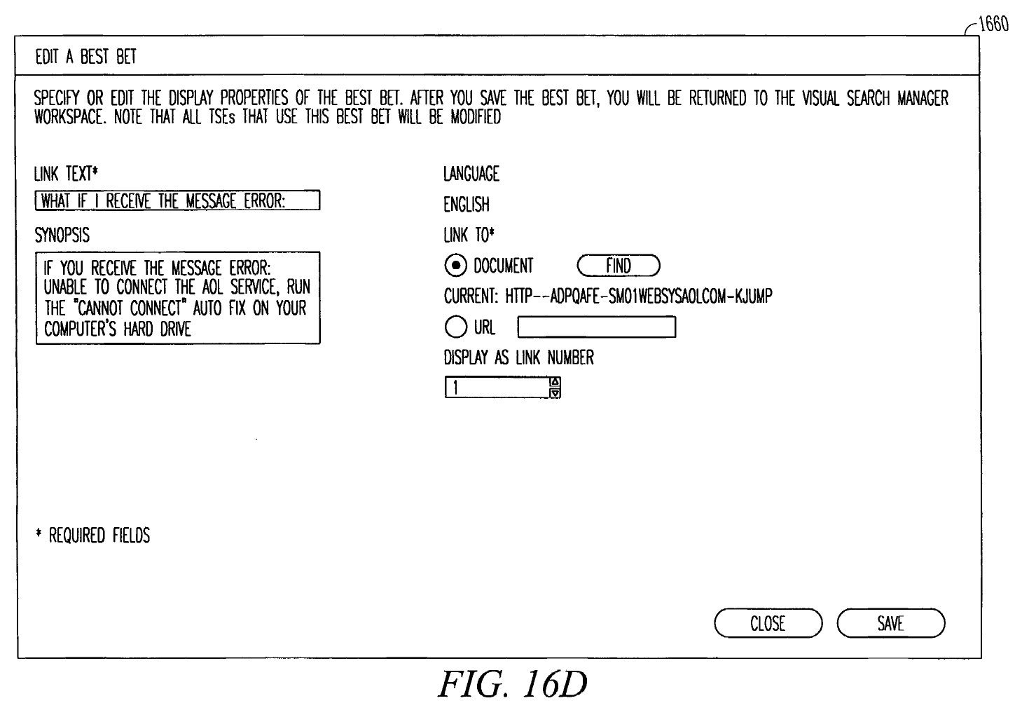

In an example, selecting the add-existing item control 1223 initiates an add item interface such as the add item interface 1600 shown in FIG. 16A. In this example, the add item interface 1600 presents candidate items that can be selectively added by the administrative user to the featured results pane 1220. In an example, the candidate items shown in the add item interface are previously-selected best bets, which are optionally filtered for context. In this example, a global best bets list is used. Every best bet selected for any tailored search is added to this global best bets list, which is then used to populate the candidate items in the add item interface. In another example, the candidate items shown in the add item interface are search results for an administrative user's query that was specified in the add item interface. In an example, particular candidate items can be selected for addition to the featured results pane 1220 using a control such as a GUI check box. For example, the check box for the candidate item 1610 has been selected as indicated by the check in the box next to the item. In an example, a preview or excerpt of the candidate item's resource is provided to the administrative user, such as to help inform the decision of whether to include a particular candidate item in the featured results pane 1610. Selecting the add items button 1623 adds the checked candidate items to the features results pane.

In FIG. 12, if the create new featured item control 1222 is selected by the administrative user, then a create new item interface is presented to the administrative user. FIG. 16B shows an example of a create new item interface 1630. Link text that is typically shown in the end-user search interface is specifiable by the administrative user in field 1632. A synopsis of the resource linked is specifiable by the administrative user in field 1633. A path to the link is specifiable by the administrative user in field 1635 or using a find tool accessible to the administrative user through find button 1634. A link number is specifiable by the administrative user using pull-down menu 1636. The new item is added to the add item interface shown in FIG. 16A when the SAVE button 1637 in the create new item interface is selected.

In FIG. 12, selection of a delete control 1224 initiates a delete interface such as the interface 1651 shown in FIG. 16C. A search experience editor's administrative user can select whether the selected featured result is deleted entirely from the underlying knowledge representation (and from the global best bets list) or just from this particular tailored search experience, such as by using GUI controls 1652, 1653. In an example, if an item 1221 in the featured results pane 1220 is selected by an administrative user, an edit item interface such as the interface 1660 shown in FIG. 16D is initiated. In an example, some or all of the data specified during creation of the item is subsequently editable by the same or other administrative users using the edit item interface 1660. In one example, these edits affect only a particular tailored search experience. In another example these edits affect the underlying knowledge representation. In a third example the edit interface offers a choice (e.g., similar to that offered by GUI controls 1652 and 1653 from FIG. 16C) allowing the search experience editor's administrative user to choose whether the edits affect only the particular tailored search experience or the underlying knowledge representation.

FIG. 12 illustrates a Search Index Results pane 1230. An item 1231 is removable from the search index results pane 1230, such as by using a delete control 1235 which is typically displayed next to each item. In an example, when such a delete control is selected, the associated search index result item is removed (or hidden) from the search index results pane in the search experience editor. In another example, when such a delete control is selected, the associated search index result is grayed out (as in FIG. 12 item 1234) or crossed out or otherwise graphically shown as removed from the search index results pane—while still being visible in the search experience editor. In either of these examples, this result is put on a list of deleted search index results in the search experience modification record. When the tailored search is triggered, the list of deleted search index results in the modification record is compared to the search index results returned by the search engine, and any matching items are removed from the search index results pane in the end-user interface.

In another example, when such a delete control 1235 is selected, the search experience editor's administrative user is asked whether the associated search result is to be removed from the particular tailored search experience only (in which case the scenario described above holds) or is to be removed entirely from the system, in which case the search experience modification record is not changed, but the knowledge representation underlying the system—in this case, the collection of content over which the search engine searches—is modified by removing that item from the collection. If removed entirely, the removed item will not appear in the search index results pane in the end-user interface when the tailored search is triggered; neither will it appear for any search that does not trigger the particular tailored search experience.

In an example, the search experience editor's administrative user can limit the number of search results or search index results shown for a particular search. In an example, the number of items to be shown is specified in a text entry box in the search experience editor. In another example, a cut-off point is defined in the results list, such as by using a GUI control (e.g., a scissors icon that is placed between items in the results pane in the search experience editor), and the number of items to be shown is determined automatically by the counting the items above the cut-off point. In another example, a slider 1236 displays and controls the number of items to be shown; for example, initially the slider 1236 is positioned at the number of items in the search index result set, and it can be placed at any position between 1 and that number. This functionality can be provided using any other appropriate interface mechanism. In any of these examples, the search index results pane in the visual search experience editor is updated to represent the limited number of items, such as by displaying the number or by removing or hiding the unshown items from the interface, or graying or crossing them out, and the corresponding number of items to be shown is written to the search experience modification record. This number is then consulted when the tailored search is triggered, so that no more than that number of items is shown in the end-user search interface during display of the search index results from the tailored search.

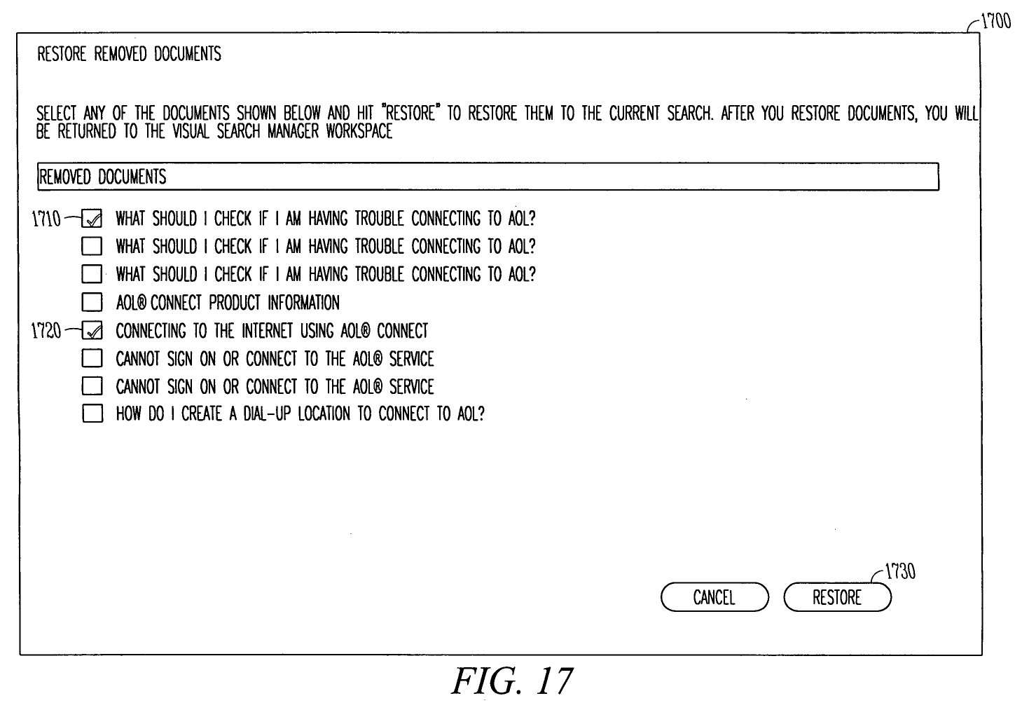

Selection of a View Deleted Items control 1237 initiates a view deleted items interface such as the interface 1700 shown in FIG. 17. The view deleted items interface 1700 displays for an administrative user items that have been removed from the search index results pane 1230 using the delete control 1235. In an example, this interface includes items removed by the number-of-items limit (e.g., 1236). A removed item, such as item 1710 and 1720, can be restored in the search index results pane, such as by an administrative user using a restore control 1730; this adds the selected items back into the search index results and removes them from the list of deleted search results in the search experience modification record.

A search index results pane 1230, may also include an add control 1238. When the add control 1238 is selected by the administrative user, a pop-up appears that allows the administrative user to perform an independent search to find an item to be added, or to specify the location of a known item to be added. An item thus identified by the administrative user can then be added to the search index results pane, such as by the administrative user dragging it into the desired pane or by selecting an “Add” control associated with the identified item. The item is put on a list of added search index results in the search experience modification record. When the tailored search is triggered, the list of added search index results in the modification record is examined, and the items tracked therein are displayed along with the search index results in the search index results pane in the end-user interface. In an example, if the identified item is not in the search index, in this addition process the administrative user may specify that the item should appear in search index results for other searches, in which case it is added to the search index (another instance of using the search experience editor to modify the underlying knowledge representation), or the user may specify that the item is to be shown for this tailored search only (in which case the item is not added to the search index). In an example, in this addition process the item may optionally be edited, or its title or content or appearance may optionally be changed.

In another example, when the add control 1238 is selected by the administrative user, an authoring system is launched. The search experience editor's administrative user is able to create a new search index result, which is put on the list of added search index results in the search experience modification record. In yet another example, when the add control 1238 is selected, the search experience editor's administrative user is able to record or communicate a recommendation that an appropriate piece of content be authored; in this case no change is made to the search experience modification record.

Note that adding and removing items can be done using any suitable technique. For example, removing an item could be done by dragging it to a trash-can icon, or to the Deleted Items link 1237 in the header of the search index results pane 1230.

The search experience editor may be used by call center agents rather than by an administrator. These agents may not have permission to add items to the system. In this case (see, e.g., FIG. 17A) a recommend-item-to-add control may replace add control 1238. The recommend-item-to-add control is selectable by an agent and initiates an interface through which the agent can recommend an item to be created by a content author and added to the universe of search results. For example, if a particular topic is unrepresented or underrepresented, a recommendation could be submitted to add one or more resources relating to the topic. Such a recommendation would not affect the end-user interface immediately. The recommendation would be sent to the authoring workflow. An identifier for the tailored search may accompany the recommendation so that when the recommended item is written and published, it may automatically be added to the tailored search's search experience modification record's list of added search index results.

The items in the search index results pane 1230 can also be reordered, such as by the administrative user dragging and dropping items or any other suitable mechanism. For example, the first item 1231 in the search index results pane 1230 can be dragged below the second item 1232 in the pane. In this case, items 1231 and 1232 are placed in an order-of-search-results list in the search experience modification record, 1232 being placed before 1231 in the list. When the tailored search is triggered, the order of the results is changed for being displayed in the order given in the order-of-search-results list.

In another example, items in the search index results pane 1230 can also be moved elsewhere, such as into the featured results pane 1220. An item such as 1233 in the search index results pane 1230 can be dragged by the administrative user into the Best Bets pane 1220, for example. In this case, that item is added to the list of best bets and to the list of removed search results in the search experience modification record. When the tailored search is triggered in the end-user interface, item 1233 will be shown in the best bet pane and will not be shown in the search index results pane, by its being on these search experience modification record lists.

In yet another example, an item such as 1231 or 1232 in the search index results pane 1230 can be moved into a navigation aid such as 1271. The search experience editor's administrative user can drag the desired item 1231 onto the navigation aid 1271; the item is removed from the search index results pane and is displayed in the results set that is shown when the navigation item is selected. To accomplish this, the item 1231 is added to the list of deleted search results in the search experience modification record for the tailored search. Navigation aid 1271 has its own search experience modification record, and item 1231 is added to the list of added search results for that search experience modification record. When the original tailored search experience is triggered in the end-user interface, item 1231 will not be shown in the end-user search interface search index results pane because it is on the list of deleted search results in the original tailored search's search experience modification record. When the navigation aid 1271 is shown in the end-user interface and is selected by the end-user, item 1231 will then be shown in the end-user search interface search index results pane by virtue of being on the navigation aid's search experience modification record's list of added search results.

### Navigation Areas

In an example, one or more navigation aids are provided for selected topics such as topics known to be problematic or of interest to users, or topics being promoted by the enterprise that is providing the search facility. For example, FIG. 12 shows navigation aids 1261, 1262, 1263, 1271, 1272, and 1273 for particular activities or symptoms, such as sending instant messages, managing buddy lists, or slow connections.

Navigation aids may be categorized, such as by grouping like items together under a header, which may display the category name. Such a grouping is sometimes referred to as a navigation area. Navigation areas may themselves be grouped together, such as into a Navigation Area pane.

The search experience editor's user controls which navigation areas appear for an end-user during a tailored search. The search experience modification record for the tailored search contains a list of navigation areas to be displayed for that search. When the tailored search is triggered in the end-user search interface, this list is consulted to determine which navigation areas will be presented to the end-user.

FIG. 12 shows an example of a navigation area pane 1240 containing navigation area items such as 1260 and 1270, each of which is optionally a pane or subpane. In another example, navigation area items such as 1260 and 1270 are not grouped together but may appear anywhere in the interface.

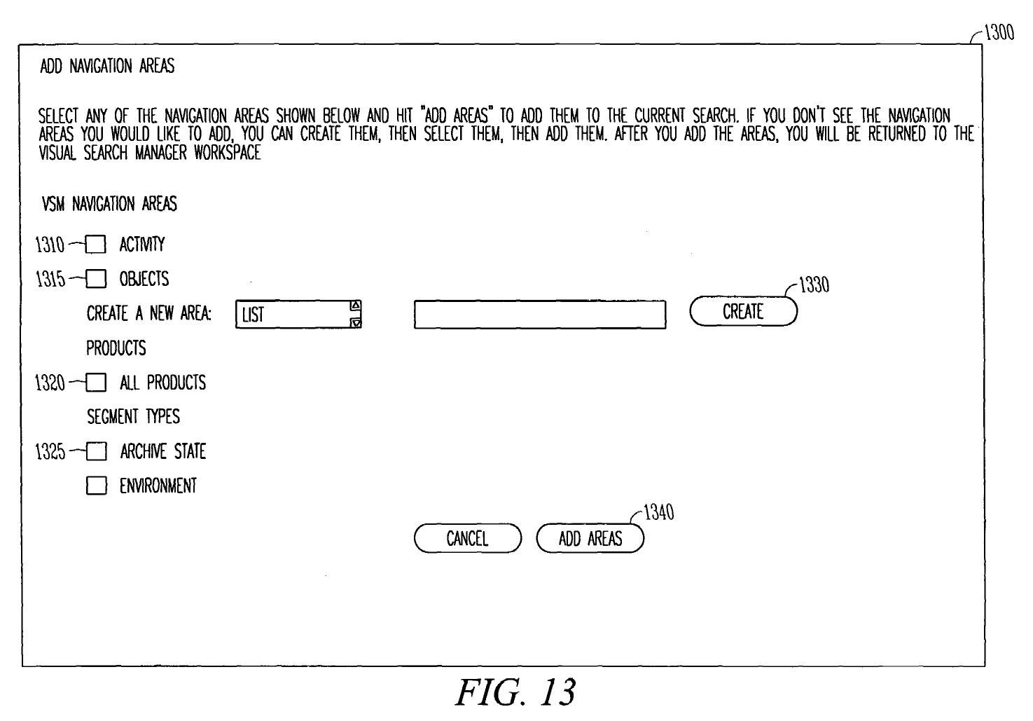

There is a control 1244 for adding a navigation area to the navigation area pane 1240. An interface like that exemplified by is used for this purpose. This interface 1300 of FIG. 13 supports adding navigation areas to the current tailored search, such as via one or more check boxes 1310, 1315, 1320, 1325. Selected navigation areas may be written to the list of navigation areas in the search experience modification record when the Add Areas button 1340 is selected. The search experience editor interface also supports creating one or more new navigation areas, such as via the Add New Navigation Area button (or link) 1330. In an example, a navigation area that is added via the search experience editor interface can be displayed in the end-user search interface only for that particular tailored search; it is written to the particular tailored search's search experience modification record, and not elsewhere. In another example, a navigation area that is added via the search experience editor interface becomes available for use in any tailored search; it is written to the underlying knowledge representation. In yet another example, the search experience editor's user is given the choice whether the new navigation area interface can be displayed only in the particular tailored search or becomes available for use in any tailored search.

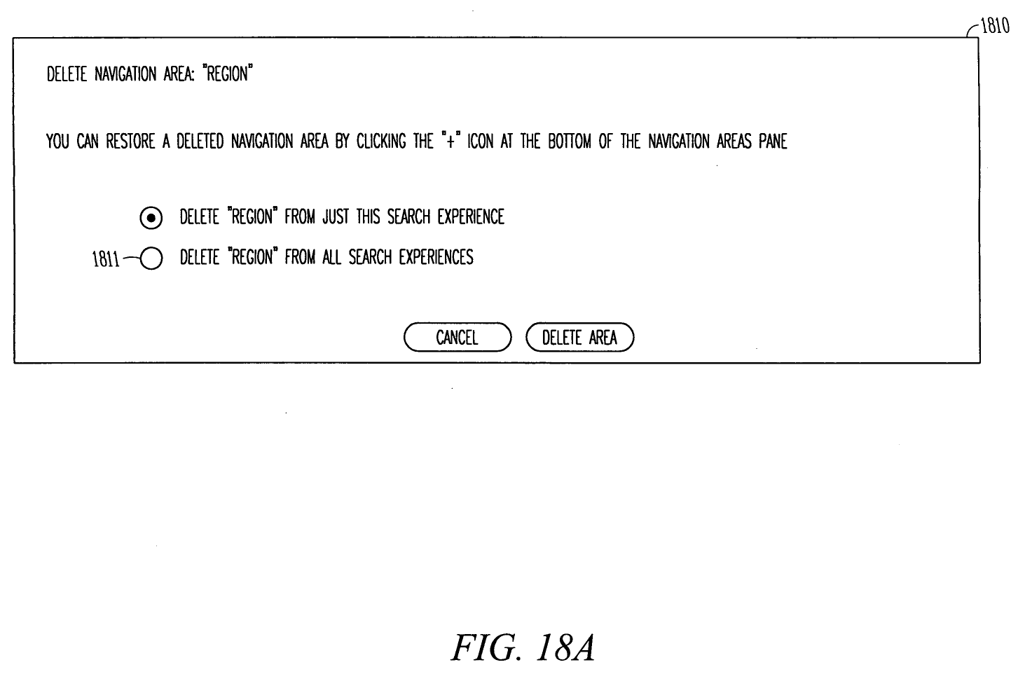

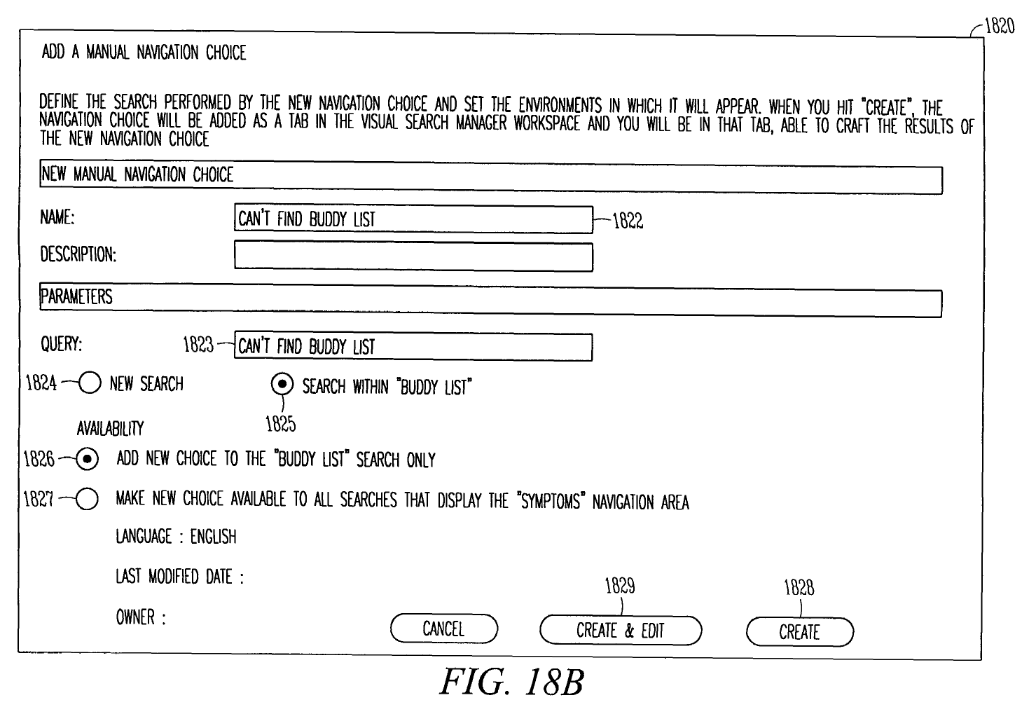

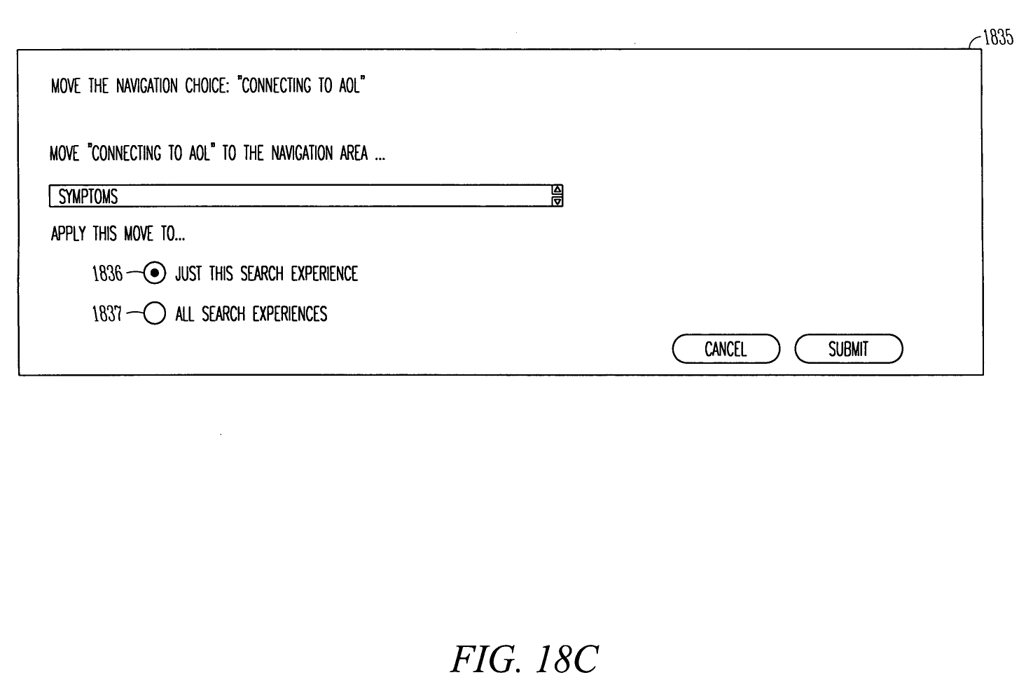

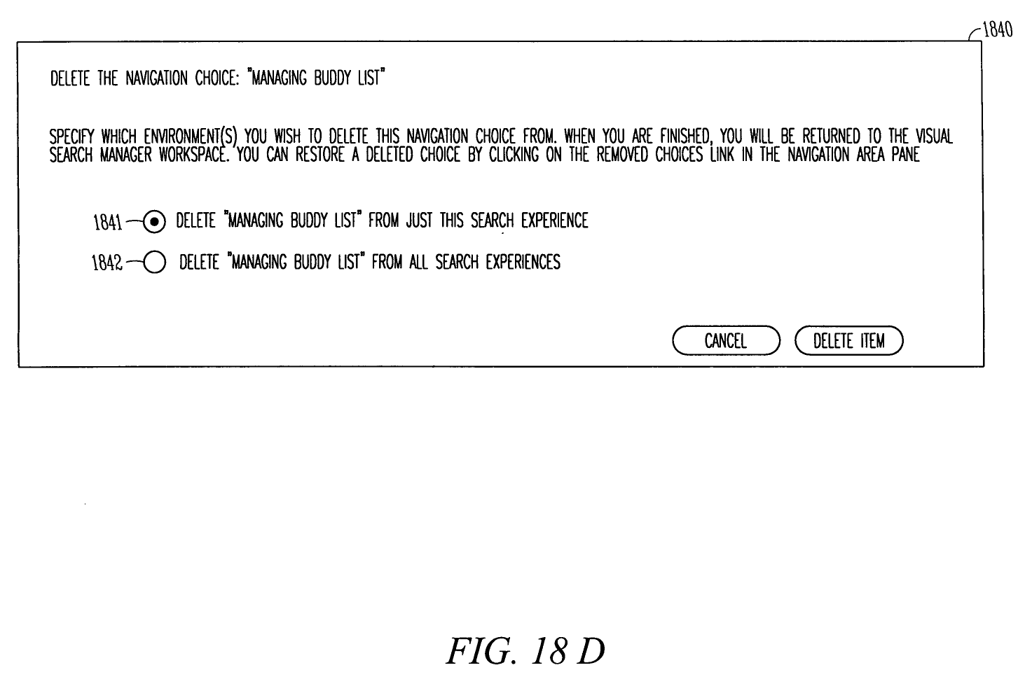

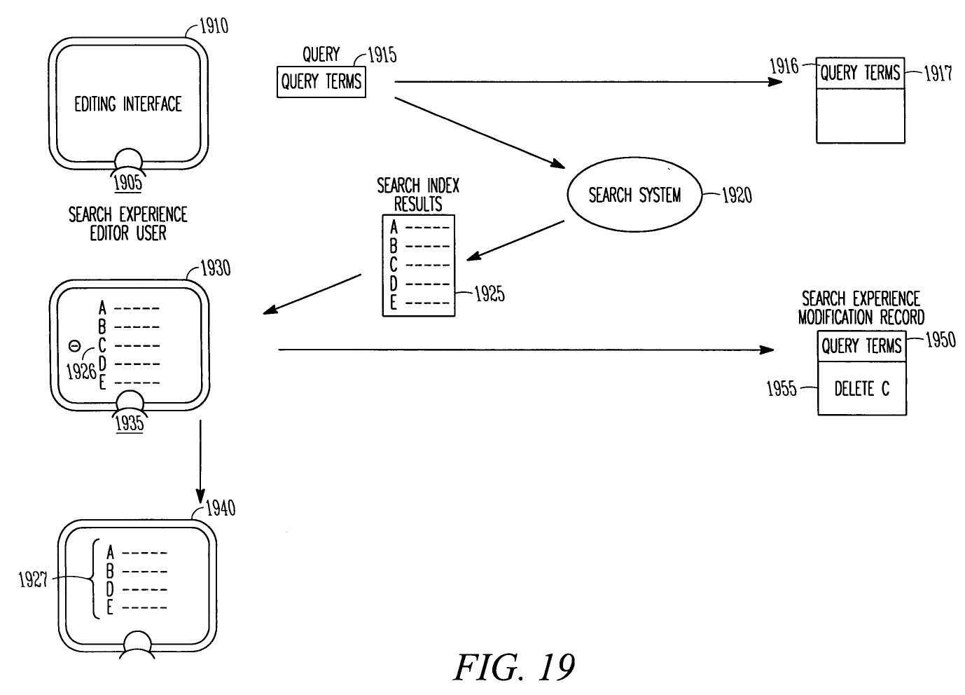

In navigation area pane 1240 in FIG. 12, selecting a delete control 1267 initiates a delete navigation area interface, such as the interface 1810 shown in FIG. 18A. A navigation area that is deleted via this interface is removed from the particular tailored search's search experience modification record and hence is no longer displayed in the particular tailored search (neither in the end-user interface, nor in the search experience editor interface). In an example, when a navigation area that is available for use in any tailored search is deleted via this interface, it may, at the discretion of the administrative user, be made unavailable to any search; control 1811 may be used for this purpose. In this case the navigation area is removed from the underlying knowledge representation, and thus will not appear with a checkbox in the Add Navigation Area interface, and it is removed from the search experience modification record of every tailored search that referenced it.

In an example, the order of navigation area items 1260 and 1270 in the Navigation Areas pane 1240 can be changed, such as by using a drag-and-drop technique. For example, item 1260 can be dragged below item 1270 in the pane. In this case, items 1260 and 1270 are noted in an order-of-navigation-areas list in the search experience modification record, 1270 being placed before 1260 in the list. When the tailored search is triggered, the order of the navigation areas displayed in the end-user interface is changed to conform to the order given in the order-of-navigation-areas list.

The contents of the Navigation Areas (e.g. Activities, Features and Functions, Installation) may be displayed as pull-down menus or lists of navigation aids. A control 1243 in the search experience editor allows the user to set the display to “pull-down” or “list.” When the administrative user sets a value for the display type in the search experience editor, this value is recorded as an attribute of the Navigation Area. In the end-user interface, this attribute is consulted and its value controls the display type of the Navigation Area. In one example, the attribute is associated with the Navigation Area in the underlying knowledge representation and not with the particular tailored search experience modification record. In another example, the attribute is associated with the Navigation Area in the search experience modification record for the particular tailored search experience; when the tailored search is triggered, this attribute in the search experience modification record is used to control the display type of the Navigation Area. In another example, the search experience editor user interface provides the user with a choice of whether to set the attribute in the underlying knowledge representation (in which case it applies to all searches that display the particular Navigation Area) or in the search experience modification record (in which case it applies only to searches that trigger the tailored search). A similar mechanism can be used to give the search experience editor's user control over any aspect of the presentation of a navigation area and the navigation aids therein.

### Navigation Aids

Example navigation aids (e.g., 1261, 1262, 1263, 1271, 1272, 1273) are shown in FIG. 12, in respective navigation areas 1260 and 1270.

Selecting an add item control 1265 initiates an Add Navigation Aid interface such as the interface 1820 shown in FIG. 18B. In contrast to the Add Navigation Area control 1244, which is located in the frame of the Navigation Area pane 1240, the Add Navigation Aid control 1244 is located in the frame of a particular navigation area; it is to that particular navigation area that a new navigation aid will be added.

When a navigation aid is added, a search experience modification record is created for the new navigation aid, typically separate from the search experience modification record for the particular tailored search. Each search experience modification record typically has a unique identifier, and the identifier of the navigation aid's search experience modification record is recorded in the search experience modification record for the particular tailored search. When the particular tailored search fires in the end-user interface, this identifier can be used to fetch the search experience modification record for the navigation aid, thus the information recorded therein is available when the results for the tailored search are rendered for the end-user.

A name for the navigation aid is typically specifiable, such as by using field 1822 and is written to the navigation aid's search experience modification record; this is the display name that appears as a link on the screen when the tailored search has been triggered and the navigation aid is displayed. (Note that a particular navigation aid associated with a tailored search may or may not be displayed for a particular user query that triggers the search. The system may limit the number of navigation aids that are displayed, and it may use various criteria to determine which navigation aids will be most useful to the end-user.)

A query is typically specifiable, such as by using field 1823. The query is recorded in the navigation aid's search experience modification record. When the navigation aid is shown in the end-user interface and a user selects it, this query is read from the search experience modification record and is run; the results are shown in the end-user interface Thus, this query defines the search that is performed when the user selects the navigation aid. In an example, a navigation aid has multiple queries, which are run as a disjunction. In an example, interface 18B has an Add query control that allows the search experience editor user to add additional queries to the navigation aid, all of which are recorded in the navigation aid's search experience modification record.

In an example, the query (or set of queries) is run on its own, without regard to the previous search (which was responsible for the navigation aid appearing on the screen). In another example, the query (or disjoined set of queries) is appended to or otherwise combined with the previous search, constructing a specialization of that search, in order to take into account the context in which the user selected the navigation aid.

In another example, the decision as to whether the navigation aid query is run on its own or is used to specialize the previous search is made by the search experience editor user for each added navigation aid. If the radio button 1824 labeled “New Search” is selected, an attribute in the navigation aid's search experience modification record is given the value “new search”, while if the radio button 1825 labeled “Search Within” is selected, the attribute is given the value “search within”. When the navigation aid is selected by an end-user in the end-user interface, the attribute in its search experience modification record is consulted and used to control which kind of search is performed.

In an example, an added navigation aid is available only in the search experience to which it has been added. In another example, an added navigation aid is available in every search experience; it is added to the underlying knowledge representation. In an example, added navigation aids are added to the underlying knowledge representation and are available in any search experience that displays the navigation area to which the navigation aid was added. In an example, the search experience editor user chooses whether the navigation aid is added to the current search experience or to the underlying knowledge representation. Radio buttons 1826 and 1827 can be used for that purpose.

In an example, the “Create” button 1828 saves the navigation aid and returns the search experience editor user to the search experience to which the navigation aid was added, while the “Create & Edit” button 1829 saves the navigation aid and creates a new tab in the search experience editor in which the navigation aid's results can be tailored, taking the search experience editor user to the new tab.

Optionally a parenthetical number is shown in correspondence with the navigation aid 1271, displaying the number of resources associated with the particular navigation aid.

In these examples, the navigation aid's display name will typically be shown in the end-user interface when this search experience is triggered. In that circumstance, the navigation aid's search query is run when the choice is selected by an end-user in the end-user interface. The items returned by the navigation aid's search will typically be modified, such as according to the navigation aid's search experience modification record.

In an example, additional interfaces are accessible when a search experience editor's user selects a navigation aid (e.g., hovers a pointer over a navigation aid or right clicks on a navigation aid). In an example, hovering or right-clicking causes a menu to appear, which may contain rename, merge, move, delete, preview, edit properties, and edit search operations. FIG. 18C shows an example interface 1835 through which a navigation aid can be moved, such as from one navigation area to another. Controls 1836 or 1837 can be used to specify whether the move applies for only for the present tailored search or for all instances of the navigation area. FIG. 18D shows an example interface 1840 through with a navigation aid can be deleted. Controls 1841 and 1842 can be used to specify whether the navigation aid is deleted from this search experience (tailored search), or all search experiences, that is, from the underlying knowledge representation.

Recall that what the search experience editor displays when it shows a tailored search are the search results for that search, including any tailoring of those results that has previously been done in the editor. In an example, multiple tailored searches are displayed, such as with each in its own tab in the search experience editor administrative interface. The search results for any of these may include navigation aids. In an example, when the administrative user selects a navigation aid in the administrative search experience editor interface, the search results for the navigation aid—the same results that the end-user would see if the end-user selected the navigation aid—are shown in the administrative search experience editor interface. In an example, these search results replace the results of the previous search in the administrative search experience editor interface, as described in step 160 of FIG. 1. In another example, the act of selecting a navigation aid in the administrative search experience editor interface of this search are displayed in a new instance of the administrative search experience editor interface. In another example, the results of each search are displayed in a separate tab in the administrative search experience editor interface; this search results in the appearance of a new tab. (Examples of multiple tabs 1201, 1202, 1203, 1204 can be seen in FIG. 12.) The items in the results of this search can be modified in the administrative search experience editor interface, and these modifications are recorded in the navigation aid's search experience modification record. In this manner, the search experience that end-users get when they select navigation aids can be tailored.

In another example, a navigation aid display name may be constructed without associating a search query with the navigation aid, but instead by directly associating a set of one or more result items with the navigation aid. These result items are recorded in the navigation aid's search experience modification record when they are associated with the navigation aid, and are looked up and rendered on the screen when the navigation aid is selected by an end-user in the end-user interface. In an example, the items are associated with the navigation aid using the search experience editor controls.

In an example, a search experience may also (or instead) be used as a navigation aid. Referring now to FIG. 14A, radio buttons 1440 and 1445 can be used to specify whether or not the search experience will, in addition to its other uses, also appear in a navigation area as a navigation aid. If button 1445 is selected, the navigation area in which it is to be displayed is specified, for example via pulldown 1446, and these attributes are recorded in its search experience modification record. The search experience's trigger query is used as the navigation aid's query. When the search experience appears in the end-user interface, as a navigation aid in a navigation area, and the end-user selects it, the search experience is run, that is, a search is performed on its trigger query and the modifications recorded in its search experience modification record are performed on the results, which are then displayed in the end-user interface.

In an example, a navigation aid constructed in the administrative interface may be displayed outside of the search experience in which it was created. In an example, the navigation aid may be associated with each search result that would be displayed when the navigation aid is selected in such a way that by inspecting the search result, the navigation aid may be identified. When some (arbitrary) search in the end-user interface returns one or more of these search results, the navigation aid is identified and may be displayed in the end-user interface. When the user selects the navigation aid, its results are first modified by its search experience modification record, if it has one, and then are displayed in the end-user interface.

The value of this capability is that many searches may be improved as a by-product of explicitly constructing a single search experience (to improve a single search). The navigation aid helps to direct the end-user to a coherent subset of the results. This navigation aid is constructed in the process of improving some search. But other searches that return some of the same resources will display this navigation aid (in accordance with the example), and so the users that entered any of those searches may be directed to this subset of the results. When many such navigation aids have been constructed, a search may cause a number of navigation aids to be displayed (those that are associated with results in the current result set), and these navigation aids act as a kind of index to the results of the original search (which may have a great many results, typically too many to review them all). It may be useful to limit the number of navigation aids that are displayed, in which case it is sometimes worthwhile to rank them and display the best ones.

We have seen that navigation aids may be much like tailored searches, in that their results may be tailored. Like tailored searches, they can have names and search queries. They typically do not have trigger queries, because they appear as navigation links on the screen and are triggered when the end-user clicks on them. By contrast, a tailored search is typically triggered by matching a user query or accompanying session context. But, in an example, a navigation aid may be converted into a tailored search by giving it a trigger query. In an example, when a navigation aid is converted into a tailored search, the search query is used as the trigger query. In another example, when a navigation aid is converted into a tailored search, a distinct trigger query is specified. Likewise, a tailored search may be used as a navigation choice (in addition to being triggered by user queries). Returning to FIG. 14A, drop-down menu 1446 is supplied for selecting a navigation area for the tailored search. If no navigation area is selected, the tailored search never appears as a navigation choice. If a navigation area is selected, the tailored search is treated as a navigation aid that has been added to that navigation area; its name appears as a link in the navigation area, and when it is selected, the tailored search is run and the results are displayed to the user.

### Specialized Transaction Interfaces

A specialized transaction interface is typically realized as a widget or pagelet—a unit that occupies a portion of the screen and provides a particular behavior, designed to be a part of a different interface and designed to communicate with that interface; to take inputs from the interface it is within, and to render its contents in that interface. Such a widget or pagelet could provide a specialized transaction to the interface user, such as a stock quote or the ability to purchase tickets for sporting events. It is called a specialized transaction interface because it typically runs some process outside of the system, performing some interaction with one or more external systems (such an interaction can be referred to as the transaction), and it is designed to perform a particular transaction—it is specialized.

In an example, a search experience editor provides the capability to add a specialized transaction interface to the end-user interface for a tailored search, such as by adding the specialized transaction interface to the administrative search experience editor interface for that tailored search (thus providing a WYSIWYG interface for this aspect of the search results). In this process, the search experience editor user may specify a set of one or more parameters for the specialized transaction interface. In an example, one or more values (such as the query string) are automatically provided as one or more parameters to the specialized transaction interface.

When a specialized transaction interface is added to the set of items in the administrative interface for a particular search experience, an identifier for the specialized transaction interface, along with any parameters specified for it and optionally its location in the interface, are typically recorded in the search experience modification record. When the tailored search is triggered, the specialized transaction interface is rendered in the end-user interface. In an example, the specified one or more parameters are passed to the specialized transaction interface, the transaction is run, and the results of the transaction are rendered (e.g., by the specialized transaction interface) in the end-user interface, automatically as part of the search results for the tailored search.

With this mechanism one could provide, for example, a photo gallery as part of the search results. The specialized transaction interface would be a widget that takes a query, does a search for images on the internet (e.g., by calling Google's image search on that query), and returns a set of thumbnails of those images. The search experience editor user could add this widget to the administrative interface and specify that it be given the end-user's query string as a parameter. When the tailored search is triggered, the end-user query would be passed to the widget, which would run the search, and find the thumbnails; the widget would be displayed in the end-user interface, and it would render the thumbnails in the portion of the screen reserved to it. In a similar example, rather than the end-user query being passed to the widget, any selected products could be passed to the widget, and images of the products would be displayed in the end-user interface. Optionally, rather than searching the internet for the product images, a local product image database could be searched, allowing the enterprise great control over the images that are displayed.

In another example, the transaction provided by the specialized transaction interface is not run when the specialized transaction interface is rendered in the end-user interface. Rather, the specialized transaction interface is triggered by an action from the user to run the transaction and show its results. To use the same illustrative example, the photo gallery widget, rather than displaying thumbnails, might display a button labeled “Photo Search”. When the user selects the button, the specialized transaction interface runs the transaction to search for and display the photos. In an example, the user can provide one or more further parameters to a specialized transaction interface. An illustrative example of this is if the specialized transaction interface is a stock quote lookup widget, in which case the user may enter a stock symbol, or if the specialized transaction interface is a mortgage rate calculator, in which case the user may enter the size of the loan.

In an example, the search experience editor user can specify whether the specialized transaction interface automatically runs the transaction or waits for end-user input to run it.

In an example, in the administrative search experience editor interface the parameters are passed to the specialized transaction interface, the transaction is run, and the results of the transaction are displayed in the administrative search experience editor interface where they can be modified, and the modifications are recorded in the search experience modification record. In another example, the specialized transaction interface has its own search experience modification record, and such modifications are recorded in the specialized transaction interface's search experience modification record. In an example, the modifications apply to any search to which the specialized transaction interface has been added; those modifications become part of the underlying knowledge representation.

When the tailored search is triggered in the end-user interface, the specialized transaction interface identifiers that are recorded in the tailored search's search experience modification record are looked up, and each identified specialized transaction interface is displayed in the end-user interface. The specified parameters for each specialized transaction interface are likewise looked up, and passed to the appropriate specialized transaction interface to be used when it runs its transaction (whether automatically or upon user input).

Specialized transaction interfaces can be built for nearly any kind of transaction. The present systems and methods can use any specialized transaction interfaces to which it can provide appropriate inputs and display the outputs.

In an example, the display or use of a specialized transaction interface is conditioned on recognizing that the search context provides appropriate input for the specialized transaction interface. As an illustrative example, if a query contains a stock symbol, the stock symbol can be passed from the query to a stock quote widget, the transaction can be automatically run, and the stock price can be displayed in the end-user interface. An example of the steps typically involved are as follows

In the search experience editor
The search experience editor user adds the specialized transaction interface (the stock quote widget) to the administrative search experience editor interface. An identifier of the specialized transaction interface is recorded in the search experience modification record.
The search experience editor user defines a mechanism used to recognize proper input for the specialized transaction interface in the search query (for example, a program that looks up a list of stock symbols in a string is provided and outputs any stock symbol found, and it is specified that the user's query is to be provided as input to this program). This mechanism is recorded in the search experience modification record.
The search experience editor user specifies the condition under which the specialized transaction interface is to be used (that the above-described mechanism finds a stock symbol in the user query and returns it). The condition is recorded in the search experience modification record.
The search experience editor user specifies the parameters to the specialized transaction interface (the return value from the above-described mechanism). The parameters are recorded in the search experience modification record.

In the end-user interface
When a user enters a query, the tailored search that applies is identified, such as by using the trigger matcher. Assume for the purposes of the example that the tailored search in question is the one that applies.
The search experience modification record for the tailored search is identified.
Any condition under which some specialized transaction is to be used is recovered from the search experience modification record (in this case, that the above-described mechanism returns a stock symbol).
The mechanism to determine whether the condition is satisfied (the program to look up stock symbols) is recovered from the search experience modification record.
The mechanism is run and the condition is evaluated.
   If the condition is false, the specialized transaction interface is ignored (no stock quote lookup is done, and the stock quote widget is not shown in the end-user interface).
   If the condition is true, the parameters (in this case, the stock symbol returned by the stock symbol lookup program) are passed to the specialized transaction interface, the transaction is run, and the specialized transaction interface is displayed (the stock price is shown in the end-user interface).

There can be any number of specialized transaction interfaces available to be used in a tailored search. The search experience editor and end-user interface could have little support or a great deal of support for specialized transaction interfaces. In an example (at the “little support” end of the spectrum), the search experience editor allows its user to write a program and store it in the search experience modification record. When the tailored search is triggered, the program is run. The steps described above are typically encoded into the program by the user; in certain examples, the search experience editor supports just the one activity (writing the program) and the end-user interface supports just the one function (running the program). In this example, the search experience editor need not know anything about any of the specialized transaction interfaces. In another example (at the “great deal of support” end of the spectrum), the search experience editor has a palette of icons, such as one per available specialized transaction interfaces. The administrative user can select an icon representing a specialized transaction interface, drag it to a desired location in the administrative search experience editor interface and place it there. Each specialized transaction interface represented in the palette typically has a pre-specified set of parameters, including a mapping from the typical inputs of the end-user interface (the user's query, any other search parameters selected by the user, such as a product selection or result type limitation, any user preferences, any session context or other information about the user, etc.) to specialized transaction interface parameters. Each specialized transaction interface represented in the palette typically has a pre-specified condition and a pre-specified (and pre-coded) mechanism for evaluating the condition. Each specialized transaction interface represented in the palette typically has an attribute specifying whether the transaction is to be run automatically or upon user input. For a specialized transaction interface that takes additional input(s) from an end-user before running the transaction, the search experience editor typically has a pre-specified description of the type of input(s). A code for each specialized transaction interface represented in the palette is typically stored in a standard location known to the end-user interface and each specialized transaction interface has a unique identifier. The parameters and mappings, the conditions and mechanisms for evaluating them are likewise typically stored in a standard location and can be referenced with the identifier of their accompanying specialized transaction interface. When a specialized transaction interface is dropped into a tailored search, only its identifier and its specified location in the end-user interface are typically recorded in the search experience modification record. This is sufficient for the end-user interface to use the specialized transaction interface. The end-user interface typically has a generic condition evaluator that takes the condition to be evaluated and the mechanism to evaluate it as parameters, calls the mechanism, and returns the result of the evaluation. It has code that, if the condition is true, runs a specified transaction and renders the results on the screen (either automatically or upon receiving user input, in accordance with the value of a passed-in attribute). When the tailored search is triggered, the identifier is recovered, the specialized transaction interface along with its parameters, mappings, conditions, condition evaluation mechanisms, and attributes are retrieved. These are plugged into the end-user interface code described above and the specialized transaction interface is used. Finally, there is a registration mechanism that allows the search experience editor user to add a specialized transaction interface to its palette, such as by providing all of the parts (the specialized transaction interface—e.g., the widget itself—along with its parameters, mappings, conditions, condition evaluation mechanisms, and attributes). This registration mechanism stores these parts and associates an identifier with them, enabling the use of the new specialized transaction interface in both the search experience editor and the end-user interface.

### Tailored Search Triggering

We have been saying things like “when the tailored search fires” or “when the tailored search is triggered”. In this section we'll go into detail about certain examples of how that happens.

We previously stated that when a query entered in the end-user interface is recognized as being sufficiently similar to the trigger query, the tailored search is triggered. The trigger matcher is typically the component that determines whether the user-query is sufficiently similar to the trigger query. In an example, the user-query is sufficiently similar to the trigger query when they are identical. In another example, the user-query is sufficiently similar to the trigger query when normalized versions of them are identical. Normalization converts a query to a canonical form, and can include lower-casing the query, stemming the query, and performing synonym substitution on the query—when any term in a synonym group is found in the query, substituting the synonym group's canonical form (or the synonym group's identifier) for the original term.

In another example, the user query is sufficiently similar to the trigger query when the user query contains the trigger query (and possibly contains other text as well). In another example, the user-query is sufficiently similar to the trigger query when the trigger query contains the user query (and possibly contains other text as well).

In another example, the search experience editor's user specifies, such as search experience by search experience, whether the matching process requires the user query and trigger query to match completely with no “leftover” text in either one, or to match based on containment. In FIG. 14A, a control such as 1416 can be used to allow the search experience editor user to conveniently specify this; the control 1416 corresponds to an attribute that is stored in the search experience modification record; the trigger matcher consults this attribute during matching.

In another example, the user query is sufficiently similar to the trigger query when the canonical form of the user query contains the canonical form of the trigger query.

In another example, the user query is sufficiently similar to the trigger query when the canonical form of the trigger query contains the canonical form of the user query.

In another example, the user query is sufficiently similar to the trigger query when the canonical form of some word, term or phrase in the user query contains the canonical form of some word, term or phrase in the trigger query.

In another example, the tailored search may have multiple trigger queries, and the tailored search is triggered when the user query is sufficiently similar to any of the trigger queries. In an example, the Query pane 1210 of FIG. 12 has an Add control that allows the search experience editor user to add trigger queries.

In another example, the tailored search may have multiple trigger queries, and the tailored search is triggered when the user query is sufficiently similar to any of the trigger queries.

In another example, triggering a tailored search takes into account not only the user query string but also other parameters of the search or session context. A tailored search might fire only when the user has selected a particular product, or only when the user is in a specific segment of users. FIG. 14A shows an example interface 1400 for adding a new tailored search, which contains the properties of a tailored search. Much of the data entered in the interface shown in FIG. 14A constrains the triggering of the tailored search, that is, it constrains when the search fires.

In an example, check boxes (1430, 1435) are provided for selecting one or more environments to which the tailored search is applicable. Check box 1430 denotes a Self-Service application, which is accessible to users from as a web site. A query entered from the Self-Service site will trigger a tailored search only if the Self-Service box 1430 was checked when the tailored search was constructed; similarly for any application or environment listed in the Applies-To area. Items from this area of the interface are recorded in an Applies-To list in the search experience modification record. The application or environment into which the query was entered is part of the input to the trigger matcher, and the trigger matcher compares it with Applies-To list in the search experience modification record for a tailored search; that tailored search will fire only if the application or environment is on the list, in this example.

In an example, drop-down menu 1425 is supplied for selecting one or more languages. The languages are stored in a Languages list in the search experience modification record. The language in which the query was entered is part of the input to the trigger matcher, and the trigger matcher compares it with the Languages list in the search experience modification record for a tailored search; that tailored search will fire only if the input language is on the list, in this example.

Other possible session context elements can be specified as part of the scope of a tailored search experience. Session context elements are elements of the end-user search session. For example, an end-user might select a product from a pulldown in the end-user interface in order to constrain the results to resources related to that product, or the end-user might have entered the site from an entry point that is particular to a product, so the site would add information identifying the product to the session context interface in order to constrain the results to resources related to that product. An example interface for selecting session context elements is presented in FIG. 14C. This interface is reached via the “Edit Scope” control 1426 in FIG. 14A. Session context elements are displayed as meta-data elements in the example of FIG. 14C, and may be selected via a tree 1427, or via a search over possible session context elements. However they are specified, the specified session context elements are typically stored in a context element list in the search experience modification record. The context elements in the end-user's search session are then used as part of the input to the trigger matcher, and the trigger matcher compares them with the context element list in the search experience modification record for a tailored search; in this example, that tailored search will fire only if the context elements listed in the search experience modification record match the context elements in the end-user's search session.

The trigger matcher processes every incoming query (along with its session context) and for each query, compares the query string and session context with the information recorded in the search experience modification records for each tailored search to see whether they correspond. There may be a high volume of queries, and there may be a large number of tailored searches. Therefore, a subscription engine is useful for implementing the trigger matcher. Subscription engines are architected for rapid comparisons in the presence of high traffic volume (here corresponding to query traffic) and large numbers of subscriptions (here corresponding to tailored searches).

The rules for matching end-user queries to tailored search triggers can result in more than one match. In an example, a single tailored search is selected from the set of matching tailored searches and is run. In an example the tailored searches are ranked, such as by the quality of the match to their triggers, and the top-ranking one is selected. In an example, a trigger that matches more of the query ranks higher than a trigger that matches less of the query. (This means that the more specific trigger will be selected.) If two triggers have equal rank and are the top-ranked query, one of them may be selected arbitrarily. In another example, the matching tailored searches are merged, and the merged tailored search is run. Merging tailored searches typically involves merging the various lists in the search modification records of each tailored search; for example, the lists of deleted search results in the search experience modification records are combined into a single list.

In a system with many tailored searches, particularly if they can be made by different people, redundant tailored searches could be made. Support may be provided to help the search experience editor user avoid creating redundant tailored searches. FIG. 14B is an example of an interface 1450 that is presented when the search experience editor user selects the Create Search button 1480 of FIG. 14A and the tailored search name entered in field 1405 of FIG. 14A matches or partially matches other tailored searches. The search experience editor user is offered the choice of using one of the pre-existing tailored searches such as 1451 or 1452, or continuing on to create a tailored search using the entered name (via control 1455). In another example, the interface 1450 is presented if the tailored search's search query (rather than its name) matches or partially matches other tailored searches. In another example, the interface 1450 is presented if either the tailored search's name 1405 or its search query 1415 matches or partially matches other tailored searches.

The Search Performed in the Search Experience Editor

As stated previously, the search experience editor displays search results for a tailored search. It typically gets the results that it displays in the same way that the end-user interface does, by sending a search to the search system and receiving the results of the search from it. In an example, the search that the search experience editor sends to the search system comprises the trigger query and the search scope (application, language, product, . . . , in fact, any metadata selected to specify the scope). In an example, if the search has more than one trigger query, one of the trigger queries is identified as primary, and that one is used as the search query (that is the one that is send to the search system). In another example, if the search has more than one trigger query, all of the trigger queries are joined in a disjunction to form a new query which is used as the search query.

In another example the trigger query and the search query are independent, and possibly distinct (e.g., to allow a particular end-user query to be mapped to a possibly very different tailored search query). The search query is independently specified by the search experience editor user. Both are written to the search experience modification record. The trigger query is considered by the trigger matcher while the search query is used by the search system to select the search results. In an example, the trigger query and the search query are separately displayed in the Query pane. In an example, there may be multiple search queries (all of which are typically recorded in the search experience modification record). In an example, there is an Add control that allows the search experience editor user to add search queries.

In an example, the tailoring mechanisms, that is, the consulting of the search experience modification record and modifications of results, are implemented within the underlying search system. Each modification is performed at the most convenient point, typically when the result of the kind being modified is generated. For example, when the list of result documents is generated by the underlying search system, any documents listed as suppressed by the search experience modification record for the triggered tailored search are removed from the list. In this example, the search experience editor and the end-user interface call the underlying search system and use its results with no need for an intermediary.

In another example, the tailoring mechanisms are implemented in a separate tailoring component distinct from the underlying search system. In this example, this tailoring component can be used with any underlying search system. In an example, the search experience editor and the end-user interface call the underlying search system and receive results from it, then call the tailoring component, passing it those first results and receiving final results from it. In another example, the search experience editor and the end-user interface call the tailoring component, which calls the underlying search system and receives results from it. Then, the tailoring component modifies the results and returns them to the caller.

### The Query Match Pane

The Query Match pane 1250 lists queries that will trigger the tailored search when any of these queries are entered in the end-user interface. Recall that the queries that trigger the tailored search are not only those that are identical to the trigger query but also those that generalize it (in ways described above). The Query Match pane 1250 allows the search experience editor user to see which queries are affected by the modifications, which is helpful to the search experience editor user's ability to provide a good search experience for the end-users.

The queries 1251, 1252, etc. shown in the Query Match pane 1250 can come from any source. In an example, the queries shown in the Query Match pane 1250 are selected from the search system's query logs, that is, they are queries that have been entered in the past by users of the system. In an example, the queries come from a list of queries that is supplied for the purpose of populating the Query Match pane appropriately. This list might come from another search system (for example, if an enterprise changes from some search system to one that uses the present systems or methods), from other divisions of the enterprise or other enterprises, from academic or government studies, or it might be comprised of examples that experts believe are (or will be) important or frequent.

In certain examples, the entire set of queries from whichever source is used (which may be all the queries that have ever been entered into the search system) are run through the trigger matcher (the subscription engine), and those queries that match the trigger for the current tailored search are shown in the Query Match pane. Thus, in this example, the same trigger matcher that is used to match queries to tailored searches in the end-user interface can be used to match queries for the Query Match pane. It follows, then, that the queries shown in the Query Match pane have whatever relationship to the tailored search's trigger that the end-user queries have, and this relationship may vary in ways we discussed above. It follows also that any of the queries, such as 1251, 1252, 1253, shown in the Query Match pane will trigger the tailored search if they are entered in the end-user interface. The less direct the relationship between queries and the trigger, the more important it is that the search experience editor user be able to see which queries will be affected by the tailored search.

The count column 1255 identifies the number of times a particular query has been entered by some end-user. For example, the third item 1253 (“how to delete a buddy list”) has been searched 987 times.

In addition to letting the search experience editor user see the matching queries, the query pane 1250 allows the search experience editor user to control which queries will trigger the tailored search by selectively associating a particular query with the tailored search, or dissociating a particular query from the tailored search. An Add control 1256 allows the search experience editor user to add queries to this pane. In an example, this control brings up a text box into which a query can be entered; the entered query is added to the queries in the query pane (it may be visually distinguished as having been added manually) and is associated with the tailored search. Such an added query, when entered into the end-user search interface, will trigger the tailored search whether or not it otherwise would have matched the trigger for the tailored search. The added query is written to a list of associated queries in the search experience modification record, which is consulted by the trigger matcher. If the added query is entered in the end-user interface, the trigger matcher matches it against this list and proclaims a match.

Similarly, a Delete control such as 1257 allows the search experience editor user to remove queries from this pane and disassociate them from the tailored search experience. A deleted query, when entered into the end-user search interface, will not trigger the tailored search whether or not it otherwise would have matched the trigger for the tailored search. The deleted query is written to a list of disassociated queries in the search experience modification record, which is consulted by the trigger matcher. If the deleted query is entered in the end-user interface, the trigger matcher matches it against this list and (regardless of any other characteristics) does not proclaim it a match.

Illustratively, selecting the Delete control 1257 for the “how to save my buddy list” item 1252 dissociates the item 1252 from the present search (Buddy List). In an example, selecting the Delete control 1257 also removes the item 1252 from the Query Match pane 1250. In an example, selecting the Delete control 1257 does not remove the item 1252 from the Query Match pane 1252, but rather modifies its presentation to make it clear that it has been removed, such as by graying it out, or displaying it with strike-through, or by moving it to a region of the pane labeled as showing deleted queries. In an example, an interface is available to re-associate previously disassociated queries with the search experience. In an example, the “Deleted Items” control 1254 brings up a list of deleted query items and selecting an item from the list re-associates the selected query item with the search experience. In another example, in which the deleted query items are visible in the Query Match pane 1250 (grayed out or struck though, perhaps), a “restore” control for each deleted query item (for example, the add icon used elsewhere in various figures) is present in the Query Match pane, corresponding to the Delete control for the non-deleted query items such as 1251, 1252, etc.

In an example, a control is provided to cause information about a selected query to be displayed. In an example, each query item has a control for this purpose. In an example, such a control would use the same icon as control 1215 in the query pane 1210 and would perform the same action, bringing up the interface shown in FIG. 15, on the Query Match pane query item with which the control is associated. In another example, the control icons shown in the Query Match pane would be used, and would expand to show the same information shown in FIG. 15 about the query directly in the Query Match pane. These controls allow the search experience editor user to understand why a query item in the Query Match pane that uses different terms from the trigger query matches the trigger query.

### The Search Performed in the End-User Interface

Recall that the search performed by the search experience editor for a tailored search may comprise the trigger query or may be independently specified. Recall as well that a query that triggers the tailored search may be identical to the trigger query or may differ from it, such as in ways specified above. The question arises, what search is done in the end-user interface? In an example, the query that is searched on in the end-user interface is the tailored search's search query, and any differences between that and the query entered by the end-user are ignored—the end-user's query is replaced by the tailored search's search query. In another example, the query that is searched on in the end-user interface is the query entered by the end-user, and any differences between that and that tailored search's search query are ignored. In another example, the query entered by the end-user and the tailored search's search query are combined, and it is the combined query that is searched on in the end-user interface.

In this example, referring now to FIG. 23B, the query terms 2316 are sent to the trigger matcher 2341 and to the index lookup component 2335. The query terms are matched against the stored triggers by the trigger matcher 2341 and if a match is found, the search experience modification record 2342 for the matching search experience is identified. The search query 2343 for the matching search experience is extracted from the search experience modification record 2342 and is sent to the index lookup component 2335. The index lookup component combines the query terms with the search query to construct the search that it performs on the search index 2333. In an example, the query terms are combined with the search query, such as by finding a mapping from the end-user's query to the tailored search's trigger query, and the elements of the end-user's query that do not correspond to any element of the tailored search's trigger query are added to the tailored search's search query; the result is the combined query. In an example, the user's session context is also added to the final search query. If the tailored search has multiple search queries, then these multiple search queries can be combined with the end-user's query or session context, such as described above.

The trigger query for a particular tailored search can be different than the user query provided by the user, such that an end-user query entered in an end-user interface that triggers a particular tailored search experience may actually use a different trigger query for the resulting tailored search experience. This means that the search performed in the end-user interface when a tailored search is triggered may not be the search that is performed in the search experience editor for that tailored search. Hence the results shown n the end-user interface may not be the results shown in the search experience editor. This may be problematic for the search experience editor user, who is trying to craft the results for all users that enter matching queries. To address this issue, in certain examples, a preview mechanism is supplied in the search experience editor. The search experience editor user can select a query from the Query Match pane and see (in the administrative search experience editor interface) the results of that executed query. In an example, this preview operation is available through a menu item in the right-click menu for a query item in the Query Match pane. In another example, a “preview” control is provided for each query item in the Query Match pane. In an example, the preview is shown in a separate interface reflective of the end-user interface (e.g., a pop-up that looks like what the end-user would see, having entered the relevant query, would appear). In another example, the preview is shown in a new tab in the search experience editor, In the example, all of the controls are available for crafting the results of the previewed query. The modifications made in this tab are recorded in the same search experience modification record as the original tailored search (the new tab does not have its own search experience modification record because it does not represent a separate tailored search). In another example, the preview replaces the view shown in the current tab. In an example, a “back” button is provided to return to the previous view. In this way that search experience editor user can generalize the modifications they are providing so that they cover not only the original search but also the other searches that will trigger that particular tailored search experience.

### Search Template Builder

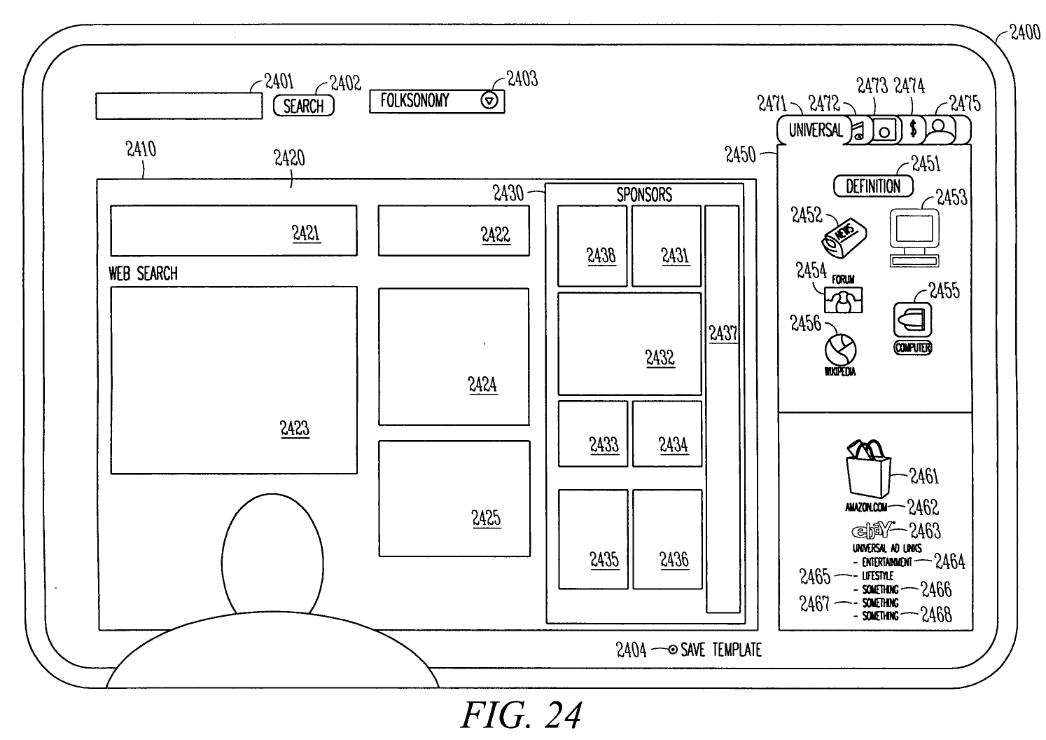

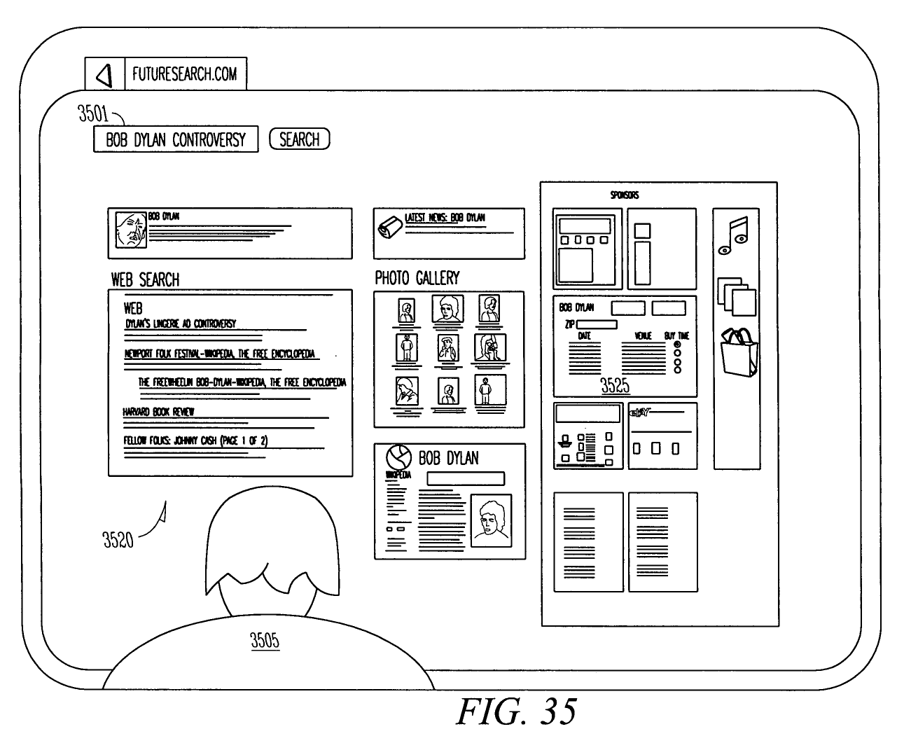

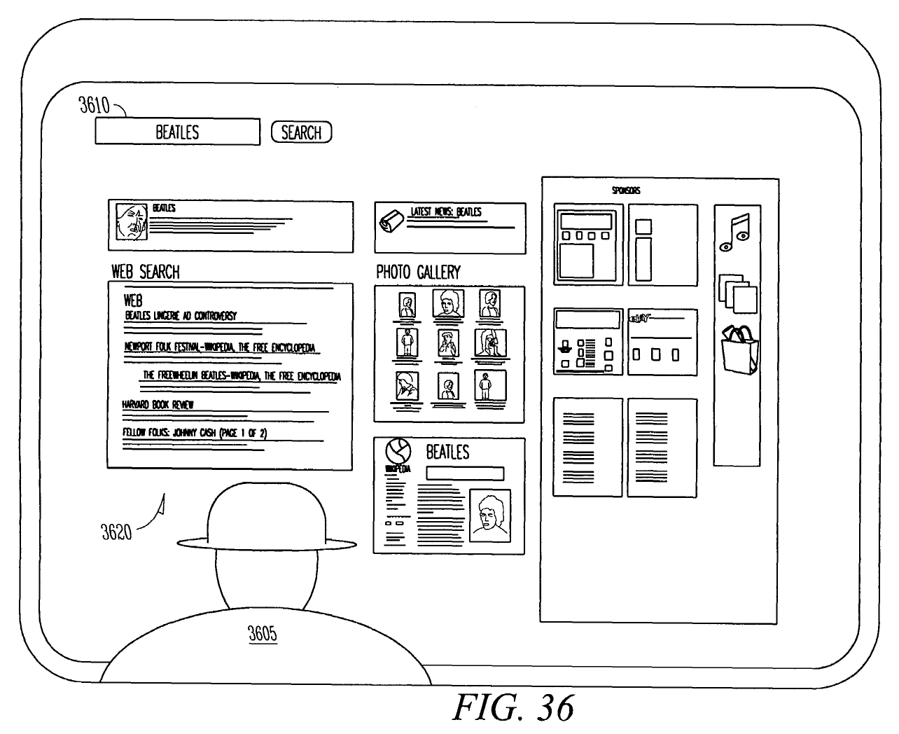

Much of the previous description has focused on tailoring the results that appear in the search interface, with discussion of control over the layout of the interface, including discussion of adding elements (e.g., featured results panes and specialized transaction interfaces). Here we describe methods for tailoring search results interfaces (which may vary from search to search), from the page layout to the kinds of searches that are done, returning finally to tailoring the results themselves. FIGS. 24 to 34 step through an example of a process of designing a search template in a WYSIWYG editing interface. The designed search template permits tailoring the search interface for a large class of queries, instead of permitting tailoring only for a particular query. As will be described, the query classes described in this section are typically more general because they are more highly abstracted. FIGS. 35 and 36 show examples of the resulting end-user interfaces for two different queries in the class to which the template applies.

FIG. 24 is an example of an editing interface for designing a search template. This editing interface is also an instantiation of a search experience editor, albeit with a somewhat different focus than what has been previously described. Interface 2400 typically includes a search box 2401, a search button 2402, a nearly blank search template 2410 for the results area of the search page, a palette 2450 of specialized transaction interfaces or widgets, a expandable/collapsible pane 2403 for listing query abstractions, and a SAVE TEMPLATE button 2404. Template 2410 contains a search results area 2420 containing five panes 2421, 2422, 2423, 2424, and 2425 on the left. Panes 2421, 2422, 2424, and 2425 are examples of containers into which search or other specialized transaction interface widgets may be dropped. Pane 2423, the one such pane that is labeled, already contains a web search widget. (It is the presence of this widget that makes this template “nearly blank”, rather than blank.) This widget takes input from the search box 2401, performs an Internet search on that input, and displays the results in pane 2423. Further to the right in template 2410 is a Sponsors area 2430 containing panes 2431, 2432, 2433, 2434, 2435, 2436, 2437 and 2438. Panes 2431 through 2437 are examples of containers into which sponsor widgets may be dropped. Pane 2438 is a legend, alerting the user to the type of information shown in corresponding regions in corresponding Sponsors areas. Palette 2450 contains icons 2451, 2452, 2453, 2454, 2455, and 2456, each representing a distinct search widget, as well as icons 2461 through 2468, each representing a distinct sponsor widget. In this example, palette 2450 has tabs 2471 through 2475; each tab represents a distinct set of widgets.

The search experience editor includes a list of search templates. Each search template is associated with a particular search experience (also referred to as a tailored search), and the search experience modification record that goes with a tailored search experience therefore also goes with the template that's associated with the search experience. The search experience modification record typically contains information specifically for handling templates; it typically has a list of widgets, their positions on the page (possibly in terms of pre-identified locations, such as the fixed positions shown in the template 2410), and their arguments. In this example, the search experience modification record for the template 2410 lists only the web search widget 2423. It lists the argument to the widget as the search query 2401, which is empty at this point.

A fixed template is not required. Rather than dropping a fixed number of widgets from the palette into fixed positions on the page, the layout could be free-form, with an arbitrary number of widgets dropped into arbitrary positions on the page, and the editing interface could support moving and sizing the widgets. Various page-layout capabilities are possible. For expository and illustrative purposes, the figures are shown using a fixed template.

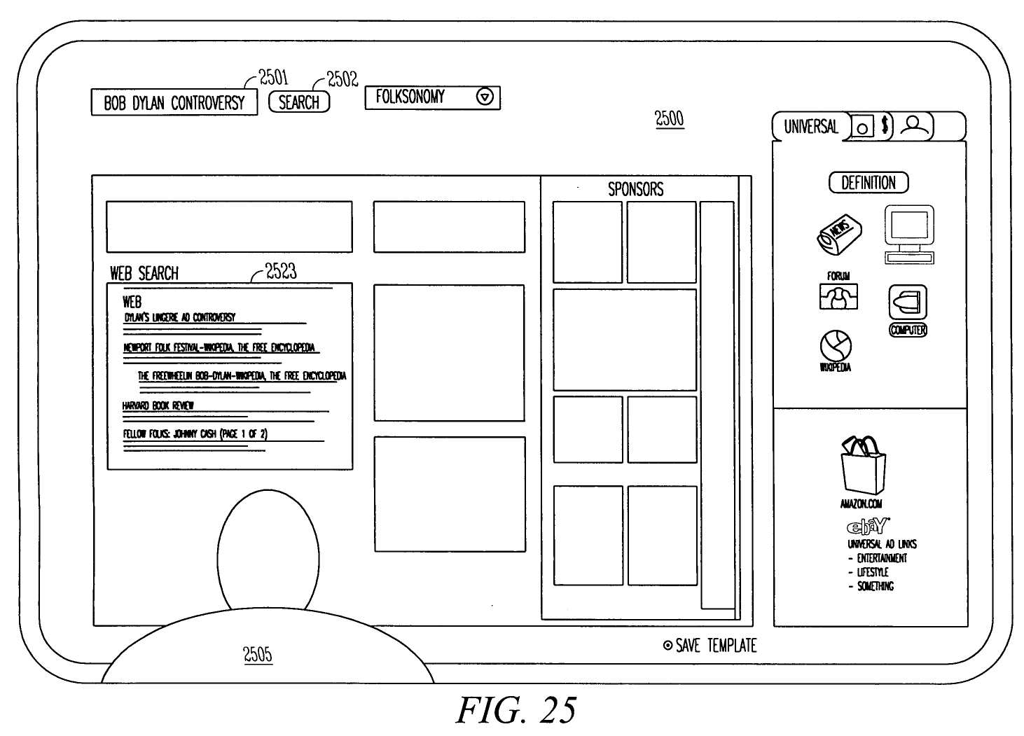

FIG. 25 shows an example of the initial interaction of a user with the editing interface 2500. In this example, the user 2505 launches or navigates to this interface in the search experience editor, types a query “Bob Dylan controversy” into the search box 2501 and clicks the search button 2502. The web search widget populates with web search results for the query in the search box 2501, consistent with a WYSIWYG interface. The system actions typically proceed as follows. The default search template is instantiated into the editor and displayed on the screen. The query “Bob Dylan controversy” is recorded in the search experience modification record. That query is passed to the web search widget 2523, which runs the search and returns the results back to the search experience editor, which displays them in the widget's screen area 2523. (Of course, the template could start out completely blank. It is likely that some default search—Internet search or enterprise search—would make sense for most search experiences, thus it makes sense to have such a widget in the default search template.)

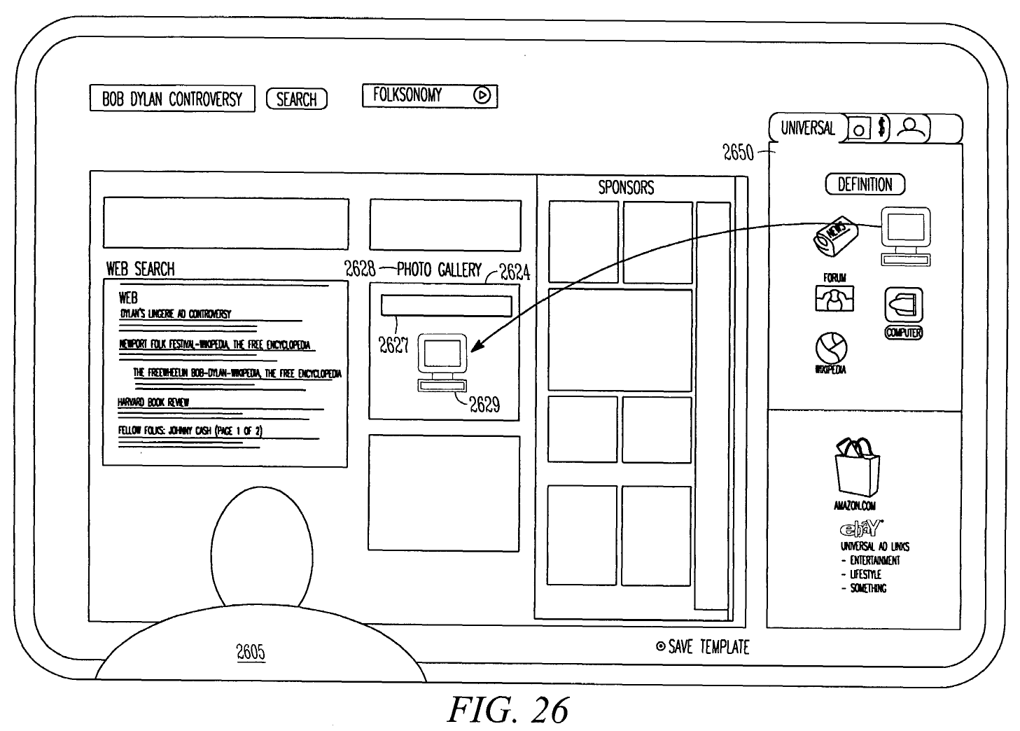

FIG. 26 shows an example of the next step of search template construction. The search experience editor user 2605 selects a widget 2653, for example, an image-search widget, from the widget palette 2650. The user 2605 places the widget into one of the widget containers 2624. This action could be performed using drag-and-drop, or selecting (clicking on) the icon in the palette could change the shape of the cursor to match the icon, and subsequent cursor actions would thereby be understood in the context of the item selected from the palette; subsequently clicking in the widget containers 2624 would place the widget in that container. Any other user interface for item placement could be used. When the widget is placed in the container, the search experience editor adds the widget to the list of widgets in the search experience modification record and records its display location. In the interface, it labels the container 2624 with the display name 2628 of the widget (if any) and displays the widget icon 2629 in the container 2624. It displays an argument field 2627 (in this example, a text box) in the container 2624, indicating that the arguments to the widget should be specified.

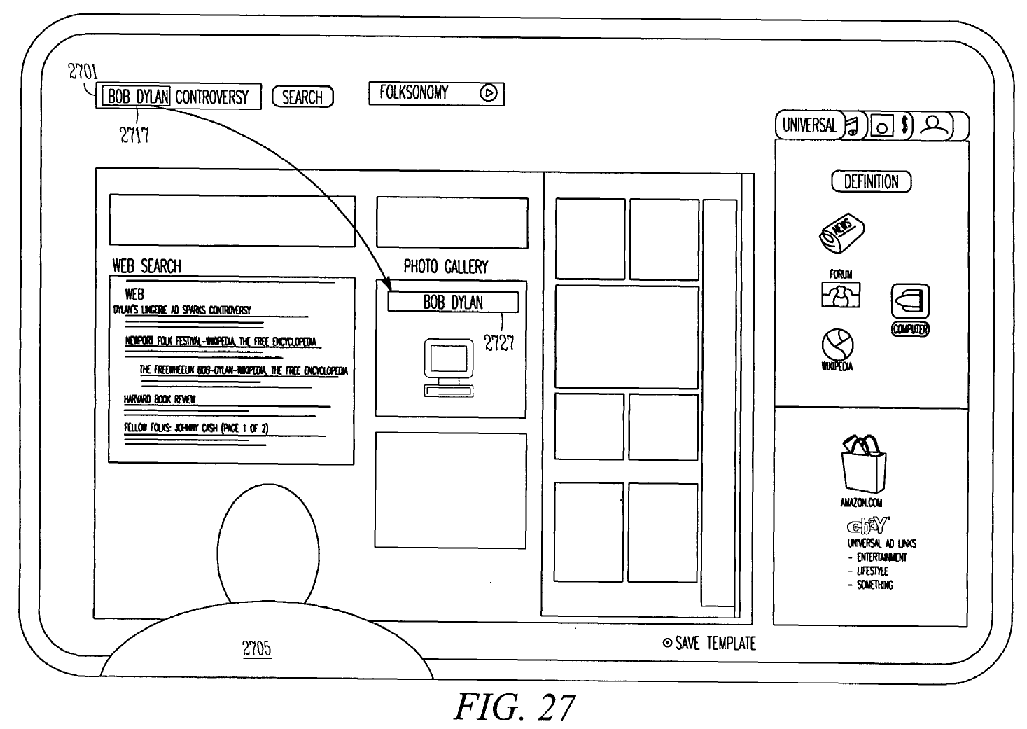

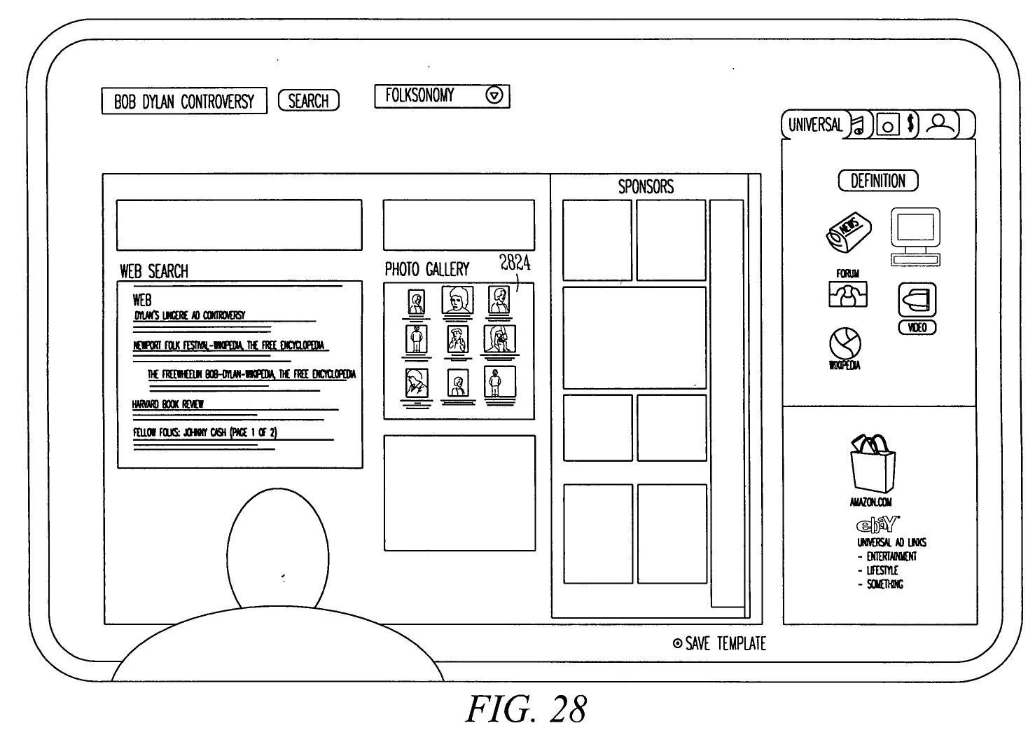

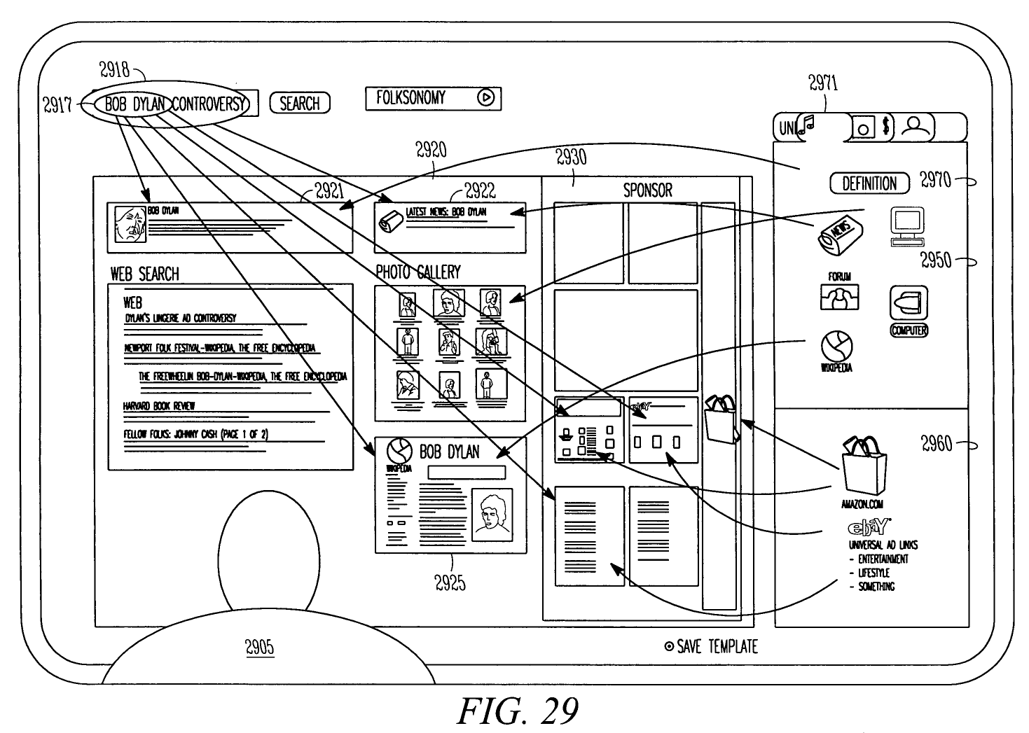

FIG. 27 shows an example of the step of specifying arguments to the widget and FIG. 28 shows the results thereof. The search experience editor user 2705 selects some portion 2717 of the search query text—in this instance, “Bob Dylan”. The user 2605 places the text into the argument field 2727. As with widget placement, this action could be performed using any suitable interface. When the text 2717 is placed into the argument field 2727, the search experience editor records the argument specification in the search experience modification record.

In the example of FIG. 28, the argument to the widget now being available, it is passed to the image search widget, which runs the search and returns the results back to the search experience editor, which displays them in the widget's screen area 2824. The system response time is merely the time it takes to do the search, and the actual results of the search are directly visible to an administrative user in the search experience editor. Thus, the search experience editor's administrative user can immediately see the results of their actions, in contrast to a situation in which page layout would be done in a distinct interface that does not do any searching. This avoids phased design work, in which the search results cannot be seen during the page design phase, and page design cannot be done during the result review phase.

For simplicity of exposition we described this step with a widget that takes a simple argument. The argument specification step could be more complex. For example, consider a query that mentioned a stock ticker symbol. Suppose the search experience editor's user had placed a stock report widget on the page. The ticker symbol from the query would be an argument, specified in the manner described above. But other arguments might be used as well. If the widget had the capability of showing the stock movement over time, the time period might be an argument. In this instance, the time period does not depend on the query; in an example, the search experience editor would display an interface for specifying the time period and search experience editor user would use that interface to specify the time period; this could be part of adding the widget to the search template just as specifying a textual argument from the query is. A widget can have multiple arguments. It can have arguments specified from the search query and arguments specified by the search experience editor directly. It can have arguments that are looked up from an external source; the search experience editor user specifies how to do the lookup. In an example, a search widget such as an insurance rate calculator might be sensitive to the state in which the prospective policy holder lives. If the user is registered or the search system knows the user's address, the search experience editor user might specify that the argument use the address element of the session context. In another example, returning to the stock report widget, if the search query contains a company name (not a ticker symbol), the search experience editor user might specify that the company name be passed to a ticker-symbol lookup function and the output of the function be sent in as the argument to the stock report widget. In these examples, the sources of the arguments to a widget are recorded in the search experience modification record along with information identifying the widget.

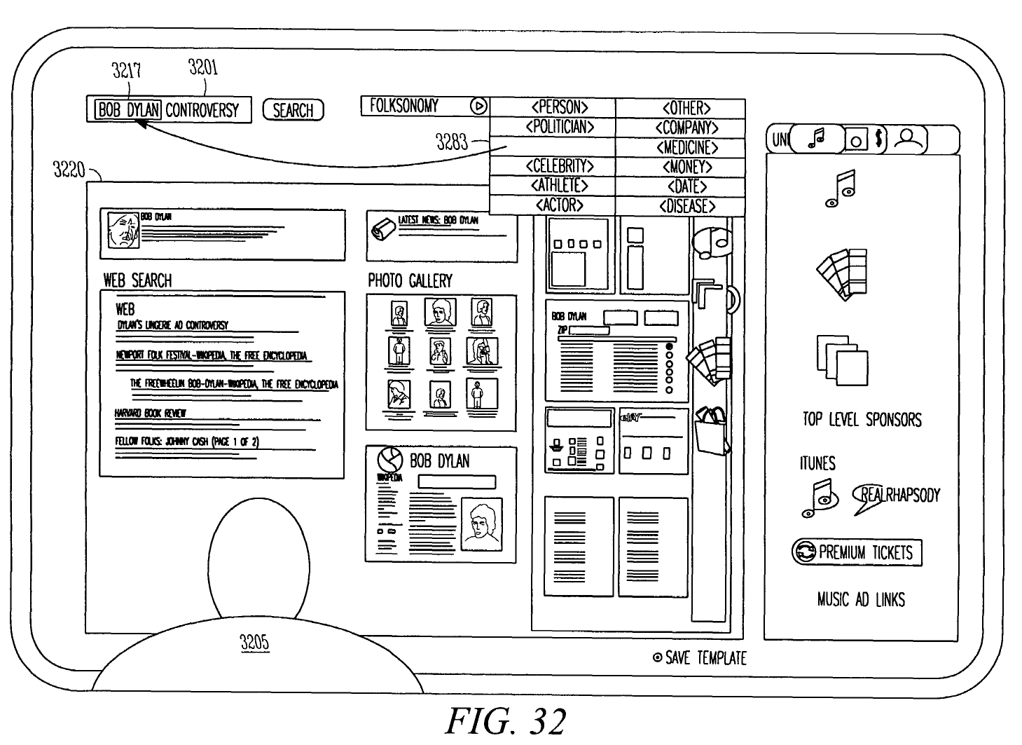

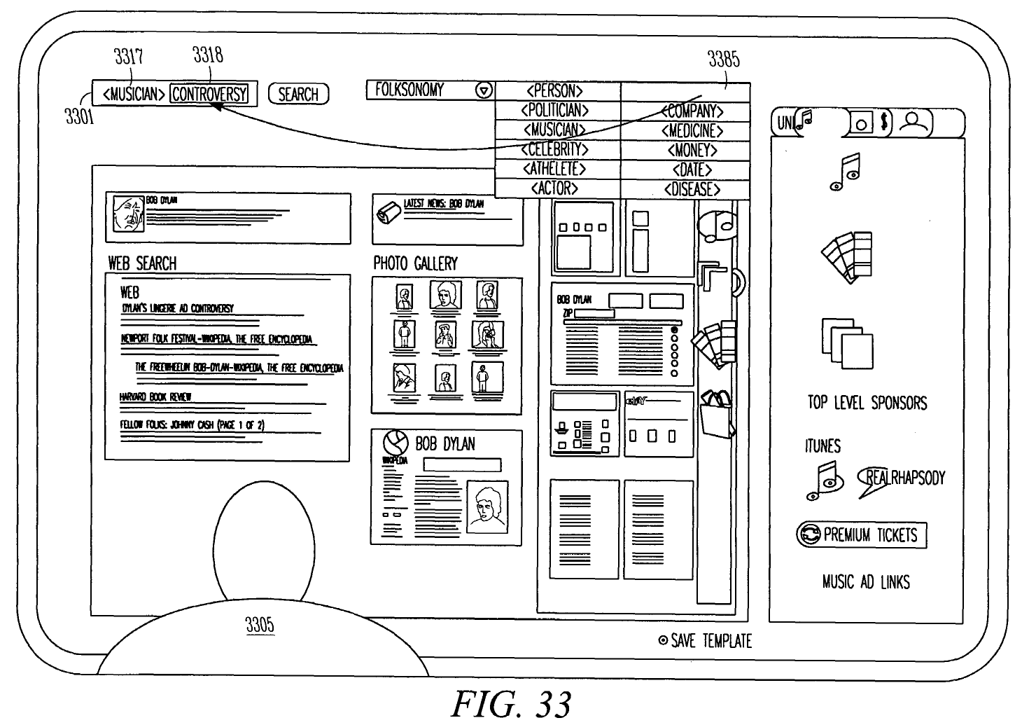

In an example, the case in which a widget argument 2727 comes from the search query 2701 is generally handled with a reference to the relevant part of the search query 2717, rather than a copy of that part of the query. For example, the starting and ending character positions, or any other method of identifying the relevant part of the query, may be used. The earlier discussion of trigger queries versus search queries, and combining the user query and the trigger or search query, suggest reasons for using reference rather than copying. FIGS. 32 and 33 will directly address this issue.

FIG. 29 is an example that collapses into a single step the multi-step process of search template design. In this example, the widget palette 2970 is divided into a top portion 2950 containing icons representing search widgets and a bottom portion 2960 representing sponsor widgets. In this example, the search experience editor user 2905 may place widgets into desired locations, such as into widget containers 2921, 2922, and 2925 in the search results area 2920 from the search widgets portion 2950 of the Universal tab 2971 of the widget palette 2970. The search experience user 2905 also may place widgets from the Sponsors portion 2960 of the Universal tab 2971 into widget containers 2934, 2935, and 2936 in the sponsors area 2930. The search experience user 2905 then specifies one or more arguments to each widget, in this example either “Bob Dylan” 2917 or the entire query 2918. Consistent with the WYSIWYG nature of the search experience editor, upon completing these steps, widget results are visible for the widgets that have been placed into the template.

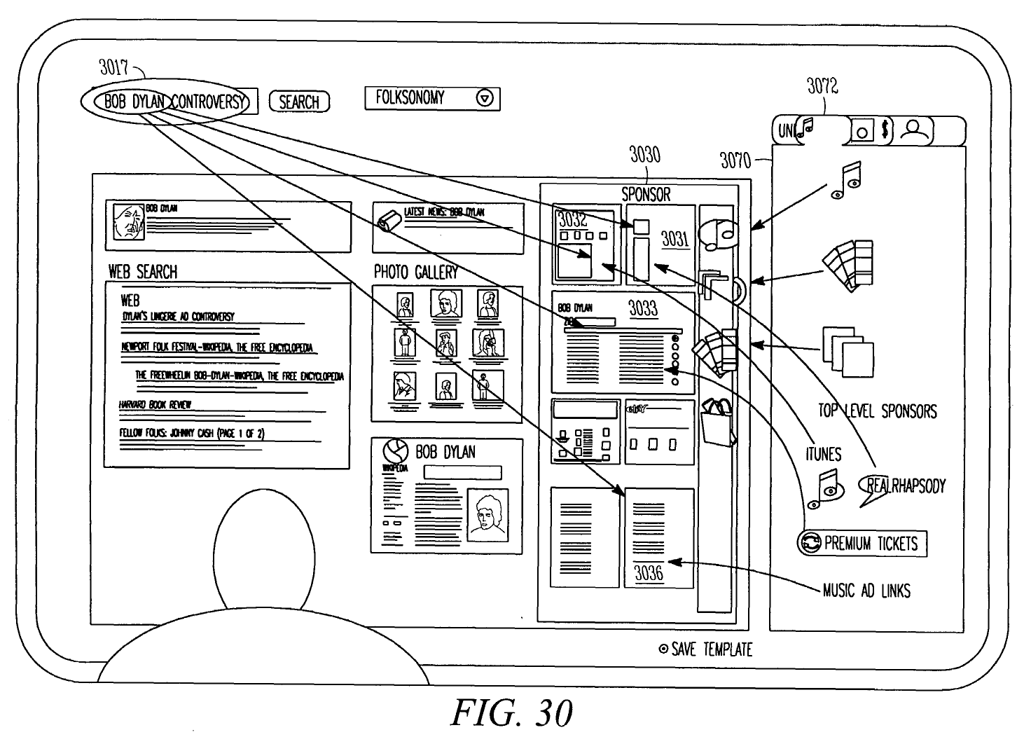

FIG. 30 is an example that completes the placement and argument specification for this example of the search template. In this example, widgets are placed from the Music tab 3072 of the widget palette 3070 into the remaining Sponsor area 3030 widget containers 3031, 3032, 3033, and 3036. The administrative user specifies the arguments to each widget, in this case “Bob Dylan” 3017 is used as the argument for all of the widgets. Some organization of the widget palette 2970, 3070 is helpful, especially for a large numbers of possible widgets. Without some organizing principles, the search experience editor user may be at a loss to find all of the appropriate widgets for a template. However, many different organizing principles can be used and no particular organizing principle is required. For that matter, a widget palette is only one possible interface for widget selection. A search interface or a browse tree interface are others. Any suitable widget selection interface may be used.

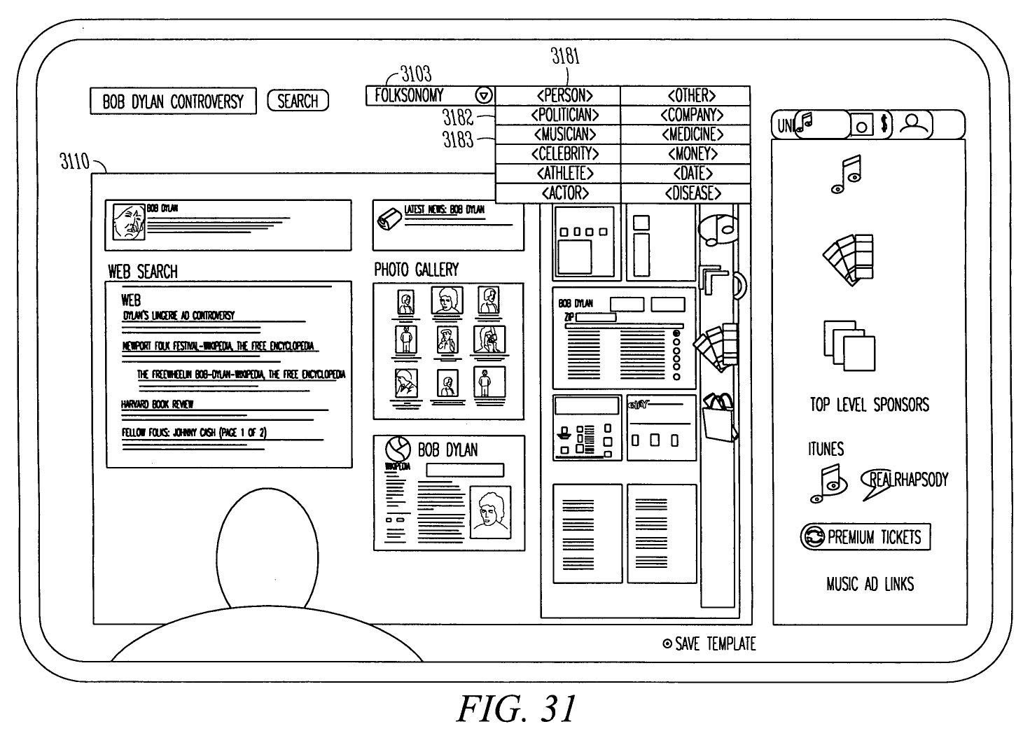

FIG. 31 shows an example of a first step in a process of abstracting the search template above the level of the initial query. Consider what has been accomplished: The search template area 3110, which defines the search template, is complete, and a rich search results page has been designed for the query “Bob Dylan controversy”. A similar page may be appropriate for the query “Willie Nelson braids” or for that matter, “is Dolly Parton married?”. Having gone to the effort of designing a rich page, it is possible to get re-use out of the template.

The Folksonomy pane 3103 supports the ability to abstract one or more portions the query for re-use, such that the tailored search created for a particular query can also be used for other like queries. The Folksonomy pane 3103 contains categories or abstractions 3181, 3182, 3183, etc. A “folksonomy” is a collaboratively generated, open-ended labeling system that enables Internet users to categorize content, and here we apply it to categorizing queries or portions of queries. However, note that any categorization/abstraction scheme could be used in the place of a folksonomy.

In FIG. 32, the search editor user 3205 abstracts a portion 3217 of the query 3201 by relating it to a particular folksonomy category. The search editor user has selected category <musician> 3283 as the appropriate abstraction of “Bob Dylan”. Several other categories might have been chosen for Bob Dylan (person, celebrity, actor), but notice that some of the sponsor widgets have to do with selling music. (The choice need not be based on sponsors. Had a discography widget been placed in the search results area 3220, that would have also been a reason to select <musician>.) In an example, the search experience editor user performs the abstraction operation by highlighting a portion of the query and subsequently selecting a category into which that portion of the query is abstracted.

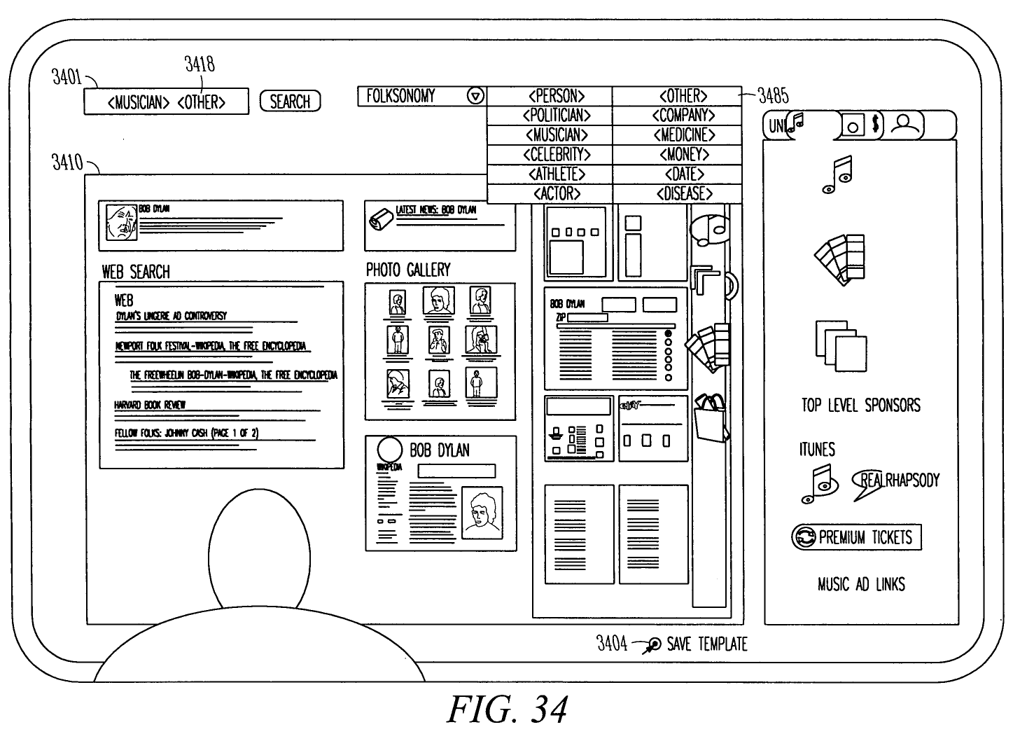

We see in FIG. 33 the result of the abstraction operation; the abstracted portion of the search query has been replaced by the abstraction or category 3317. Any of a number of user interfaces could be used to specify the abstraction; for example, portions of the query could be dragged to the folksonomy pane and dropped onto a category, or a category could be dragged to the search box and dropped onto a portion of the search text, or a mapping table could be built, with the query text in one column and the category in another, or arrows could be used to connect the category to the text, much like in FIG. 33 and FIG. 34, or any other suitable interface could be used.

The replacement of the query text with the abstraction is stored in the search experience modification record. While for simplicity of exposition FIG. 33 shows replacement in the search text box, it may be beneficial to show an administrative user both the original query and the abstraction, particularly as the search results shown in the widgets are the results for the original query.

When describing previously how arguments to the widgets are represented, we mentioned that they refer to the portion of the search query that is (one of) their argument(s), rather than being given a copy of the search query text. One reason for this is that when the search query gets abstracted, the widget arguments should also get abstracted. Consider the photo gallery widget. It is passed the string “Bob Dylan”, on which it does an image search. Subsequently the string “Bob Dylan” in the search query 3301 is abstracted to “<musician>” 3317. When the search template trigger is matched in the end-user interface, any (recognized) musician's name will match “<musician>”, and it is desired that the actual musician's name be passed to the photo gallery widget. Therefore the representation of the argument to the widget in the search experience modification record is sensitive to the abstraction operation. By referring to the portion of the search query 3301, rather than being given a local copy of that portion, after the abstraction takes place, the widget argument refers to “<musician>”. In the end-user interface, the queries go to the trigger matcher. The trigger matcher matches query terms against the abstractions. The trigger matcher typically is provided with one or more lexical resources that it uses to do this matching. In the running example we are using, the trigger matcher uses a list of musician names. If it encounters a listed musician name in a query, it identifies the name on the list as a match for the <musician> abstraction and instantiates the name as the value for the abstraction in the search experience modification record's search query. The value of the abstraction in the search experience modification record's search query is passed as the argument to any widget that referred to the abstraction as its argument. (The discussion above assumes that the search query and the trigger query are the same. It is possible to extend the behavior to the case in which the search query and the trigger query are distinct; a mapping between abstractions in the trigger query and corresponding abstractions in the search query are maintained so that the particular values for a recognized abstraction in the trigger query can be instantiated as values for the corresponding abstraction in the search query.)

In an example, the list of categories (or abstractions or tags, all names for the same thing) in the Folksonomy pane is extensible. In an example, any search experience editor user can add categories to the Folksonomy pane. In another example, only administrative users granted permission can add categories to the Folksonomy pane.

Also, in the example of FIG. 33 the user 3305 abstracts the unabstracted remainder 3318 of the search query 3301, replacing it with <other> 3385.

FIG. 34 shows a completed Musician template 3410 and abstracted trigger-and-search query 3401, which the search experience editor user saves via the “Save Template” control 3404. When the template is saved, its search experience modification record is sent to the trigger matcher, such as shown in FIGS. 21A and 21B. In the example shown in FIG. 34, the search query and trigger query for the search template is “<musician><other>” 3401. Any query containing a musician's name (that is known as such to the trigger matcher) will match the Musician tailored search, and the search experience modification record will allow the search system to generate an instance of the Musician template in the end-user interface, with search results specialized to the particular musician mentioned in the end-user's query. In order to get this behavior, “<other>” 3418, 3485 is a special kind of abstraction that “soaks up” all text that doesn't match any other abstraction. Alternatively, behavior could be built into the system to handle extra text implicitly. However, in the present example, any text that has not been abstracted or eliminated from a trigger query must match an end-user query in order to cause the trigger to “fire”. The search experience editor user can eliminate any extraneous text when constructing the trigger query. In another example, any additional text in an otherwise matching end-user query can be automatically added to the search query. In yet another example, any additional text in an otherwise matching end-user query can be automatically discarded. In another example, each widget has a control, similar to control 1416 in FIG. 14A, for specifying whether additional text in an otherwise matching end-user query is included in the argument to the widget. (Note that the use of the special abstraction <other> is a different mechanism to allow the search experience editor user to make this choice on a per-widget basis. Any other suitable mechanism may be used instead.)

FIG. 35 shows an example end-user interface. End-user 3505 has entered query “Bob Dylan controversy” 3501. This is the exact query used by the search experience editor user to construct the search template, and the results 3520 seen by user 3505 are identical to those in template area 3110 of FIG. 31, as you would expect from a WYSIWYG interface.

FIG. 36 also shows an example end-user interface. End-user 3605 has entered query “Beatles” 3610. This query matches the musician search template saved in FIG. 34. The rich results page built for re-use by the search experience editor user is being re-used, and the results 3620 seen by user 3605 are similar in form to those in template area 3110 of FIG. 31, but differ in content. Note that item 3525 from FIG. 35 is not present in FIG. 36. Item 3525 is a ticket-purchase widget. Bob Dylan is a living, performing musician (as of the time of this writing), and a search in a ticket-purchase widget for Bob Dylan performances will return results. The Beatles are a defunct band. A search for Beatles performances in a ticket-purchase widget will return no results. In this example, the search system does not render any results from a widget when there are no results to render. Alternatively, a message saying that there are no tickets available for Beatles performances could be shown.

We have drawn a distinction between the search experience editor user and the end-user. As described above, the use of the search experience editor may be restricted. One usage model has a small number of employees of an enterprise that provides search using the search experience editor to craft search experiences that will be used by a large number of end-users. This model would be valuable for enterprise search, in which the enterprise benefits when users find what they're looking for on the first try, and for Internet search in the case where a search provider such as Yahoo or Google or Ask.com can attract more users to their site by making the search experience better.

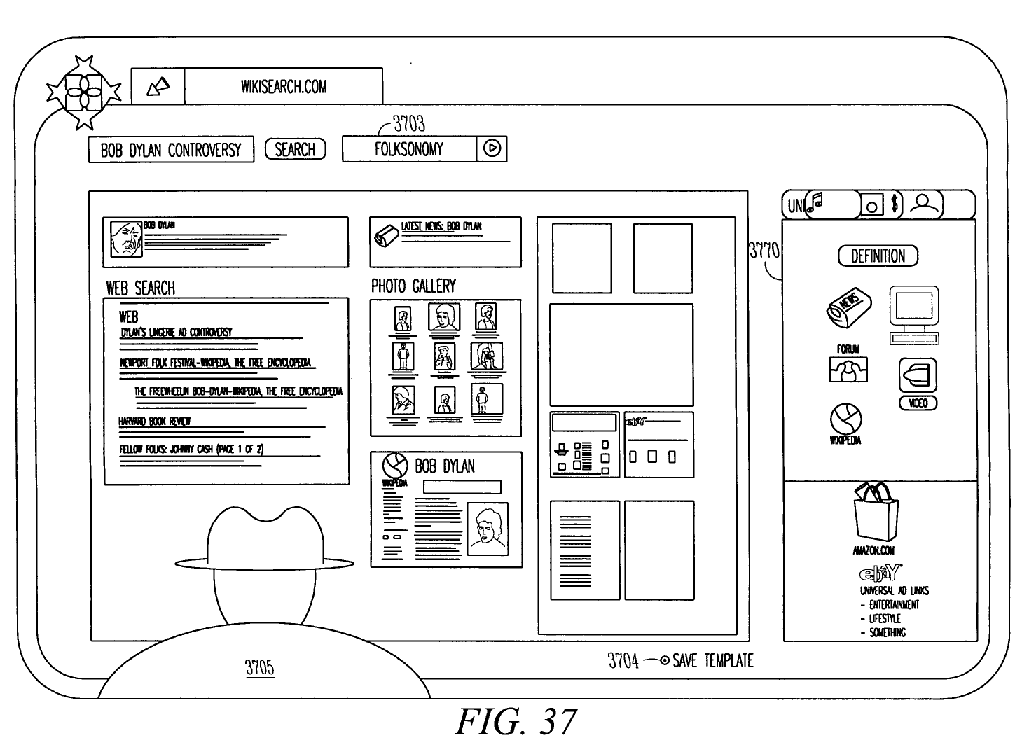

However, as exemplified by FIG. 37, the search experience editor may be turned loose to the general public, or to communities of interest. “Wiki” is a fairly newly coined term used to describe collaborative capabilities on the Internet (witness “wikipedia”, an on-line encyclopedia in which anyone can make or edit an entry). FIG. 37 shows “wikisearch”, where the user 3705 is an end-user of the search system, but this user has the full search experience editor available in the end-user interface. The Folksonomy pane 3703, the widget palette 3770, and the SAVE TEMPLATE button 3704 are all present and available. This supports a usage model in which every user can benefit from the efforts of any other user toward building a rich search experience. Of course, there is no guarantee that the efforts of all users will improve the experience; some may degrade it (possibly maliciously). The lack of any central control and the potential for abuse are disadvantages of the “wiki” model, while the vast numbers of end-users and the fact that they do not have to be paid for their work are advantages of the mode. There are several mixed models. In one example, each end-user has the search experience editor available, and the templates an end-user makes are used by the trigger matcher to match the queries entered by that end-user. In an example, each end-user has the search experience editor available, and the templates an end-user makes are reviewed by a moderator (who may be an employee of the search provider); the moderator can approve a search template for general use, but a template that is not approved by the moderator is not used by the trigger matcher. In an example, access to two interfaces is provided to the end-users. One interface does not include the search experience modification controls, but displays “unmediated” search experiences, or optionally, search results mediated (tailored) by special permissioned users (who may be employees of the search provider). The other interface includes the WYSIWIG search experience editor, which any end-user can use to modify search experiences for all end-users (the “wiki” model), and end-users are able to toggle freely between these interfaces. In an example, the search experience editor is available to users within a particular community of interest that provides search over some set of content.

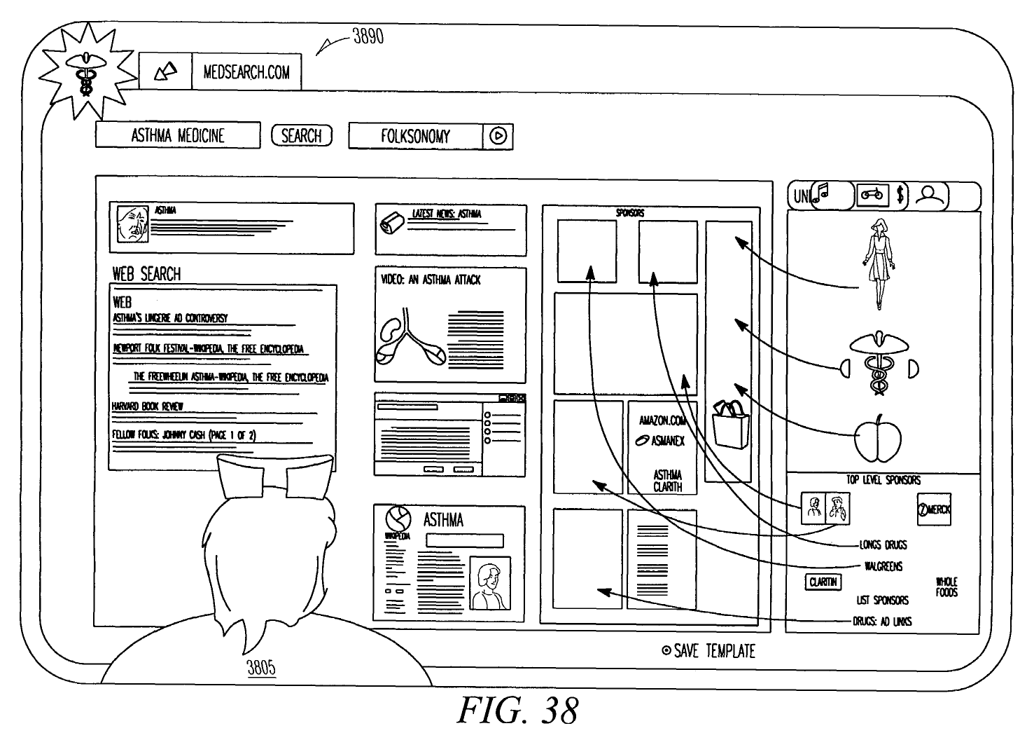

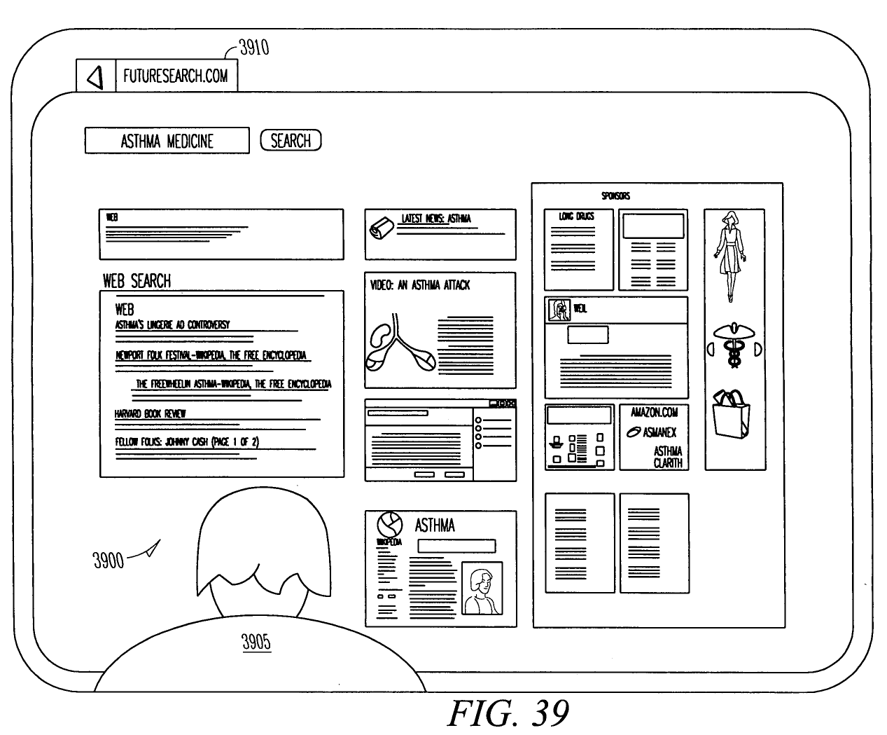

FIG. 38 shows a nurse 3805 in the midst of designing a search template for asthma medicine (which she could abstract to “<disease><remedy>”) in a search system “medsearch.com” 3890 provided by and for health care practitioners, who comprise a community of interest. Such a community would have the option of making the results of their search system available outside the community; we see in FIG. 39 an arbitrary end-user 3905 looking at the “Asthma medicine” search in an end-user interface 3910 (that does not provide the search experience editor).

The results page 3900 provides a rich search experience, like the musician pages shown earlier. This demonstrates the wide applicability of the search experience editor technology; it is not limited to searches in particular subject areas or searches over particular content repositories.

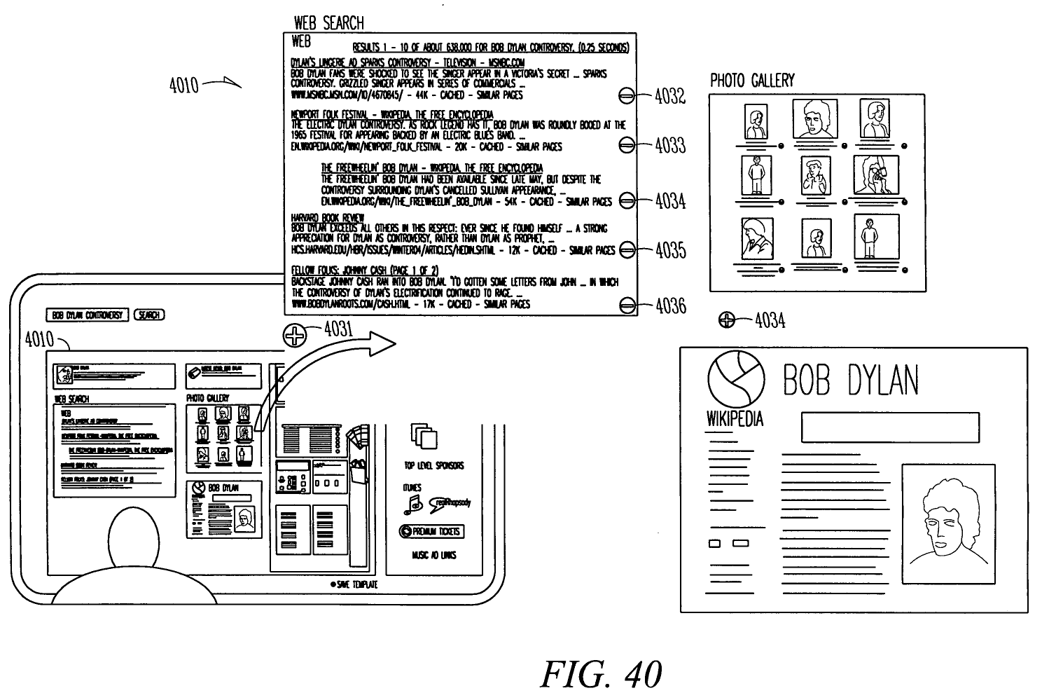

The search template builder figures have not focused on the same capabilities that the earlier search experience editor figures (such as FIG. 12) have shown, but this is merely for expository clarity. In an example, the search result crafting capabilities exemplified by FIGS. 11 through 18D and the search template building capabilities exemplified by FIGS. 24 through 39 are combined into one search experience editor tool that gives its user great control over the search experience. FIG. 40 shows detail beyond that shown in FIGS. 24 through 39. In the example of FIG. 40, a portion of the search results area 4010 is blown up for greater visibility, and “add” controls 4031, 4034, and “delete” controls 4032, 4033, 4035, and 4036 are shown. In certain examples, an item that is added to the featured results pane 1220 in FIG. 12 is added to a featured results added items list in the search experience modification record, while an item that is added to the search results pane 1230 in FIG. 12 is added to a search results added items list in the search experience modification record. To deal with a non-fixed set of multiple widgets, each widget has its own list of added, deleted, or modified items in the search experience modification record, and these lists are identified with their widget. Thus, the capabilities described for modifying results once the results have been obtained are available for the results of the search widgets and sponsor widgets.

The above specification, examples and data provide a complete description of the manufacture and use of the composition of the invention, including computer-assisted methods, computer-implemented systems for performing such methods, and computer readable media for specifying instructions for performing such computer-assisted methods. Since many embodiments of the invention can be made without departing from the scope of the invention, the invention resides in the claims hereinafter appended.

What is claimed is:

1. A method of crafting an end-user search experience, the method comprising:
displaying in an administrative interface a plurality of items including at least one query item and one or more additional items associated with the query item, the one or more additional items including at least one responsive item to the query item, the one or more additional items displayed in a configuration representative of an appearance of an end-user search interface;
receiving administrative input, through the administrative interface, relating to a modification of one or more of the items or the configuration;
saving in a record at least one parameter relating to the modification; and
displaying in the administrative interface, in a configuration representative of an appearance of an end-user search interface, the configuration of the one or more of the additional items as modified in accordance with the at least one parameter saved in the record.

2. The method of claim 1, in which the record includes triggers, each trigger associated with at least one of the saved parameters, and comprising receiving a first query through an end-user search interface, identifying whether the first query maps to at least one trigger, and if the first query does map to at least one trigger, then using the at least one parameter associated with the at least one trigger to control the displaying of at least one responsive item in the end-user interface.

3. The method of claim 2, comprising determining a first query class associated with the first query, and wherein the identifying whether the first query maps to at least one trigger comprises identifying whether the first query class maps to at least one trigger.

4. The method of claim 1, wherein displaying at least one query item includes displaying at least one text string or specifiable parameter.

5. The method of claim 1, wherein displaying at least one additional item includes displaying a result item, a results area, a featured result, a featured result area, a navigation item, a navigation area, a direct answer, an advertisement, or a specialized transaction interface.

6. The method of claim 1, wherein the saving in a record comprises saving in an underlying knowledge representation, wherein search results are presented in an end-user search interface using the modified knowledge representation.

7. The method of claim 1, wherein the saving in a record comprises saving in a record that is associated with at least one trigger for comparison against an end-user query to determine whether to use the saved at least one parameter in response to the end-user query.

8. The method of claim 1, wherein receiving administrative input includes receiving an instruction to:
add an item to the administrative interface;
remove an item from the administrative interface;
move an item to a different organizational unit or a different location in the administrative interface,
reorder an items or items;
edit an item;
rename an item;
merge two or more items;
preview an end user interface; or
edit a property of an item.

9. The method of claim 1, wherein receiving administrative input comprises receiving input specifying one or more contexts in which the modification is to be applied.

10. The method of claim 9, comprising:
receiving an end-user query in an end-user interface; and
applying the modification in the end-user interface if the specified one or more contexts are present.

11. The method of claim 9, wherein applying the modification includes applying the modification if the end-user query corresponds to a specified query class, a specified product or product group, a specified document type, a specified author, or a specified user or customer group.

12. The method of claim 1, further comprising displaying some or all of the additional items in an end-user interface using the at least one parameter saved in the record to:
add an item to the administrative interface;
remove an item from the administrative interface;
move an item to a different organizational unit or a different location in the administrative interface;
reorder an items or items;
edit an item;
rename an item;
merge two or more items; or
edit a property of an item.

13. The method of claim 1, wherein the one or more additional items includes search results responsive to the query item.

14. The method of claim 1, further comprising refreshing the administrative interface in accordance with the modification provided by the administrative input.

15. The method of claim 14, wherein receiving administrative input includes receiving an input changing the at least one query item and refreshing the administrative interface includes updating the one or more additional items in response to changing the at least one query item.

16. The method of claim 1, further comprising displaying in the administrative user interface one or more other queries associated with the record.

17. The method of claim 1, wherein the displaying in the administrative interface the plurality of items includes displaying two or more items in an order as would be presented in the end-user search interface in response to the at least one query-item, and the receiving administrative input includes receiving an instruction to change the displayed order of the two or more items.

18. The method of claim 1, comprising displaying in the administrative interface a first pane and a second pane, and wherein the receiving administrative input includes receiving an instruction to move or copy an item from the first pane to the second pane.

19. The method of claim 1, wherein the displaying in the administrative interface the plurality of items includes displaying items in a what-you-see-is-what-you-get (WYSIWYG) interface that displays the items substantially as the items would be displayed to an end-user, and
the method further comprises displaying one or more controls in the WYSIWYG interface through which at least some of the administrative input relating to a modification of the end user presentation scheme is receivable.

20. The method of claim 1, wherein the displaying in the administrative interface the plurality of items includes displaying one or more selectable navigation items, and
the receiving administrative input includes at least one of:
adding a navigation item;
removing a navigation item;
merging navigation items;
creating a new navigation item; and
renaming a navigation item.

21. The method of claim 1, further comprising:
receiving an input selecting a navigation item,
refreshing the display and presenting items associated with the navigation item in a configuration representative of an appearance of an end-user search interface, and
receiving administrative input, through the administrative interface, relating to a modification of one or more of the plurality of items or the configuration of the one or more items; and
saving in the record at least one parameter relating to the modification of one or more of the plurality of items or the configuration of the one or more items.

22. The method of claim 1, comprising displaying in the administrative interface a WYSIWYG query response region including a general results area listing a plurality of ordered results, a targeted results area listing one or more targeted results, and a navigation area listing one or more navigation links.

23. The method of claim 22, comprising displaying a query match region listing one or more queries associated with the at least one trigger and displaying one or more administrative controls relating to the queries associated with the at least one trigger.

24. The method of claim 23, wherein displaying a WYSIWYG query response region includes presenting search results for a first query in the general results area, and the displaying a query match region listing one or more queries associated with the trigger includes:
normalizing the first query;
determining a first query class using the normalized first query; and
populating the query match region with one or more other, different query classes that contain the first query class.

25. The method of claim 24, comprising logging previous queries, normalizing the previous queries, and storing normalized versions of the previous queries in a query index, and
wherein populating the query match region with one or more other, different query classes that contain the first query class includes searching the query index using the first query class and populating the query match region with normalized versions of the previous queries.

26. A method of crafting an end-user search experience, the method comprising:
displaying in an administrative interface a plurality of items including at least one query item and one or more additional items associated with the query item, the one or more additional items displayed in a configuration representative of an appearance of an end-user search interface;
receiving administrative input, through the administrative interface, relating to a modification of one or more of the plurality of items or the configuration of the one or more items;
saving in a record at least one parameter relating to the modification of one or more of the plurality of items or the configuration of the one or more items;
receiving a first query through an end-user search interface;
determining whether the first query qualifies as a trigger for the record;
if the first query qualifies as a trigger for the record, displaying at least one responsive item in the end-user search interface using the at least one parameter relating to the modification of one or more of the plurality of items or the configuration of the one or more items.

27. The method of claim 26, wherein determining whether the first query qualifies as a trigger for the record includes identifying a first query class associated with the first query, and determining whether the first query class qualifies as a trigger for the record.

28. The method of claim 27, wherein identifying a first query class includes determining a normalized version of the first query.

29. The method of claim 26, comprising searching a set of resources using the first query and displaying a result of the searching modified by the record.

30. The method of claim 26, further comprising refreshing the administrative interface and reflecting in the administrative interface the modification of one or more of the plurality of items or the configuration of the one or more items.

31. The method of claim 26, wherein displaying in an administrative interface a plurality of items includes displaying a plurality of queries having a specified relationship with the record.

32. The method of claim 31, wherein displaying a plurality of queries having a specified relationship with the record includes displaying a plurality of queries that are triggers for the record.

33. The method of claim 31, wherein receiving administrative input includes receiving at least one input specifying at least one query to be associated with or dissociated from the record, wherein associated queries qualify as a trigger for the record.

34. The method of claim 33, comprising recording in the record the at least one query to be associated with or dissociated from the record.

35. The method of claim 31, wherein the record includes a sponsored result and displaying a plurality of queries having a specified relationship with the record includes displaying queries that are triggers for the sponsored result.

36. The method of claim 31, wherein:
receiving a first query includes receiving a first query string; and
determining whether the first query qualifies as a trigger for the record includes determining a query class from the first query string and determining whether the query class qualifies as a trigger.

37. The method of claim 36, wherein displaying a plurality of queries includes displaying queries having a specified relationship with the query class.

38. The method of claim 31, wherein displaying queries having a specified relationship with the record includes displaying queries associated with the record, displaying queries dissociated from the record, or displaying queries containing the query class.

39. The method of claim 31, wherein:
receiving a first query includes receiving a first query string and a second query string; and
determining whether the first query qualifies as a trigger for the record includes determining a query class using the first query string and second query string and determining whether the query class qualifies as a trigger.

40. A method comprising:
receiving a query input;
identifying a search modification record with which the query input has a specified relationship, the search modification record including at least one modification relating to the presentation of one or more items responsive to the query input or a configuration of the one or more items; and
displaying results responsive to the query using the search modification record.

41. The method of claim 40, wherein identifying a search modification record with which the query input has a specified relationship includes identifying a search modification record associated with a query class that the query contains.

42. The method of claim 40, wherein displaying results responsive to the query using the search modification record includes displaying results using an instruction specified by the search modification record to
add an item to the administrative interface;
remove an item from the administrative interface;
move an item to a different organizational unit or a different location in the administrative interface;
reorder an items or items;
edit an item;
rename an item;
merge two or more items; or
edit a property of an item.
